(19) United States
(12) Patent Application Publication
(10) Pub. No.: US 2017/0251770 A1
(43) Pub. Date: Sep. 7, 2017

(54) Forming A Trimmed Assembly

(71) Applicant: Coach, Inc., New York, NY (US)

(72) Inventors: Kelly Greeley, New York, NY (US); Tina Blanco, New York, NY (US); Dawn Kiernan, Danbury, CT (US); Alan C. Au, Brooklyn, NY (US)

(73) Assignee: Coach, Inc., New York, NY (US)

(21) Appl. No.: 15/058,641

(22) Filed: Mar. 2, 2016

(51) Int. Cl. A44B 13/00; B44C 3/00

(52) U.S. Cl. CPC A44B 13/0088; B44C 3/00

(57) ABSTRACT

A trim assembly includes a first trim member and a second trim member, each including an aesthetically-pleasing surface and a substrate-facing surface. A plurality of circumferentially-arranged projections extends axially away from substrate-facing surface of the first trim member. The second trim member includes an aesthetically-pleasing surface and a substrate-facing surface. A circumferential projection extends axially away from substrate-facing surface of the second trim member. The circumferential projection includes an axially-extending portion and a radially-extending portion. The radially-extending portion extends radially outwardly away from the axially-extending portion. The radially-extending portion forms a plurality of circumferentially-arranged passages configured for receiving the plurality of circumferentially-arranged projections for joining the first trim member to the second trim member when the plurality of circumferentially-arranged projections are at least partially disposed within the plurality of circumferentially-arranged passages. A trimmed assembly is also disclosed. A method for forming a trimmed assembly is also disclosed.

### TECHNICAL FIELD

This disclosure relates to a trim assembly, a trimmed assembly and a method for forming a trimmed assembly.

### BACKGROUND

Trim assemblies and trimmed assemblies are known. While existing trim assemblies and trimmed assemblies perform adequately for their intended purpose, improvements to trim assemblies and trimmed assemblies are continuously being sought in order to advance the arts.

### SUMMARY

One aspect of the disclosure provides a trim assembly. The trim assembly includes a first trim member and a second trim member. The first trim member includes an aesthetically-pleasing surface and a first substrate-facing surface. A plurality of circumferentially-arranged projections extends axially away from the first substrate-facing surface of the first trim member. The second trim member includes a second aesthetically-pleasing surface and a second substrate-facing surface. A circumferential projection extends axially away from the second substrate-facing surface of the second trim member. The circumferential projection includes an axially-extending portion and a radially-extending portion. The radially-extending portion extends radially outwardly away from the axially-extending portion. The radially-extending portion forms a plurality of circumferentially-arranged passages configured for receiving the plurality of circumferentially-arranged projections for joining the first trim member to the second trim member when the plurality of circumferentially-arranged projections are at least partially disposed within the plurality of circumferentially-arranged passages.

Implementations of the disclosure may include one or more of the following optional features. The plurality of circumferentially-arranged projections may further include a first projection, a second projection, a third projection and a fourth projection. In some examples, each of the first projection, the second projection, the third projection and the fourth projection is respectively offset by approximately 90°. In some implementations, each of the first projection, the second projection, the third projection and the fourth projection includes a substantially arcuate shape having an axially-extending portion and a radially-extending portion. The axially-extending portion may include a proximal end, a distal end surface, a radially-inwardly-facing surface and a radially-outwardly-facing surface, wherein the proximal end of the axially-extending portion extends axially away from the substrate-facing surface of the first trim member. The radially-extending portion may include a radially-outwardly-facing surface and a shoulder surface. The radially-outwardly-facing surface of the radially-extending portion connects the shoulder surface to the distal end surface of the axially-extending portion. In some examples, the radially-outwardly-facing surface of the radially-extending portion extends away from the distal end surface of the axially-extending portion at an angle. The shoulder surface is arranged in an opposing relationship with respect to the first substrate-facing surface of the first trim member. In some implementations, the axially-extending portion includes a proximal end, a distal end surface, a radially-inwardly-facing surface and a radially-outwardly-facing surface. The proximal end of the axially-extending portion extends axially away from the second substrate-facing surface of the second trim member. In additional examples, the radially-extending portion includes a radially-outwardly-facing surface, a lower shoulder surface, and an upper shoulder surface. The radially-outwardly-facing surface of the radially-extending portion connects the lower shoulder surface to the upper shoulder surface. The radially-extending portion is defined by a thickness extending between the lower shoulder surface and the upper shoulder surface.

In some implementations, the plurality of circumferentially-arranged passages extends axially through the thickness of the radially-extending portion. The plurality of circumferentially-arranged passages includes a first passage, a second passage, a third passage and a fourth passage. In some examples, each of the first passage, the second passage, the third passage and the fourth passage is respectively offset by approximately 90°. In some implementations, each of the first passage, the second passage, the third passage and the fourth passage includes a substantially arcuate shape.

In some examples, the first trim member includes a second plurality of circumferentially-arranged projections extending axially away from the first substrate-facing surface and are arranged radially outwardly with respect to the first plurality of circumferentially-arranged projections of the first trim member. The second trim member may include a plurality of circumferentially-arranged projections extending axially away from the second substrate-facing surface and are arranged radially outwardly with respect to a radially-outwardly-facing surface of the radially-extending portion of the circumferential projection of the second trim member.

Another aspect of the disclosure provides a trimmed assembly including a first trim member, a second trim member and a substrate. The first trim member includes a first aesthetically-pleasing surface and a first substrate-facing surface. A plurality of circumferentially-arranged projections extends axially away from the first substrate-facing surface of the first trim member. The second trim member includes a second aesthetically-pleasing surface and a second substrate-facing surface. A circumferential projection extends axially away from the second substrate-facing surface of the second trim member. The circumferential projection includes an axially-extending portion and a radially-extending portion extending radially outwardly away from the axially-extending portion. The radially-extending portion forms a plurality of circumferentially-arranged passages configured for receiving the plurality of circumferentially-arranged projections for joining the first trim member to the second trim member when the plurality of circumferentially-arranged projections are at least partially disposed within the plurality of circumferentially-arranged passages. The substrate is defined by a body having an upper surface, a lower surface and a side surface joining the upper surface to the lower surface. The body is defined by a thickness extending between the upper surface to the lower surface. The side surface forms a passage extending through the thickness of the body. The passage extends through the thickness of the body. The passage is defined by a passage diameter. The axially-extending portion of the circumferential projection of the second trim member is disposed within the passage extending through the thickness of the body of the substrate, and the radially-extending portion of the circumferential projection is arranged opposite or adjacent the upper surface of the body of the substrate.

This aspect may include one or more of the following optional features. In some implementations, the second trim member includes a plurality of circumferentially-arranged projections extending axially away from the second substrate-facing surface, the circumferentially-arranged projections of the first trim member arranged in an opposing relationship with respect to the plurality of circumferentially-arranged projections of the second trim member for pinching a portion of the thickness of the body of the substrate arranged there-between. The plurality of circumferentially-arranged projections of the first trim member may be arranged in an opposing relationship with respect to the circumferentially-arranged passages extending into the second substrate-facing surface of the second trim member for permitting the plurality of circumferentially-arranged projections of the first trim member to axially plunge a portion of thickness of the body of the substrate into each of the circumferentially-arranged passages. The first trim member may define projection passages extending into the first substrate-facing surface, and the second trim member may include a plurality of circumferentially-arranged projections extending axially away from the second substrate-facing surface and arranged in an opposing relationship with respect to the projection passages extending into the first substrate-facing surface of the first trim member for permitting the plurality of circumferentially-arranged projections of the second trim member to axially plunge a portion of thickness of the body of the substrate into the projection passages.

Yet another aspect of the disclosure provides a method for forming a trimmed assembly including a first trim member, a second trim member, and a substrate. The method includes arranging a first substrate-facing surface of the first trim member opposite an upper surface of the substrate. The method also includes arranging a second substrate-facing surface of the second trim member opposite a lower surface of the substrate. The method also includes joining the second trim member to the substrate. The method also includes axially disposing a first plurality of circumferentially-arranged projections of the first trim member within a plurality of circumferentially-arranged passages formed by a radially-extending portion of the second trim member. The method also includes joining the first trim member to the second trim member.

This aspect may include one or more of the following optional features. In some implementations, joining the second trim member to the substrate includes axially inserting a circumferential projection of the second trim member into the passage extending through the thickness of the body of the substrate such that the radially-extending portion is axially moved to an orientation opposite the lower surface of the substrate, through the passage extending through the thickness of the body of the substrate and axially beyond the upper surface of the substrate. Axially disposing the first plurality of circumferentially-arranged projections of the first trim member within the plurality of circumferentially-arranged passages may include a radially-extending-outwardly-facing surface of the radially-extending portion of each projection of the first plurality of circumferentially-arranged projections adjacent a surface portion defining each passage of the plurality of circumferentially-arranged passages, such that the plurality of circumferentially-arranged projections flex radially inwardly.

In some implementations, joining the first trim member to the second trim member also includes axially moving the first plurality of circumferentially-arranged projections further through the passage extending through the thickness of the body of the substrate for subsequently axially arranging the shoulder surface of each projection of the first plurality of circumferentially-arranged projections of the first trim member beyond the lower shoulder surface of the radially-extending portion of the circumferential projection of the second trim member such that the plurality of circumferentially-arranged projections flex radially outwardly. In some examples, when the first trim member is joined to the second trim member, the projections that axially extend away from the first substrate-facing surface of the first trim member are arranged in an opposing relationship with respect to projections that axially extend away from the second substrate-facing surface for the purpose of pinching a portion of thickness of the body of the substrate arranged there-between. In additional examples, when the first trim member is joined to the second trim member, the projections that axially extend away from the first substrate-facing surface of the first trim member are arranged in an opposing relationship with respect to passages extending into the second substrate-facing surface of the second trim member for permitting the projections to axially plunge a portion of thickness of the body of the substrate into a void formed by the passages. In yet more examples, when the first trim member is joined to the second trim member, the projections that axially extend away from the second substrate-facing surface of the second trim member are arranged in an opposing relationship with respect to passages extending into the substrate-facing surface of the first trim member for permitting the projections to axially plunge a portion of thickness of the body of the substrate into a void formed by the passages.

The details of one or more implementations of the disclosure are set forth in the accompanying drawings and the description below. Other aspects, features, and advantages will be apparent from the description and drawings, and from the claims.

### DESCRIPTION OF DRAWINGS

FIGS. 1A-1E illustrate exploded perspective views of an exemplary trim assembly and a trimmed assembly.

FIG. 2A is a cross-sectional view according to line 2A-2A of FIG. 1A.

FIG. 2B is a cross-sectional view according to line 2B-2B of FIG. 1B.

FIG. 2C is a cross-sectional view according to line 2C-2C of FIG. 1C.

FIG. 2D is a cross-sectional view according to line 2D-2D of FIG. 1D.

FIG. 2E is a cross-sectional view according to line 2E-2E of FIG. 1E.

FIG. 2A₁ is an enlarged view according to line 2A₁ of FIG. 2A.

FIG. 2A₂ is an enlarged view according to line 2A₂ of FIG. 2A.

FIG. 3A is a cross-sectional view according to line 3A-3A of FIG. 1A.

FIG. 3B is a cross-sectional view according to line 3B-3B of FIG. 1B.

FIG. 3C is a cross-sectional view according to line 3C-3C of FIG. 1C.

FIG. 3D is a cross-sectional view according to line 3D-3D of FIG. 1D.

FIG. 3E is a cross-sectional view according to line 3E-3E of FIG. 1E.

FIG. 3A₁ is an enlarged view according to line 3A₁ of FIG. 3A.

FIG. 3A₂ is an enlarged view according to line 3A₂ of FIG. 3A.

FIG. 4 is a plan view of a first trim member of the trim assembly of FIG. 1A-1E.

FIG. 5 is a plan view of a second trim member of the trim assembly of FIG. 1A-1E.

FIGS. 6A-6E illustrate exploded perspective views of an exemplary trim assembly and a trimmed assembly.

FIG. 7A is a cross-sectional view according to line 7A-7A of FIG. 6A.

FIG. 7B is a cross-sectional view according to line 7B-7B of FIG. 6B.

FIG. 7C is a cross-sectional view according to line 7C-7C of FIG. 6C.

FIG. 7D is a cross-sectional view according to line 7D-7D of FIG. 6D.

FIG. 7E is a cross-sectional view according to line 7E-7E of FIG. 6E.

FIG. 7A₁ is an enlarged view according to line 7A₁ of FIG. 6A.

FIG. 7A₂ is an enlarged view according to line 7A₂ of FIG. 6A.

FIG. 8A is a cross-sectional view according to line 8A-8A of FIG. 6A.

FIG. 8B is a cross-sectional view according to line 8B-8B of FIG. 6B.

FIG. 8C is a cross-sectional view according to line 8C-8C of FIG. 6C.

FIG. 8D is a cross-sectional view according to line 8D-8D of FIG. 6D.

FIG. 8E is a cross-sectional view according to line 8E-8E of FIG. 6E.

FIG. 8A₁ is an enlarged view according to line 8A₁ of FIG. 8A.

FIG. 8A₂ is an enlarged view according to line 8A₂ of FIG. 8A.

FIG. 9 is a plan view of a first trim member of the trim assembly of FIG. 6A-6E.

FIG. 10 is a plan view of a second trim member of the trim assembly of FIG. 6A-6E.

FIGS. 11A-11E illustrate exploded perspective views of an exemplary trim assembly and a trimmed assembly.

FIG. 12A is a cross-sectional view according to line 12A-12A of FIG. 11A.

FIG. 12B is a cross-sectional view according to line 12B-12B of FIG. 11B.

FIG. 12C is a cross-sectional view according to line 12C-12C of FIG. 11C.

FIG. 12D is a cross-sectional view according to line 12D-12D of FIG. 11D.

FIG. 12E is a cross-sectional view according to line 12E-12E of FIG. 11E.

FIG. 12A₁ is an enlarged view according to line 12A₁ of FIG. 12A.

FIG. 12A₂ is an enlarged view according to line 12A₂ of FIG. 12A.

FIG. 13A is a cross-sectional view according to line 13A-13A of FIG. 11A.

FIG. 13B is a cross-sectional view according to line 13B-13B of FIG. 11B.

FIG. 13C is a cross-sectional view according to line 13C-13C of FIG. 11C.

FIG. 13D is a cross-sectional view according to line 13D-13D of FIG. 11D.

FIG. 13E is a cross-sectional view according to line 13E-13E of FIG. 11E.

FIG. 13A₁ is an enlarged view according to line 13A₁ of FIG. 13A.

FIG. 13A₂ is an enlarged view according to line 13A₂ of FIG. 13A.

FIG. 14 is a plan view of a first trim member of the trim assembly of FIG. 11A-11E.

FIG. 15 is a plan view of a second trim member of the trim assembly of FIG. 11A-11E.

FIGS. 16A-16E illustrate exploded perspective views of an exemplary trim assembly and a trimmed assembly.

FIG. 17A is a cross-sectional view according to line 17A-17A of FIG. 16A.

FIG. 17B is a cross-sectional view according to line 17B-17B of FIG. 16B.

FIG. 17C is a cross-sectional view according to line 17C-17C of FIG. 16C.

FIG. 17D is a cross-sectional view according to line 17D-17D of FIG. 16D.

FIG. 17E is a cross-sectional view according to line 17E-17E of FIG. 16E.

FIG. 17A₁ is an enlarged view according to line 17A₁ of FIG. 17A.

FIG. 17A₂ is an enlarged view according to line 17A₂ of FIG. 17A.

FIG. 18A is a cross-sectional view according to line 18A-18A of FIG. 16A.

FIG. 18B is a cross-sectional view according to line 18B-18B of FIG. 16B.

FIG. 18C is a cross-sectional view according to line 18C-18C of FIG. 16C.

FIG. 18D is a cross-sectional view according to line 18D-18D of FIG. 16D.

FIG. 18E is a cross-sectional view according to line 18E-18E of FIG. 16E.

FIG. 18A₁ is an enlarged view according to line 18A₁ of FIG. 18A.

FIG. 18A₂ is an enlarged view according to line 18A₂ of FIG. 18A.

FIG. 19 is a plan view of a first trim member of the trim assembly of FIG. 16A-16E.

FIG. 20 is a plan view of a second trim member of the trim assembly of FIG. 16A-16E.

FIGS. 21A-21E illustrate exploded perspective views of an exemplary trim assembly and a trimmed assembly.

FIG. 22A is a cross-sectional view according to line 22A-22A of FIG. 21A.

FIG. 22B is a cross-sectional view according to line 22B-22B of FIG. 21B.

FIG. 22C is a cross-sectional view according to line 22C-22C of FIG. 21C.

FIG. 22D is a cross-sectional view according to line 22D-22D of FIG. 21D.

FIG. 22E is a cross-sectional view according to line 22E-22E of FIG. 21E.

FIG. 22A₁ is an enlarged view according to line 22A₁ of FIG. 22A.

FIG. 22A₂ is an enlarged view according to line 22A₂ of FIG. 22A.

FIG. 23A is a cross-sectional view according to line 23A-23A of FIG. 21A.

FIG. 23B is a cross-sectional view according to line 23B-23B of FIG. 21B.

FIG. 23C is a cross-sectional view according to line 23C-23C of FIG. 21C.

FIG. 23D is a cross-sectional view according to line 23D-23D of FIG. 21D.

FIG. 23E is a cross-sectional view according to line 23E-23E of FIG. 21E.

FIG. 23A₁ is an enlarged view according to line 23A₁ of FIG. 23A.

FIG. 23A₂ is an enlarged view according to line 23A₂ of FIG. 23A.

FIG. 24 is a plan view of a first trim member of the trim assembly of FIG. 21A-21E.

FIG. 25 is a plan view of a second trim member of the trim assembly of FIG. 21A-21E.

FIG. 26 is a flow diagram of a method for forming a trimmed assembly.

### DETAILED DESCRIPTION

A trim assembly includes a first trim member joined to a second trim member.

A trimmed assembly includes a first trim member joined a second trim member and a substrate disposed between the first trim member and the second trim member. One or both of the first trim member and the second trim member may include one or a combination of a metallic material and plastic material. The substrate material may include a leather material or an artificial leather material such that the trimmed assembly forms a leather good or an artificial leather good. The leather good or artificial leather good may include, but is not limited to: a belt, a strap (e.g., for a purse or satchel), a wallet, a handbag or the like.

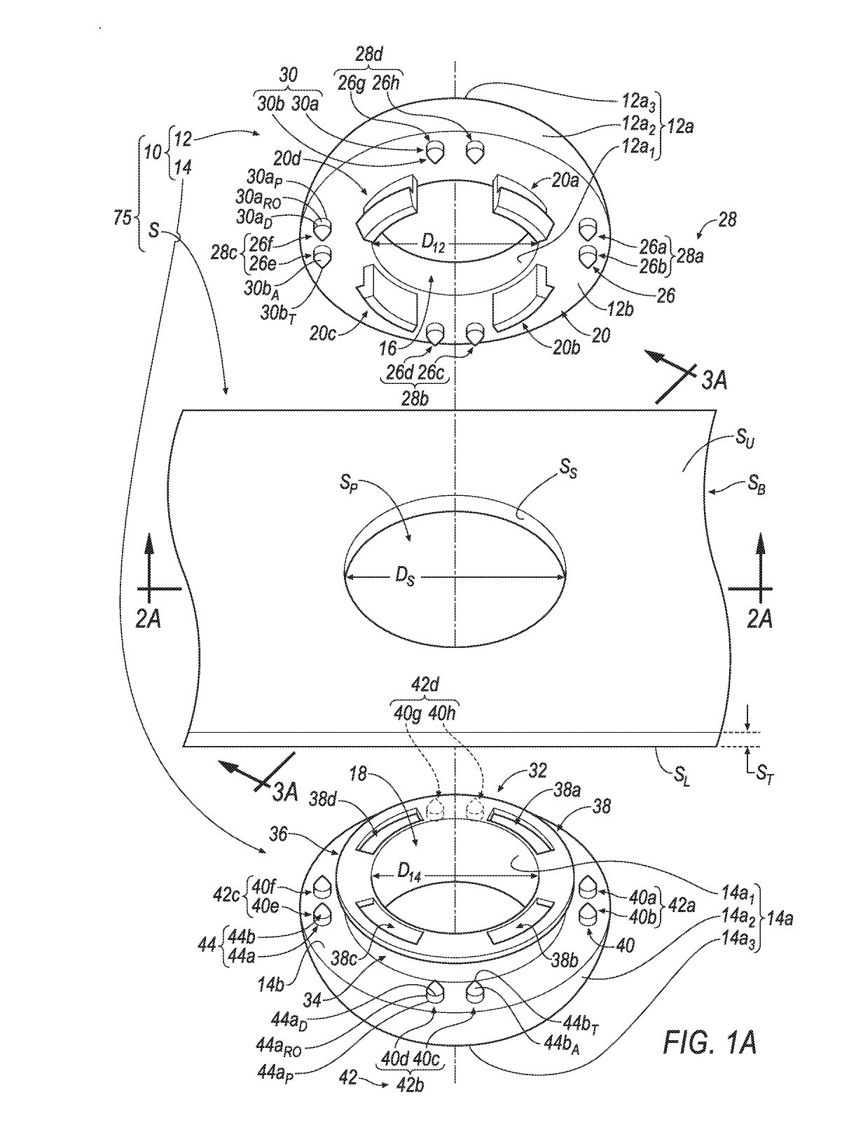

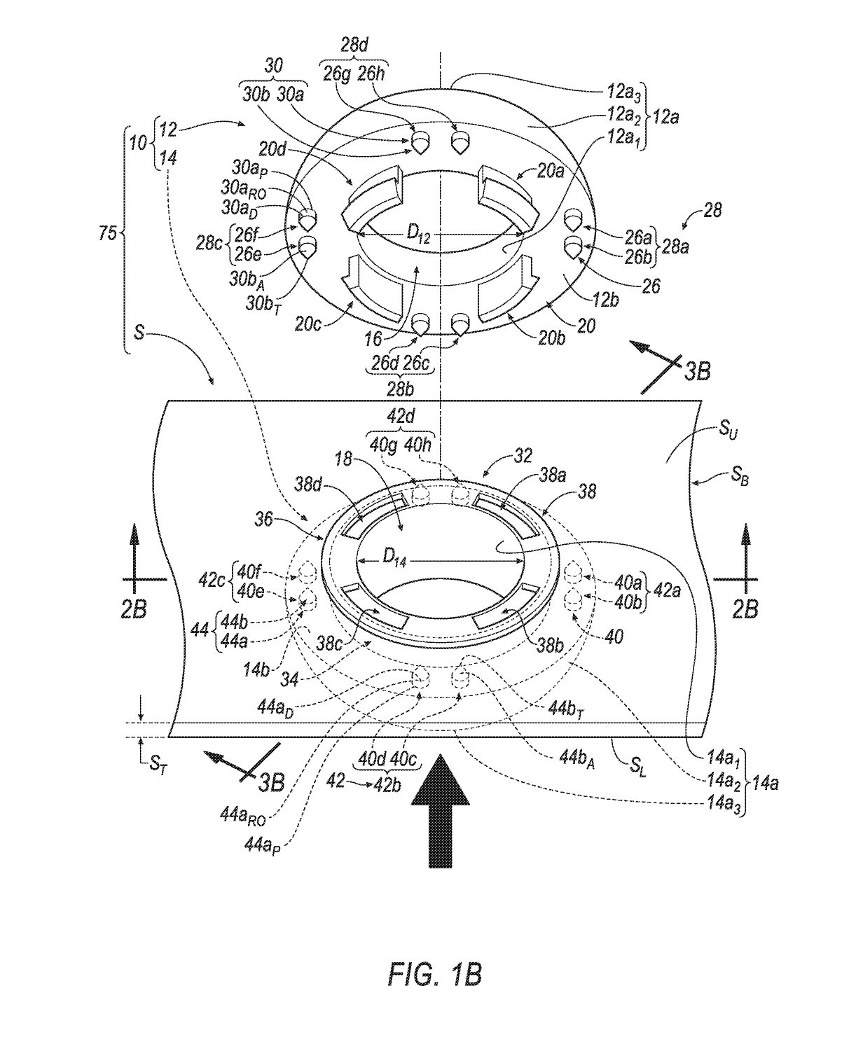

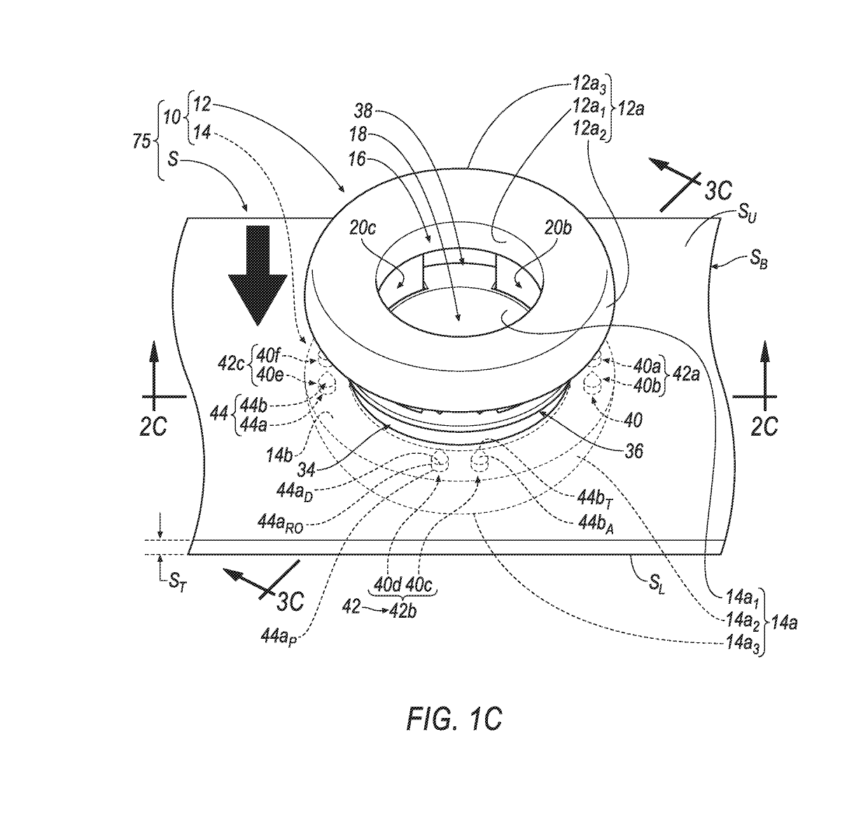

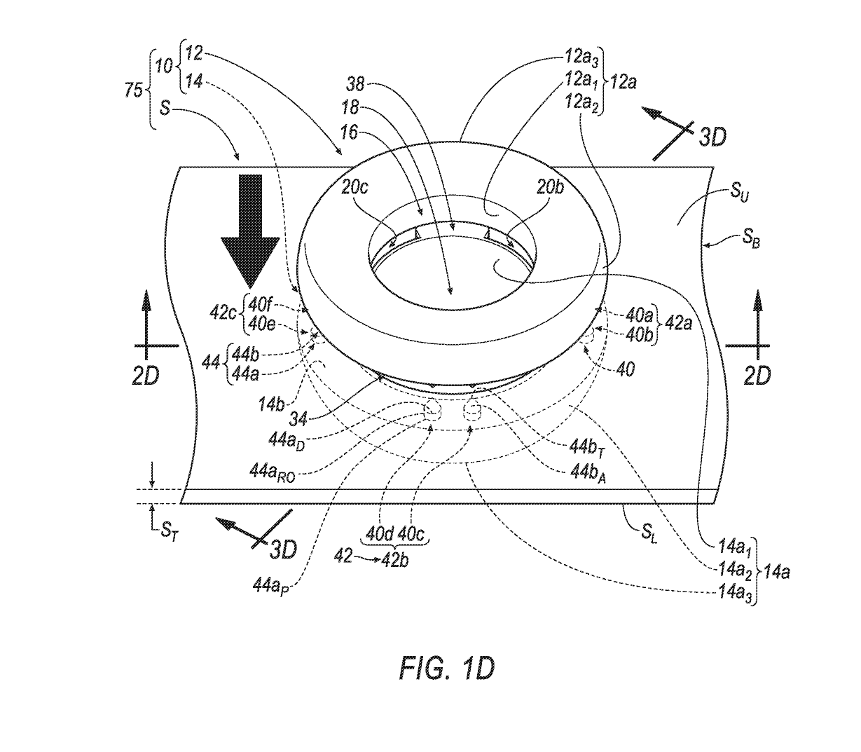

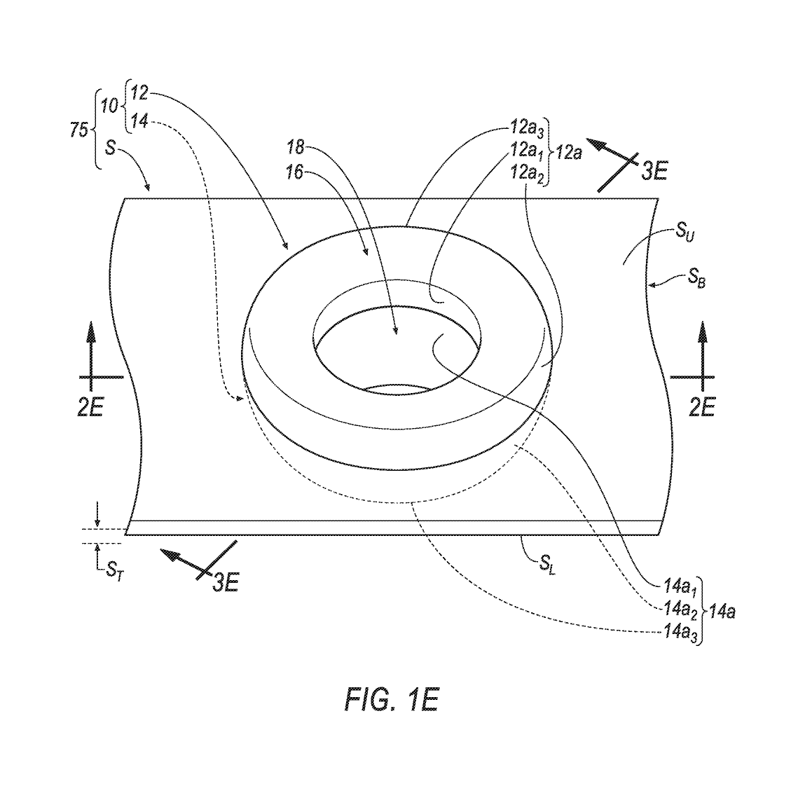

FIGS. 1A-5 illustrate an exemplary trim assembly 10 joined to a substrate S to form a trimmed assembly 75. As seen in FIG. 1A, the trim assembly 10 includes a first trim member 12 and a second trim member 14. The first trim member 12 includes an aesthetically-pleasing surface 12a and a substrate-facing surface 12b. The second trim member 14 includes an aesthetically-pleasing surface 14a and a substrate-facing surface 14b.

With continued reference to FIG. 1A, the substrate S is defined by a body S_{B} having an upper surface S_{U}, a lower surface S_{L} and a side surface S_{S} joining the upper surface S_{U} to the lower surface S_{L}. The body S_{B} is defined by a thickness S_{T} extending between the upper surface S_{U} to the lower surface S_{L}. The side surface S_{S} forms a passage S_{P} extending through the thickness S_{T} of the body S_{B}. The passage S_{P} extending through the thickness S_{T} of the body S_{B} may be defined by a diameter D_{S}.

The aesthetically-pleasing surface 12a of the first trim member 12 may include any desirable shape or surface profile. In some instances, the aesthetically-pleasing surface 12a includes an inner side surface 12a₁, an outer side surface 12a₂ and an intermediate surface 12a₃ joining the inner side surface 12a₁ to the outer side surface 12a₂. The inner side surface 12a₁ defines a passage 16 extending through the first trim member 12. The passage 16 extending through the first trim member 12 may be defined by a diameter D₁₂.

The aesthetically-pleasing surface 14a of the second trim member 14 may include any desirable shape or surface profile. In some instances, the aesthetically-pleasing surface 14a includes an inner side surface 14a₁, an outer side surface 14a₂ and an intermediate surface 14a₃ joining the inner side surface 14a₁ to the outer side surface 14a₂. The inner side surface 14a₁ defines a passage 18 extending through the second trim member 14. The passage 18 extending through the second trim member 14 may be defined by a diameter D₁₄.

A first plurality of circumferentially-arranged projections 20 extend axially away from the substrate-facing surface 12b of the first trim member 12. In some instances, the first plurality of circumferentially-arranged projections 20 includes a first projection 20a, a second projection 20b, a third projection 20c and a fourth projection 20d that are respectively offset by approximately 90°. Each of the first projection 20a, the second projection 20b, the third projection 20c and the fourth projection 20d includes a substantially arcuate shape having an axially-extending portion 22 (see, e.g., FIG. 3A₁) and a radially-extending portion 24 (see, e.g., FIG. 3A₁).

Referring to FIG. 3A₁, the axially-extending portion 22 includes a proximal end 22_{P}, a distal end surface 22_{D}, a radially-inwardly-facing surface 22_{RI} and a radially-outwardly-facing surface 22_{RO}. The proximal end 22_{P} of the axially-extending portion 22 extends axially away from the substrate-facing surface 12b of the first trim member 12. The radially-extending portion 24 includes a radially-outwardly-facing surface 24_{RO} and a shoulder surface 24_{S}. The radially-outwardly-facing surface 24_{RO} of the radially-extending portion 24 connects the shoulder surface 24_{S} to the distal end surface 22_{D} of the axially-extending portion 22. The radially-outwardly-facing surface 24_{RO} of the radially-extending portion 24 extends away from the distal end surface 22_{D} of the axially-extending portion 22 at an angle θ (see, e.g., FIG. 3A₁). The shoulder surface 24_{S} is arranged in an opposing relationship with respect to the substrate-facing surface 12b of the first trim member 12 and is spaced from the substrate-facing surface 12b of the first trim member 12 at a length dimension L₂₄ (see, e.g., FIG. 3A₁). Each of the first projection 20a, the second projection 20b, the third projection 20c and the fourth projection 20d is defined by a length dimension L₂₀ (see, e.g., FIG. 3A₁) extending between the substrate-facing surface 12b of the first trim member 12 and the distal end surface 22_{D} of the axially-extending portion 22.

Referring again to FIG. 1A, a second plurality of circumferentially-arranged projections 26 extend axially away from the substrate-facing surface 12b of the first trim member 12. In some instances, the second plurality of circumferentially-arranged projections 26 includes a first projection 26a, a second projection 26b, a third projection 26c, a fourth projection 26d, a fifth projection 26e, a sixth projection 26f, a seventh projection 26g and an eighth projection 26h that are grouped into a plurality of pairs of projections 28 that are respectively offset by approximately 90°. The first projection 26a and the second projection 26b are arranged as a first pair of projections 28a of the plurality of pairs of projections 28. The third projection 26c and the fourth projection 26d are arranged as a second pair of projections 28b of the plurality of pairs of projections 28. The fifth projection 26e and the sixth projection 26f are arranged as a third pair of projections 28c of the plurality of pairs of projections 28. The seventh projection 26g and the eighth projection 26h are arranged as a fourth pair of projections 28d of the plurality of pairs of projections 28.

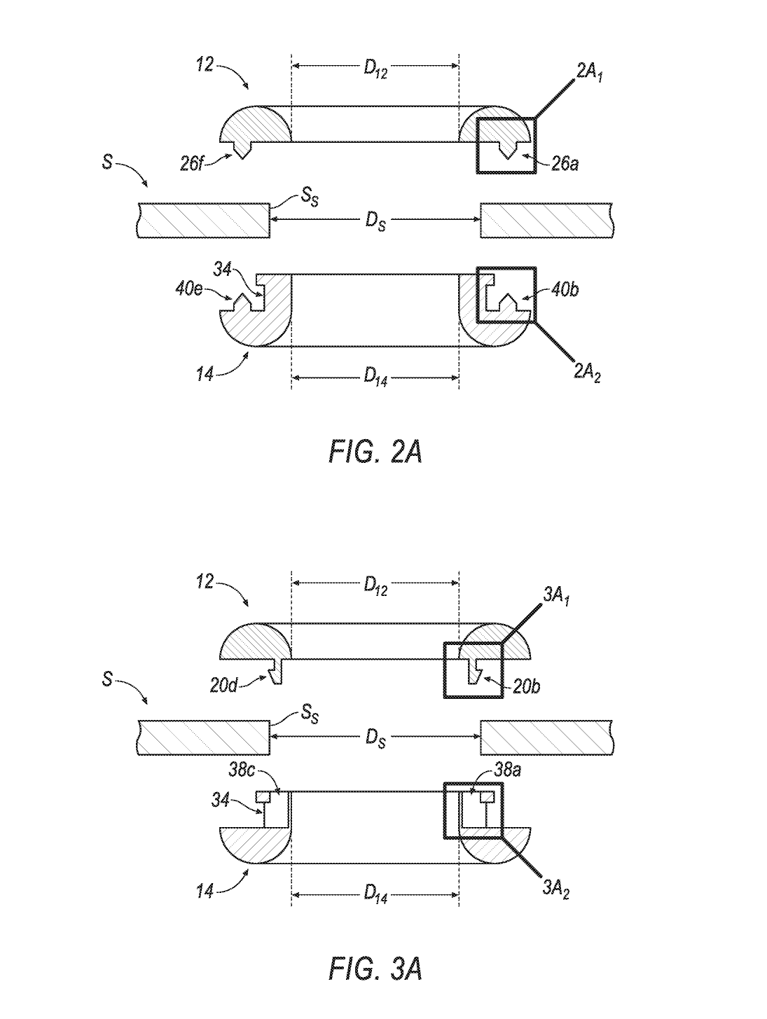

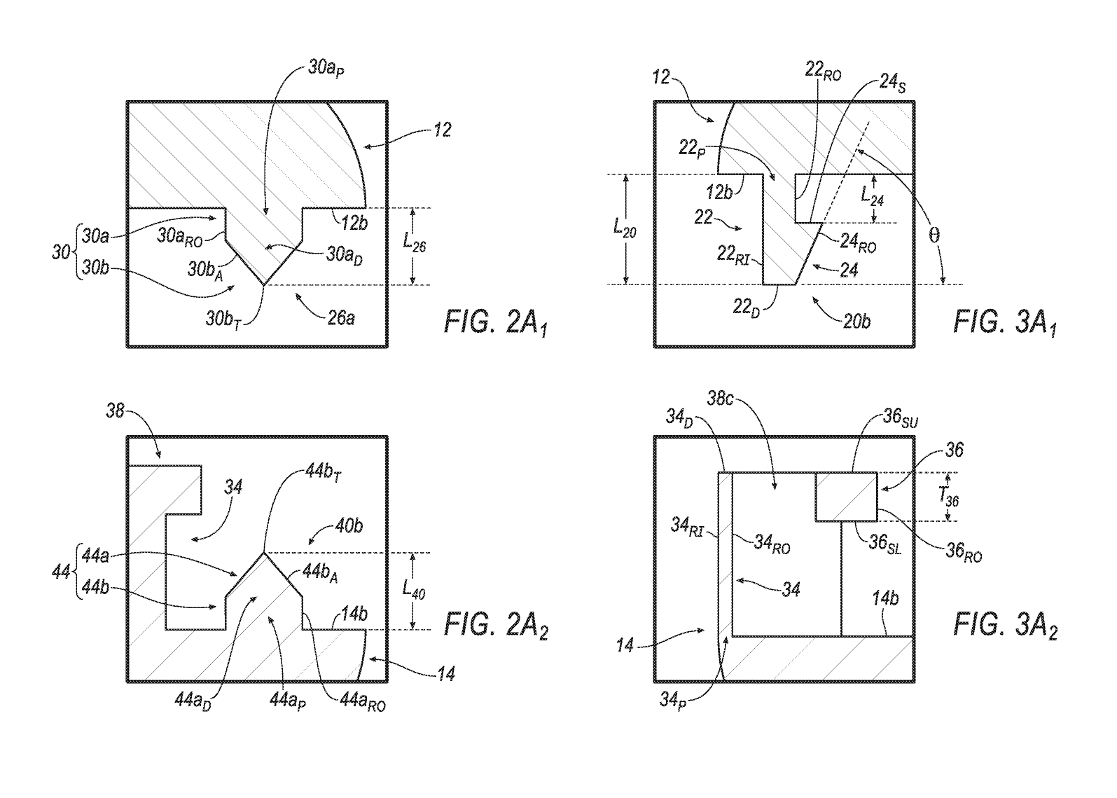

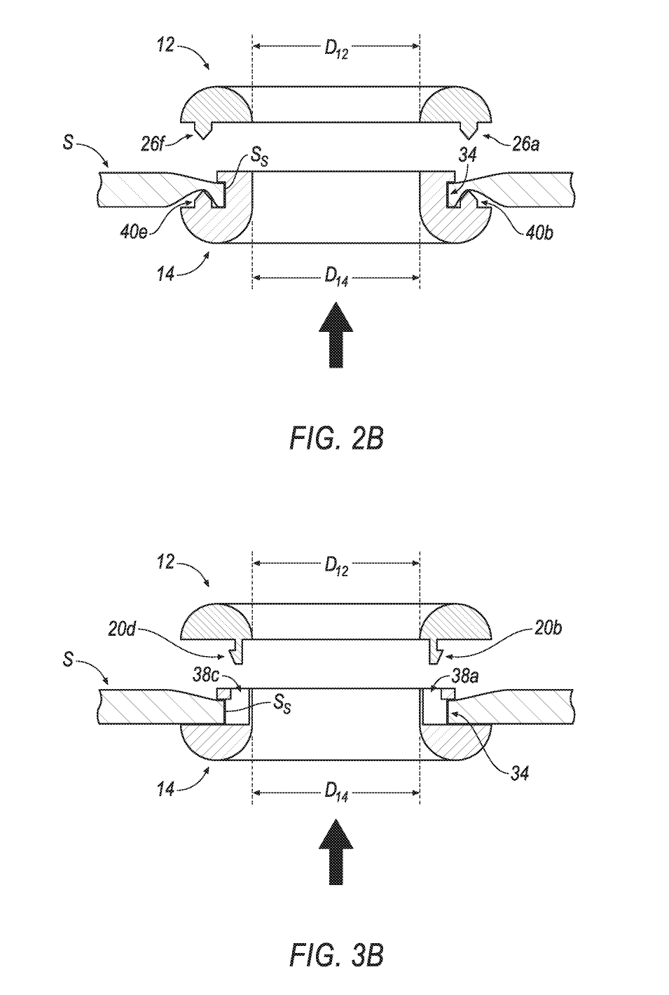

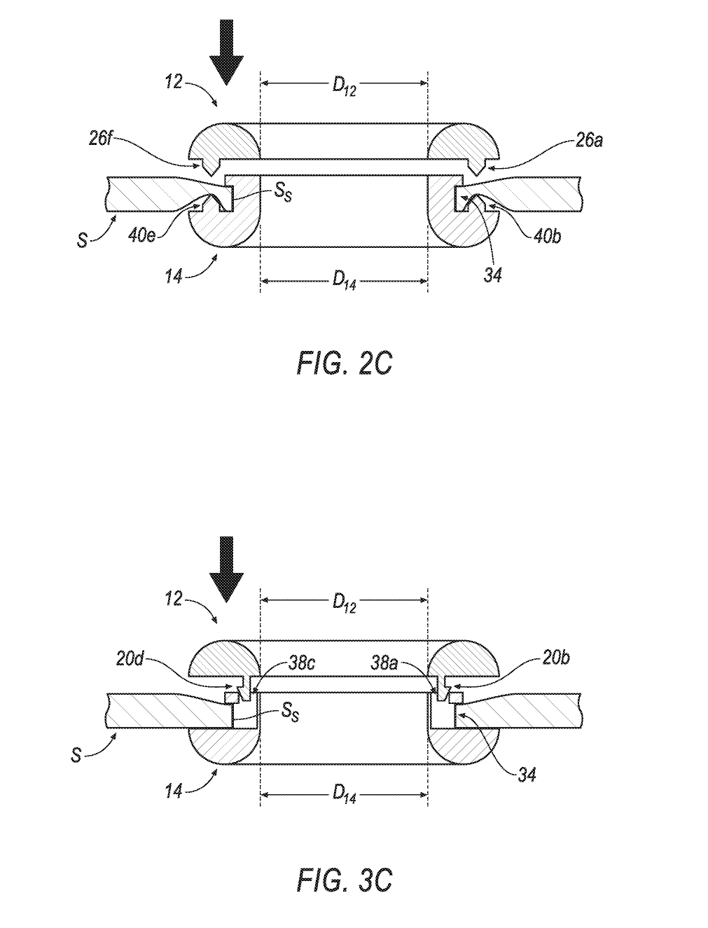

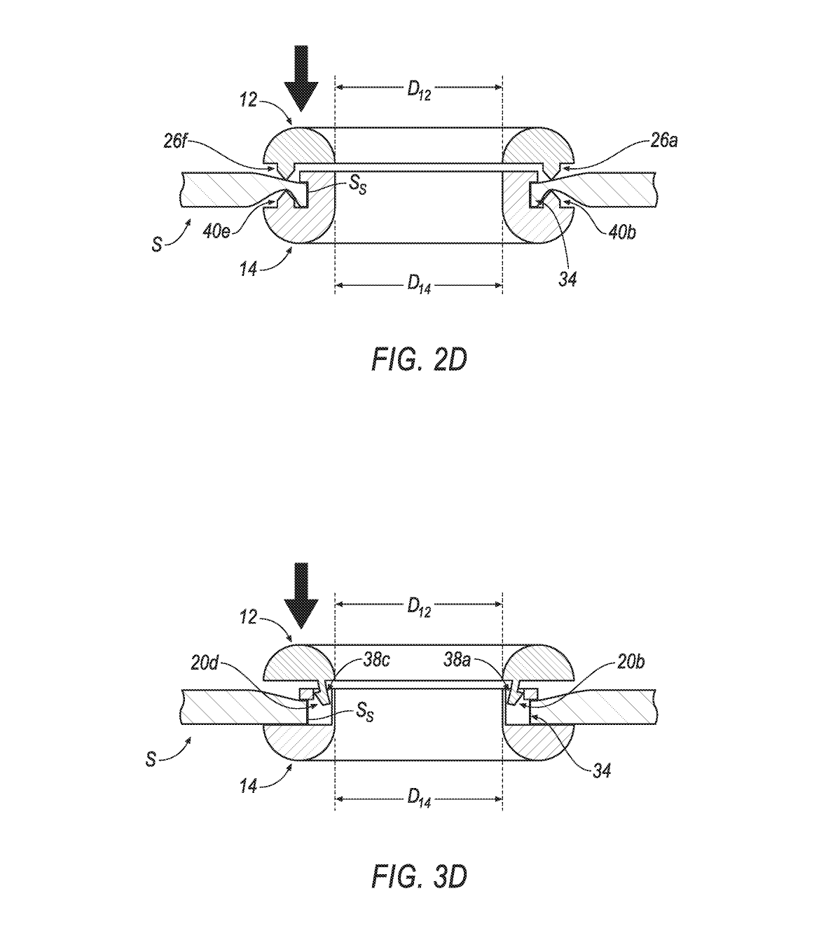

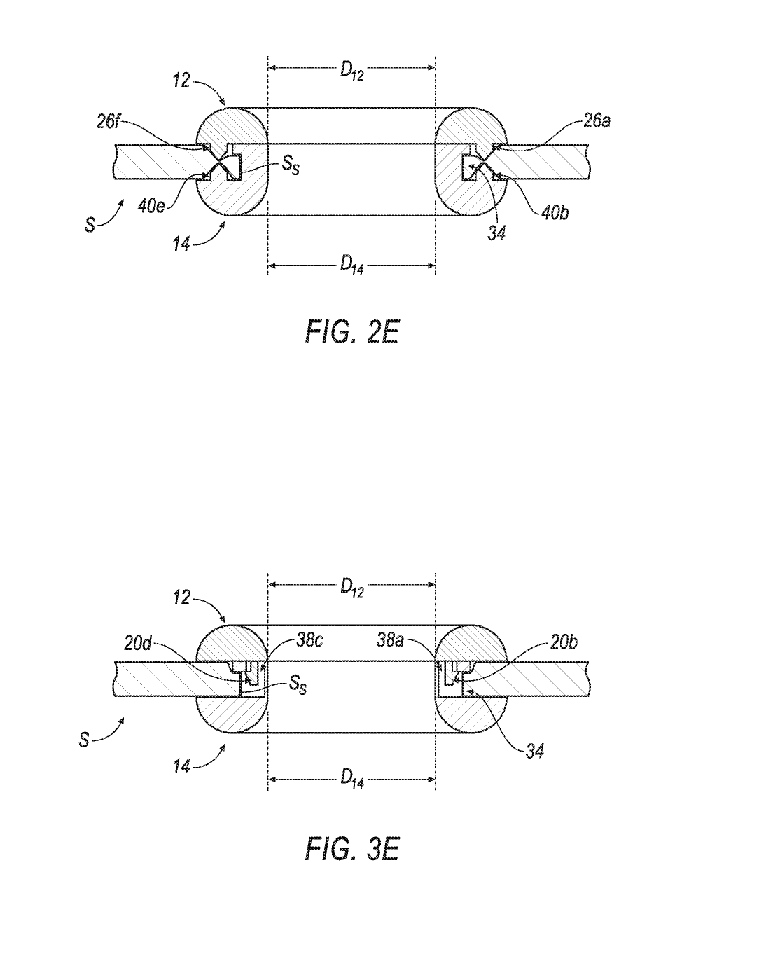

Referring to FIG. 2A₁, each of the first projection 26a, the second projection 26b, the third projection 26c, the fourth projection 26d, the fifth projection 26e, the sixth projection 26f, the seventh projection 26g and the eighth projection 26h include an axially-extending body 30 defined by a proximal cylindrical portion 30a and a distal conical portion 30b. The proximal cylindrical portion 30a includes a proximal end 30a_{P}, a distal end 30a_{D} and a radial outer surface 30a_{RO}. The distal conical portion 30b includes an axial surface 30b_{A} that extends from the radial outer surface 30a_{RO} of the cylindrical portion 30a and terminates at a tip 30b_{T}. Each of the first projection 26a, the second projection 26b, the third projection 26c, the fourth projection 26d, the fifth projection 26e, the sixth projection 26f, the seventh projection 26g and the eighth projection 26h is defined by a length dimension L₂₆ (see, e.g., FIG. 2A₁) extending between the substrate-facing surface 12b of the first trim member 12 and the tip 30b_{T} of the distal conical portion 30b.

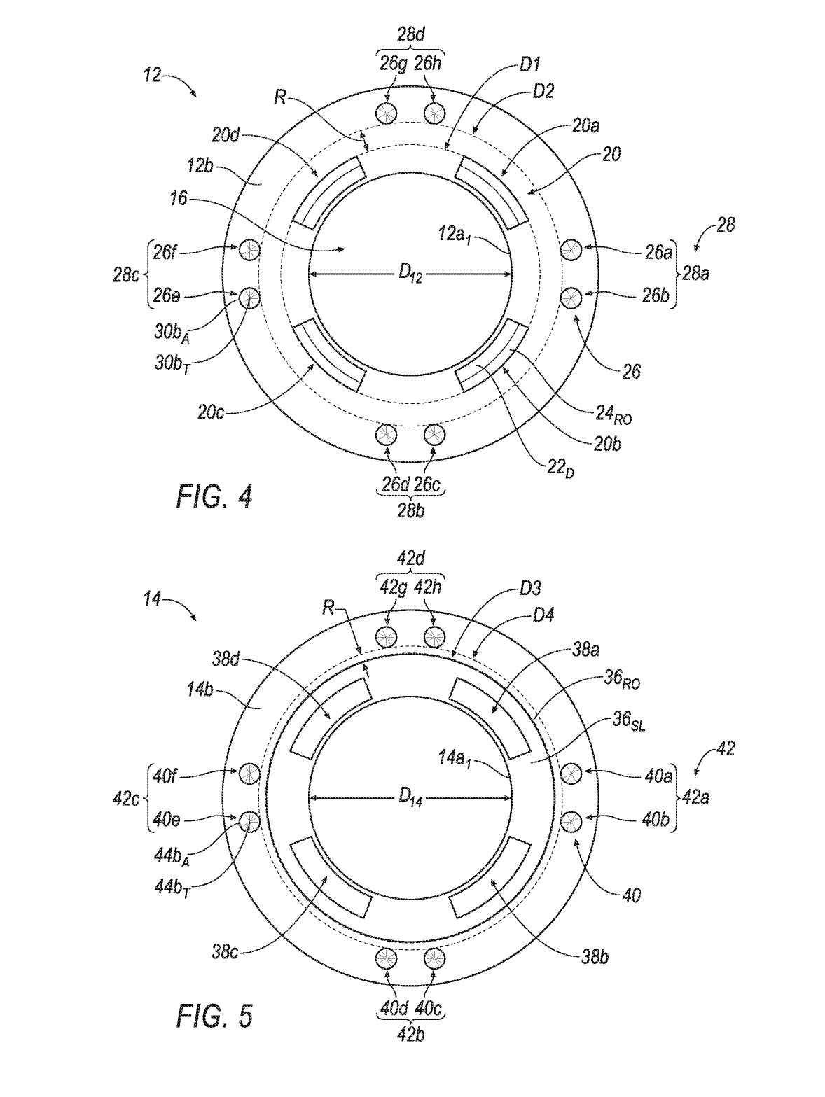

Referring to FIG. 4, a first circular perimeter is shown generally at a first dashed circular line D1, and a second circular perimeter is shown generally at a second dashed circular line D2, which is concentrically arranged with respect to the first dashed circular line D1. A radial double-arrow line R is shown radially extending between the first dashed circular line D1 and the second dashed circular line D2. The first dashed circular line D1 is shown extending across a radially-outwardly-most portion of the first plurality of circumferentially-arranged projections 20. The second dashed circular line D2 is shown tangentially extending across a radially-inwardly-most portion of the second plurality of circumferentially-arranged projections 26. The radial double-arrow line R demonstrates that the second plurality of circumferentially-arranged projections 26 is arranged radially outwardly with respect to the first plurality of circumferentially-arranged projections 20.

Referring again to FIG. 1A, a circumferential projection 32 extends axially away from the substrate-facing surface 14b of the second trim member 14. In some instances, the circumferential projection 32 includes an axially-extending portion 34 and a radially-extending portion 36.

As seen in FIG. 3A₂, the axially-extending portion 34 includes a proximal end 34_{P}, a distal end surface 34_{D}, a radially-inwardly-facing surface 34_{RI} and a radially-outwardly-facing surface 34_{RO}. The proximal end 34_{P} of the axially-extending portion 34 extends axially away from the substrate-facing surface 14b of the second trim member 14.

Referring to FIG. 3A₂, the radially-extending portion 36 includes a radially-outwardly-facing surface 36_{RO} and a lower shoulder surface 36_{SL} and an upper shoulder surface 36_{SU}. The radially-outwardly-facing surface 36_{RO} of the radially-extending portion 36 connects the lower shoulder surface 36_{SL} to the upper shoulder surface 36_{SU}. The radially-extending portion 36 is defined by a thickness T₃₆ extending between the lower shoulder surface 36_{SL} and the upper shoulder surface 36_{SU}.

Referring again to FIG. 1A, the radially-extending portion 36 defines a plurality of circumferentially-arranged passages 38. The plurality of circumferentially-arranged passages 38 extends axially through the thickness T₃₆ (see, e.g., FIG. 3A₂) of the radially-extending portion 36. In some instances, the plurality of circumferentially-arranged passages 38 includes a first passage 38a, a second passage 38b, a third passage 38c and a fourth passage 38d that are respectively offset by approximately 90°. Each of the first passage 38a, the second passage 38b, the third passage 38c and the fourth passage 38d includes a substantially arcuate shape.

A plurality of circumferentially-arranged projections 40 extends axially away from the substrate-facing surface 14b of the second trim member 14. In some instances, the plurality of circumferentially-arranged projections 40 includes a first projection 40a, a second projection 40b, a third projection 40c, a fourth projection 40d, a fifth projection 40e, a sixth projection 40f, a seventh projection 40g and an eighth projection 40h that are grouped into a plurality of pairs of projections 42 that are respectively offset by approximately 90°. The first projection 40a and the second projection 40b are arranged as a first pair of projections 42a of the plurality of pairs of projections 42. The third projection 40c and the fourth projection 40d are arranged as a second pair of projections 42b of the plurality of pairs of projections 42. The fifth projection 40e and the sixth projection 40f are arranged as a third pair of projections 42c of the plurality of pairs of projections 42. The seventh projection 40g and the eighth projection 40h are arranged as a fourth pair of projections 42d of the plurality of pairs of projections 42.

Referring to FIG. 2A₂, each of the first projection 40a, the second projection 40b, the third projection 40c, the fourth projection 40d, the fifth projection 40e, the sixth projection 40f, the seventh projection 40g and the eighth projection 40h includes an axially-extending body 44 defined by a proximal cylindrical portion 44a and a distal conical portion 44b. The proximal cylindrical portion 44a includes a proximal end 44a_{P}, a distal end 44a_{D} and a radial outer surface 44a_{RO}. The distal conical portion 44b includes an axial surface 44b_{A} that extends from the radial outer surface 44a_{RO} of the cylindrical portion 44a and terminates at a tip 44b_{T}. Each of the first projection 40a, the second projection 40b, the third projection 40c, the fourth projection 40d, the fifth projection 40e, the sixth projection 40f, the seventh projection 40g and the eighth projection 40h is defined by a length dimension L₄₀ (see, e.g., FIG. 2A₂) extending between the substrate-facing surface 14b of the second trim member 14 and the tip 44b_{T} of the distal conical portion 44b.

Referring to FIG. 5, a third circular perimeter is shown generally at a third dashed circular line D3, and a fourth circular perimeter is shown generally at a fourth dashed circular line D4, which is concentrically arranged with respect to the third dashed circular line D3. A radial double-arrow line R is shown radially extending between the third dashed circular line D3 and the fourth dashed circular line D4. The third dashed circular line D3 is shown extending across the radially-outwardly-facing surface 36_{RO} of the radially-extending portion 36 of the circumferential projection 32. The fourth dashed circular line D4 is shown tangentially extending across a radially-inwardly-most portion of the plurality of circumferentially-arranged projections 40. The radial double-arrow line R demonstrates that the plurality of circumferentially-arranged projections 40 is arranged radially outwardly with respect to the radially-outwardly-facing surface 36_{RO} of the radially-extending portion 36 of the circumferential projection 32.

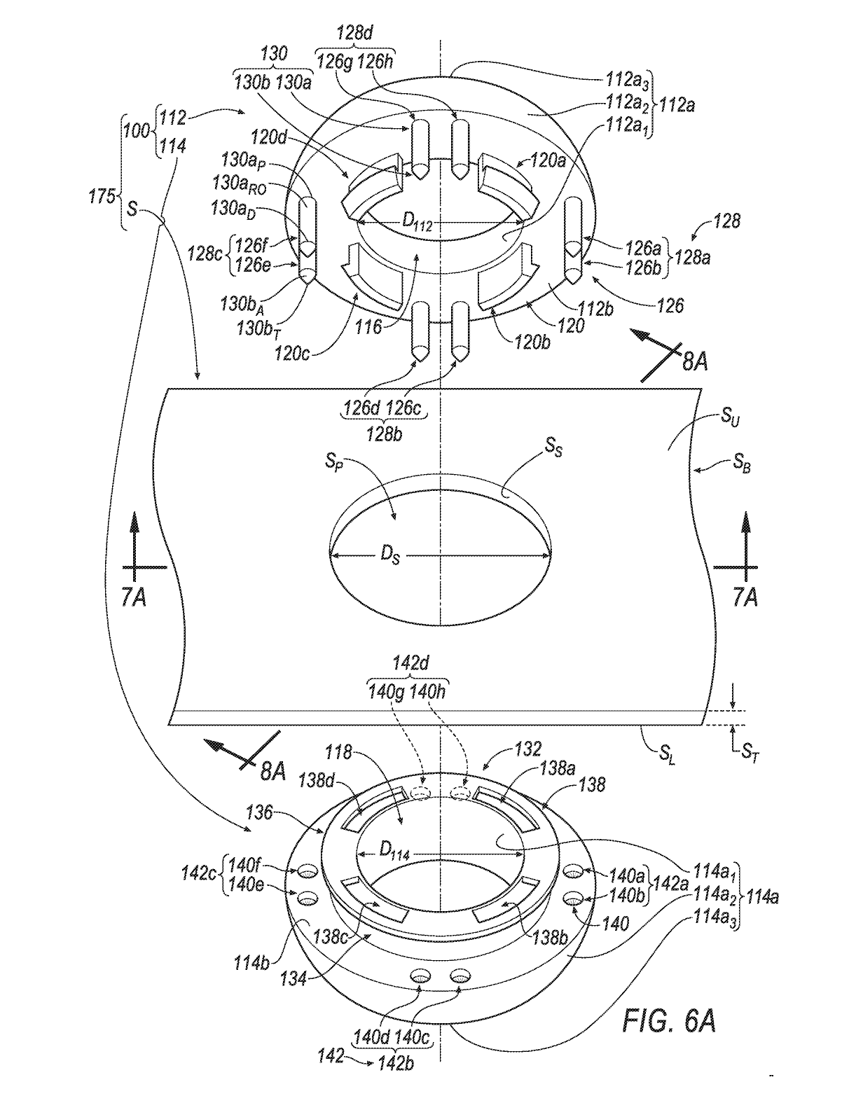

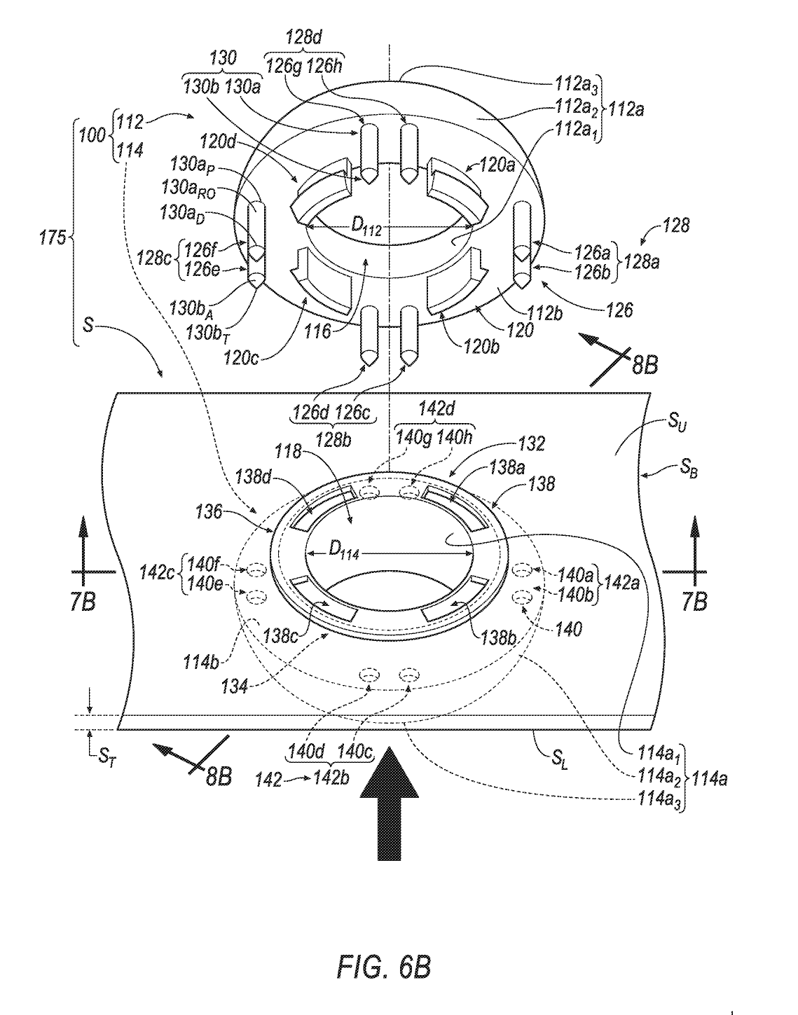

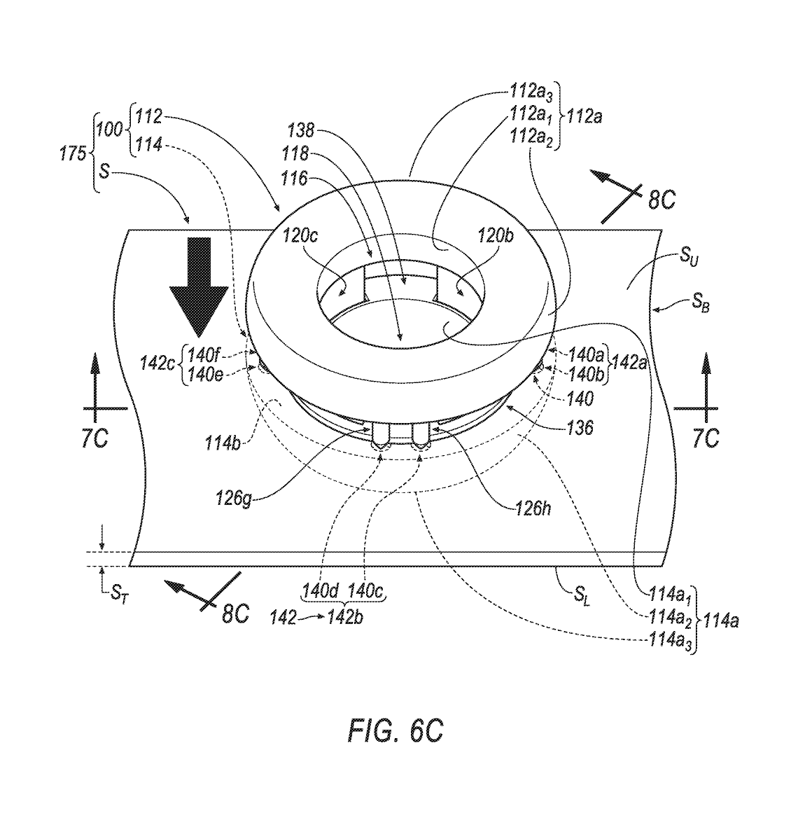

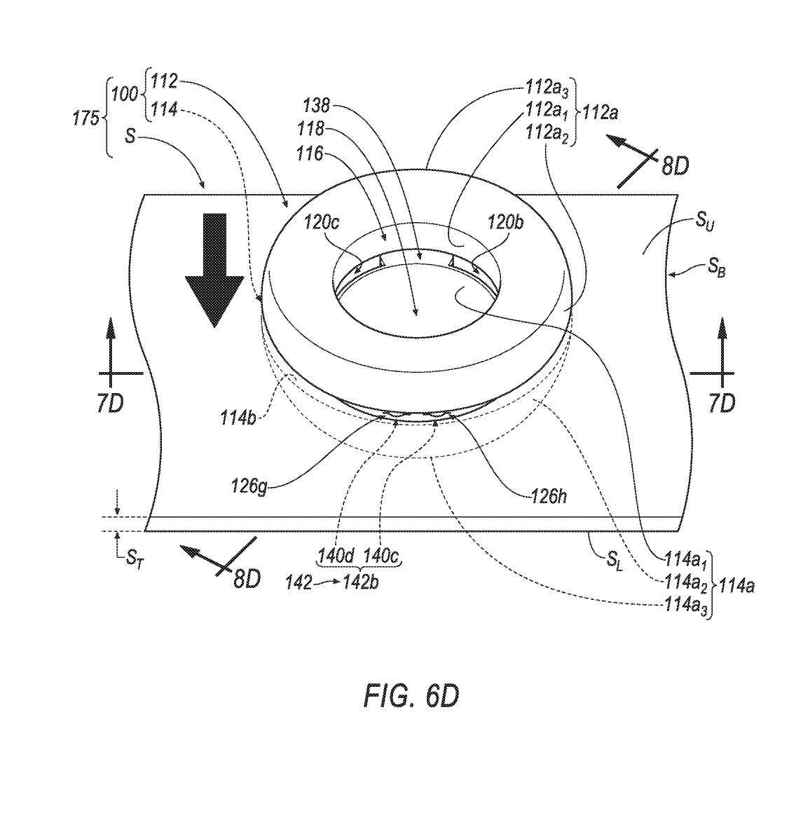

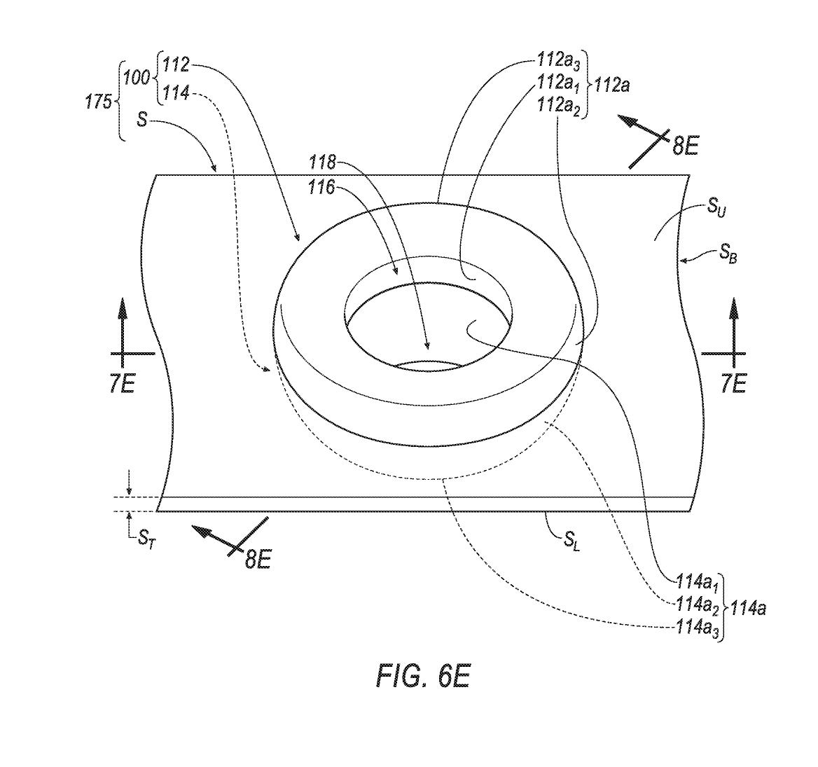

FIGS. 6A-10 illustrate an exemplary trim assembly 100 joined to a substrate S to form a trimmed assembly 175. As seen in FIG. 6A, the trim assembly 100 includes a first trim member 112 and a second trim member 114. The first trim member 112 includes an aesthetically-pleasing surface 112a and a substrate-facing surface 112b. The second trim member 114 includes an aesthetically-pleasing surface 114a and a substrate-facing surface 114b.

With continued reference to FIG. 6A, the substrate S is defined by a body S_{B} having an upper surface S_{U}, a lower surface S_{L} and a side surface S_{S} joining the upper surface S_{U} to the lower surface S_{L}. The body S_{B} is defined by a thickness S_{T} extending between the upper surface S_{U} to the lower surface S_{L}. The side surface S_{S} forms a passage Sₚ extending through the thickness S_{T} of the body S_{B}. The passage S_{P} extending through the thickness S_{T} of the body S_{B} may be defined by a diameter D_{S}.

The aesthetically-pleasing surface 112a of the first trim member 112 may include any desirable shape or surface profile. In some instances, the aesthetically-pleasing surface 112a includes an inner side surface 112a₁, an outer side surface 112a₂ and an intermediate surface 112a₃ joining the inner side surface 112a₁ to the outer side surface 112a₂. The inner side surface 112a₁ may define a passage 116 extending through the first trim member 112. The passage 116 extending through the first trim member 112 may be defined by a diameter D₁₁₂.

The aesthetically-pleasing surface 114a of the second trim member 114 may include any desirable shape or surface profile. In some instances, the aesthetically-pleasing surface 114a includes an inner side surface 114a₁, an outer side surface 114a₂ and an intermediate surface 114a₃ joining the inner side surface 114a₁ to the outer side surface 114a₂. The inner side surface 114a₁ may define a passage 118 extending through the second trim member 114. The passage 118 extending through the second trim member 114 may be defined by a diameter D₁₁₄.

A first plurality of circumferentially-arranged projections 120 extends axially away from the substrate-facing surface 112b of the first trim member 112. In some instances, the first plurality of circumferentially-arranged projections 120 includes a first projection 120a, a second projection 120b, a third projection 120c and a fourth projection 120d that are respectively offset by approximately 90° . Each of the first projection 120a, the second projection 120b, the third projection 120c and the fourth projection 120d includes a substantially arcuate shape having an axially-extending portion 122 (see, e.g., FIG. 8A₁) and a radially-extending portion 124 (see, e.g., FIG. 8A₁).

Referring to FIG. 8A₁, the axially-extending portion 122 includes a proximal end 122_{P}, a distal end surface 122_{D}, a radially-inwardly-facing surface 122_{RI} and a radially-outwardly-facing surface 122_{RO}. The proximal end 122_{P} of the axially-extending portion 122 extends axially away from the substrate-facing surface 112b of the first trim member 112. The radially-extending portion 124 includes a radially-outwardly-facing surface 124_{RO} and a shoulder surface 124_{S}. The radially-outwardly-facing surface 124_{RO} of the radially-extending portion 124 connects the shoulder surface 124_{S} to the distal end surface 122_{D} of the axially-extending portion 122. The radially-outwardly-facing surface 124_{RO} of the radially-extending portion 124 extends away from the distal end surface 122_{D} of the axially-extending portion 122 at an angle θ (see, e.g., FIG. 8A₁). The shoulder surface 124_{S} is arranged in an opposing relationship with respect to the substrate-facing surface 112b of the first trim member 112 and is spaced from the substrate-facing surface 112b of the first trim member 112 at a length dimension L₁₂₄ (see, e.g., FIG. 8A₁) Each of the first projection 120a, the second projection 120b, the third projection 120c and the fourth projection 120d is defined by a length dimension L₁₂₀ (see, e.g., FIG. 8A₁) extending between the substrate-facing surface 112b of the first trim member 112 and the distal end surface 122_{D} of the axially-extending portion 122.

Referring to FIG. 6A, a second plurality of circumferentially-arranged projections 126 extend axially away from the substrate-facing surface 112b of the first trim member 112. In some instances, the second plurality of circumferentially-arranged projections 126 includes a first projection 126a, a second projection 126b, a third projection 126c, a fourth projection 126d, a fifth projection 126e, a sixth projection 126f, a seventh projection 126g and an eighth projection 126h that are grouped into a plurality of pairs of projections 128 that are respectively offset by approximately 90°. The first projection 126a and the second projection 126b are arranged as a first pair of projections 128a of the plurality of pairs of projections 128. The third projection 126c and the fourth projection 126d are arranged as a second pair of projections 128b of the plurality of pairs of projections 128. The fifth projection 126e and the sixth projection 126f are arranged as a third pair of projections 128c of the plurality of pairs of projections 128. The seventh projection 126g and the eighth projection 126h are arranged as a fourth pair of projections 128d of the plurality of pairs of projections 128.

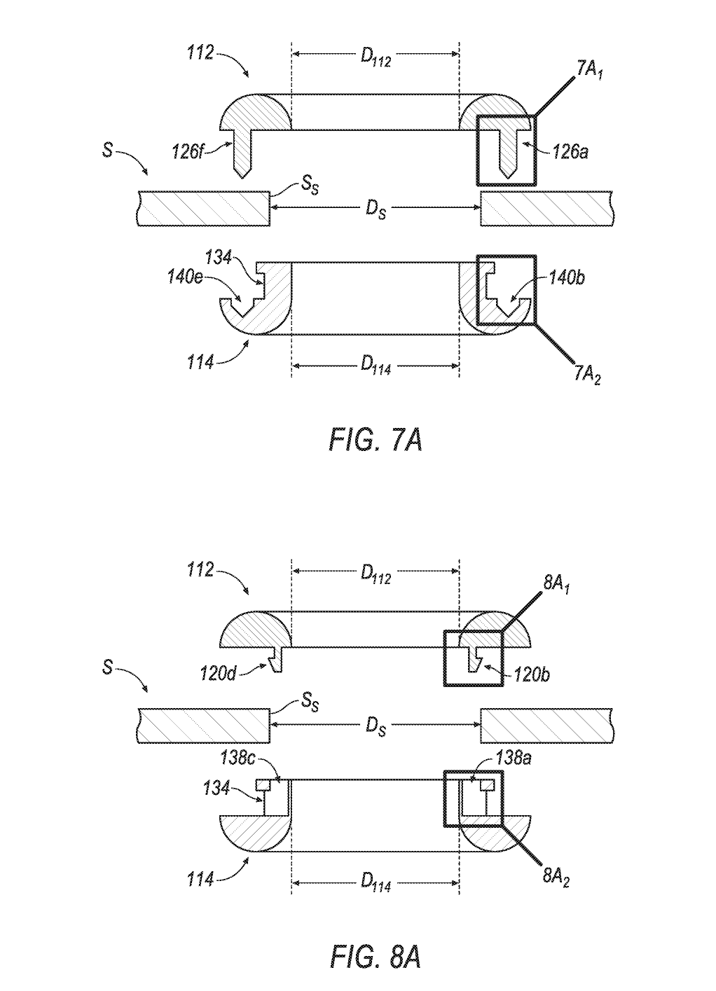

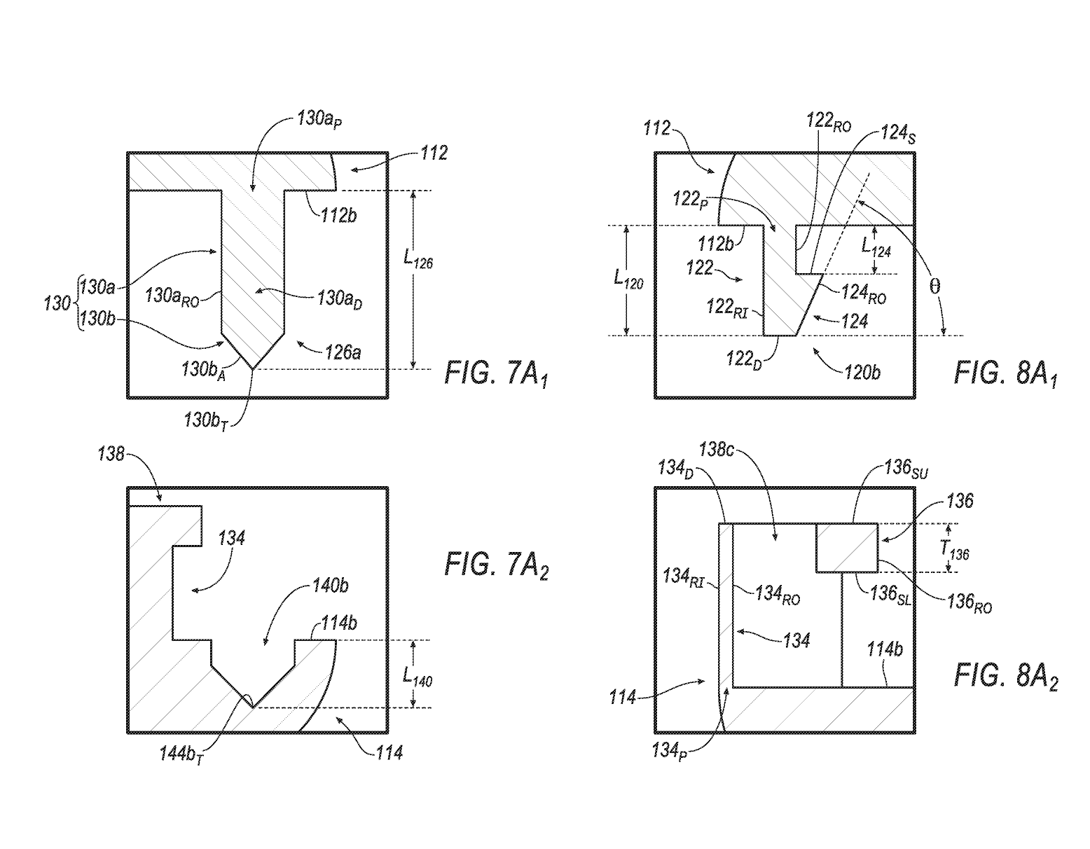

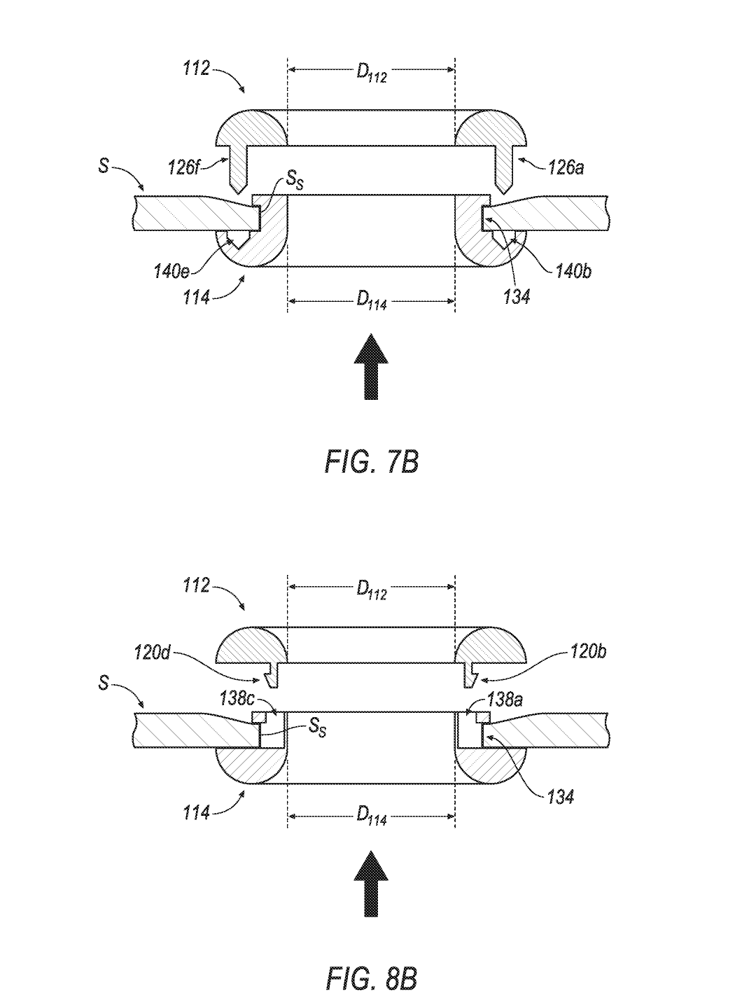

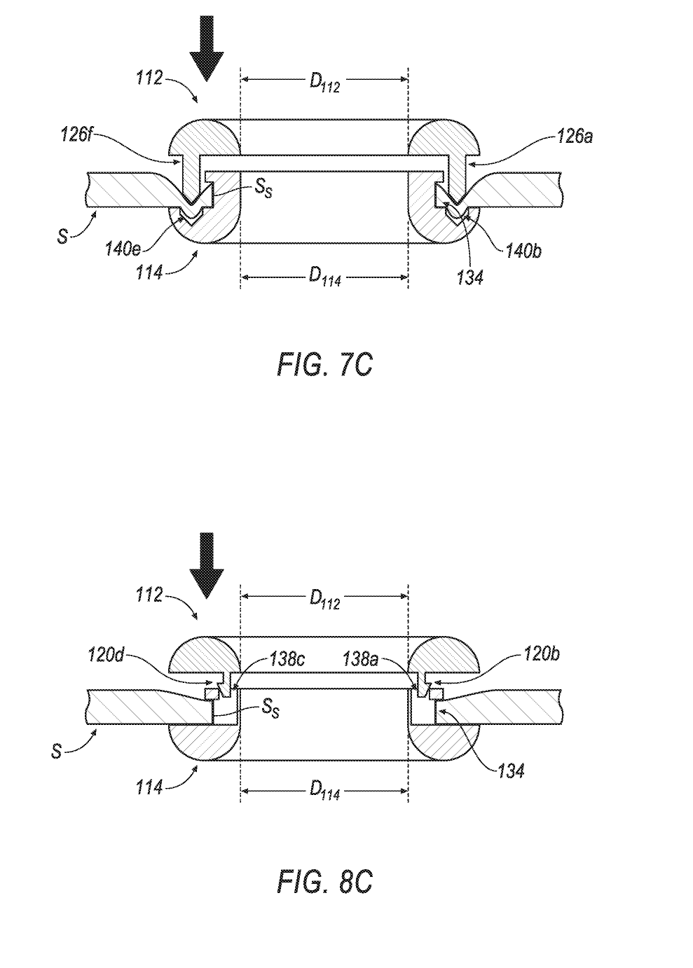

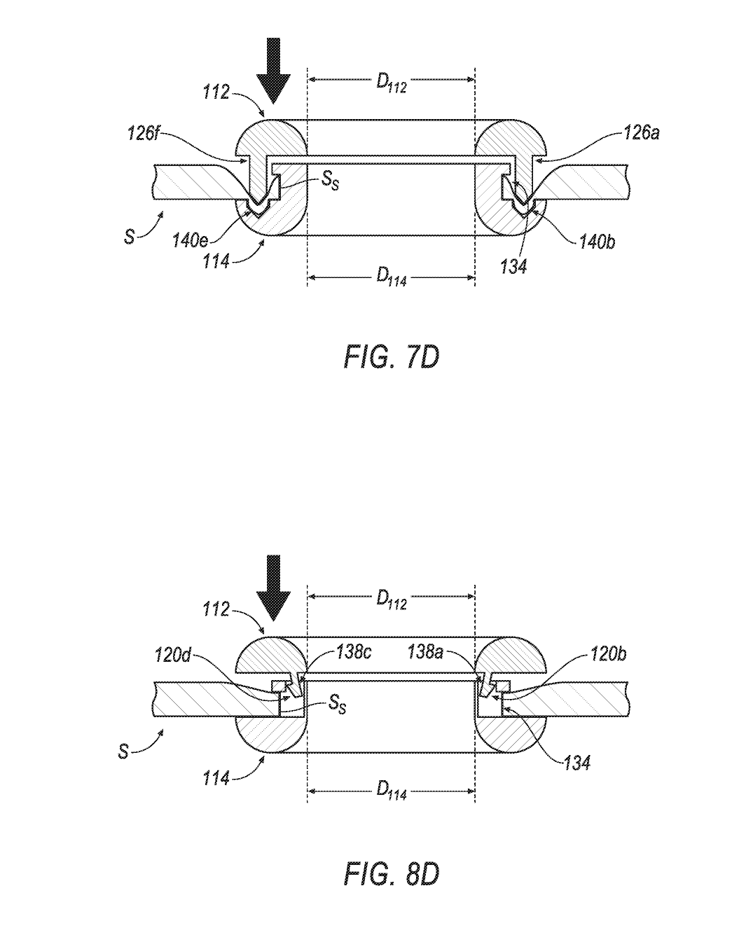

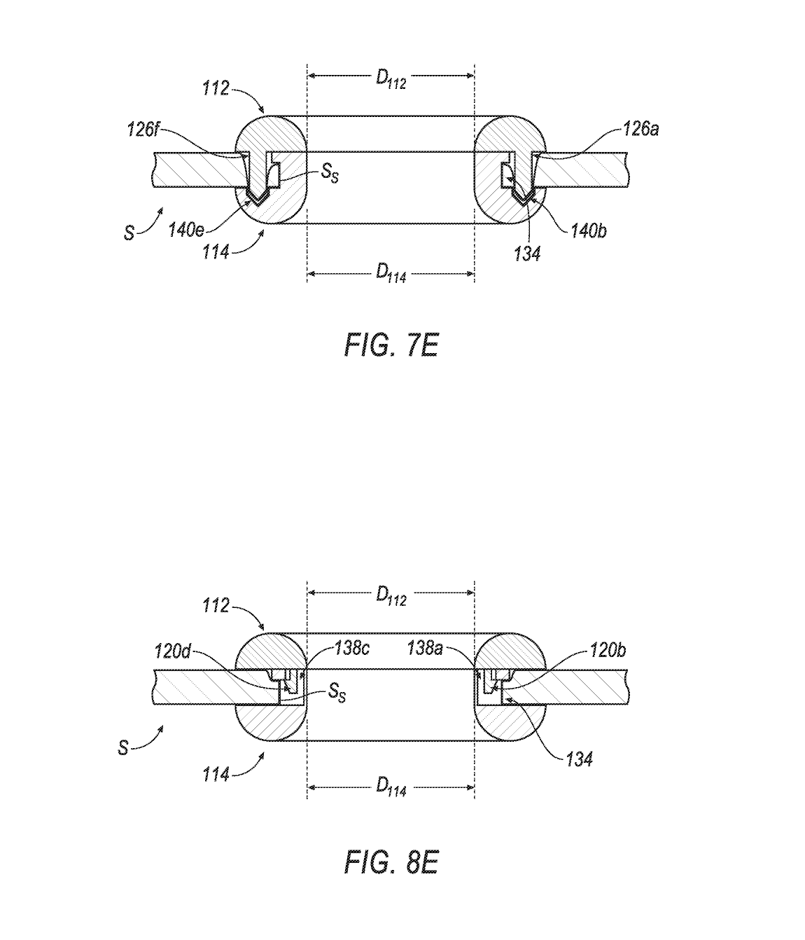

Referring to FIG. 7A₁, each of the first projection 126a, the second projection 126b, the third projection 126c, the fourth projection 126d, the fifth projection 126e, the sixth projection 126f, the seventh projection 126g and the eighth projection 126h includes an axially-extending body 130 defined by a proximal cylindrical portion 130a and a distal conical portion 130b. The proximal cylindrical portion 130a includes a proximal end 130a_{P}, a distal end 130a_{D} and a radial outer surface 130a_{RO}. The distal conical portion 130b includes an axial surface 130b_{A} that extends from the radial outer surface 130a_{RO} of the cylindrical portion 130a and terminates at a tip 130b_{T}. Each of the first projection 126a, the second projection 126b, the third projection 126c, the fourth projection 126d, the fifth projection 126e, the sixth projection 126f, the seventh projection 126g and the eighth projection 126h is defined by a length dimension L₁₂₆ (see, e.g., FIG. 7A₁) extending between the substrate-facing surface 112b of the first trim member 112 and the tip 130b_{T} of the distal conical portion 130b.

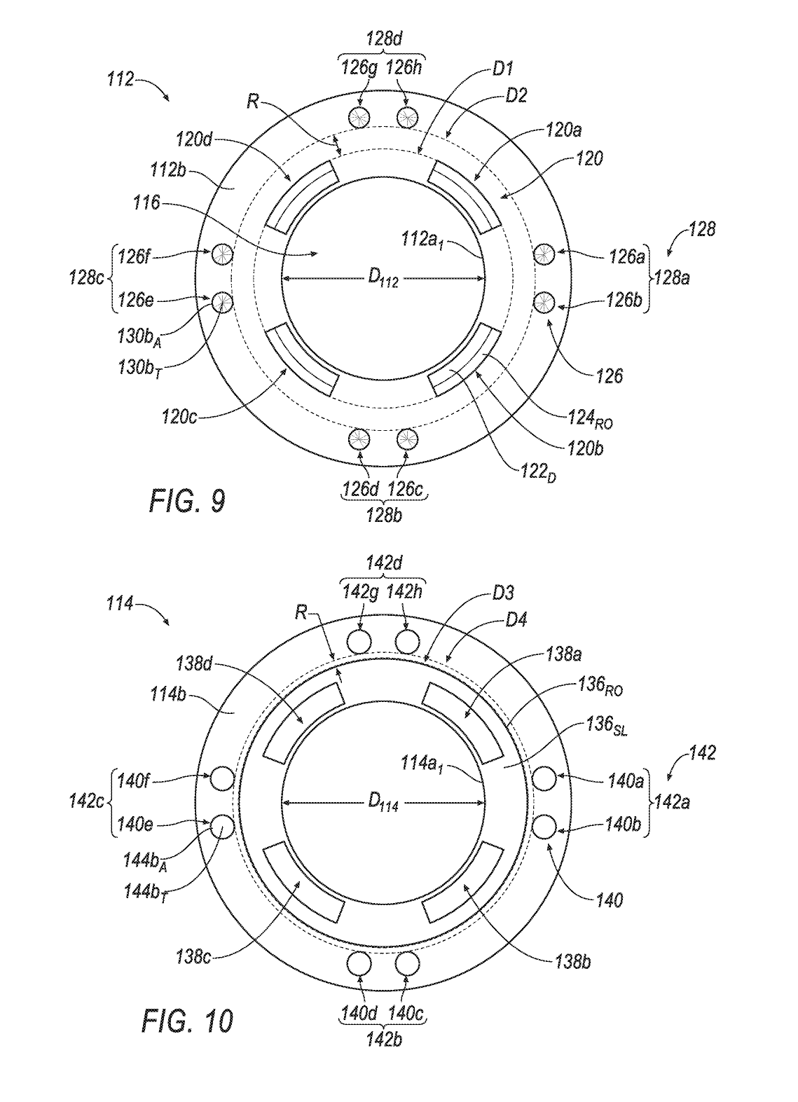

Referring to FIG. 9, a first circular perimeter is shown generally at a first dashed circular line D1, and a second circular perimeter is shown generally at a second dashed circular line D2, which is concentrically arranged with respect to the first dashed circular line D1. A radial double-arrow line R is shown radially extending between the first dashed circular line D1 and the second dashed circular line D2. The first dashed circular line D1 is shown extending across a radially-outwardly-most portion of the first plurality of circumferentially-arranged projections 120. The second dashed circular line D2 is shown tangentially extending across a radially-inwardly-most portion of the second plurality of circumferentially-arranged projections 126. The radial double-arrow line R demonstrates that the second plurality of circumferentially-arranged projections 126 is arranged radially outwardly with respect to the first plurality of circumferentially-arranged projections 120.

Referring again to FIG. 6A, a circumferential projection 132 extends axially away from the substrate-facing surface 114b of the second trim member 114. In some instances, the circumferential projection 132 includes an axially-extending portion 134 and a radially-extending portion 136.

As seen in FIG. 8A₂, the axially-extending portion 134 includes a proximal end 134_{P}, a distal end surface 134_{D}, a radially-inwardly-facing surface 134_{RI} and a radially-outwardly-facing surface 134_{RO}. The proximal end 134_{P} of the axially-extending portion 134 extends axially away from the substrate-facing surface 114b of the second trim member 114. The radially-extending portion 136 includes a radially-outwardly-facing surface 136_{RO} and a lower shoulder surface 136_{SL} and an upper shoulder surface 136_{SU}. The radially-outwardly-facing surface 136_{RO} of the radially-extending portion 136 connects the lower shoulder surface 136_{SL} to the upper shoulder surface 136_{SU}. The radially-extending portion 136 is defined by a thickness T₁₃₆ extending between the lower shoulder surface 136_{SL} and the upper shoulder surface 136_{SU}.

Referring again to FIG. 6A, the radially-extending portion 136 defines a first plurality of circumferentially-arranged passages 138. The first plurality of circumferentially-arranged passages 138 extends axially through the thickness T₁₃₆ (see, e.g., FIG. 8A₂) of the radially-extending portion 136. In some instances, the first plurality of circumferentially-arranged passages 138 includes a first passage 138a, a second passage 138b, a third passage 138c and a fourth passage 138d that are respectively offset by approximately 90°. Each of the first passage 138a, the second passage 138b, the third passage 138c, and the fourth passage 138d includes a substantially arcuate shape.

A second plurality of circumferentially-arranged passages 140 extends axially into the substrate-facing surface 114b of the second trim member 114. In some instances, the second plurality of circumferentially-arranged passages 140 includes a first passage 140a, a second passage 140b, a third passage 140c, a fourth passage 140d, a fifth passage 140e, a sixth passage 140f, a seventh passage 140g and an eighth passage 140h that are grouped into a plurality of pairs of passages 142 that are respectively offset by approximately 90°. The first passage 140a and the second passage 140b are arranged as a first pair of passages 142a of the plurality of pairs of passages 142. The third passage 140c and the fourth passage 140d are arranged as a second pair of passages 142b of the plurality of pairs of passages 142. The fifth passage 140e and the sixth passage 140f are arranged as a third pair of passages 142c of the plurality of pairs of passages 142. The seventh passage 140g and the eighth passage 140h are arranged as a fourth pair of passages 142d of the plurality of pairs of passages 142.

Referring to FIG. 7A₂, each of the first passage 140a, the second passage 140b, the third passage 140c, the fourth passage 140d, the fifth passage 140e, the sixth passage 140f, the seventh passage 140g and the eighth passage 140h defines a spatial void that geometrically corresponds to a dimension defined by the distal conical portion 130b and at least a portion of the length of the cylindrical portion 130a of the axially-extending body 130 of each of the first projection 126a, the second projection 126b, the third projection 126c, the fourth projection 126d, the fifth projection 126e, the sixth projection 126f, the seventh projection 126g and the eighth projection 126h of the plurality of pairs of projections 128. Each of the first passage 140a, the second passage 140b, the third passage 140c, the fourth passage 140d, the fifth passage 140e, the sixth passage 140f, the seventh passage 140g and the eighth passage 140h defines a length dimension L₁₄₀ (see, e.g., FIG. 7A₂) extending between the substrate-facing surface 114b of the second trim member 114 and a distal tip-receiving surface 144b_{T} that geometrically corresponds to the tip 130b_{T} of the distal conical portion 130b of each of the first projection 126a, the second projection 126b, the third projection 126c, the fourth projection 126d, the fifth projection 126e, the sixth projection 126f, the seventh projection 126g and the eighth projection 126h of the plurality of pairs of projections 128.

Referring to FIG. 10, a third circular perimeter is shown generally at a third dashed circular line D3, and a fourth circular perimeter is shown generally at a fourth dashed circular line D4, which is concentrically arranged with respect to the third dashed circular line D3. A radial double-arrow line R is shown radially extending between the third dashed circular line D3 and the fourth dashed circular line D4. The third dashed circular line D3 is shown extending across the radially-outwardly-facing surface 136_{RO} of the radially-extending portion 136 of the circumferential projection 132. The fourth dashed circular line D4 is shown tangentially extending across a radially-inwardly-most portion of the second plurality of circumferentially-arranged passages 140. The radial double-arrow line R demonstrates that the second plurality of circumferentially-arranged passages 140 is arranged radially outwardly with respect to the radially-outwardly-facing surface 136_{RO} of the radially-extending portion 136 of the circumferential projection 132.

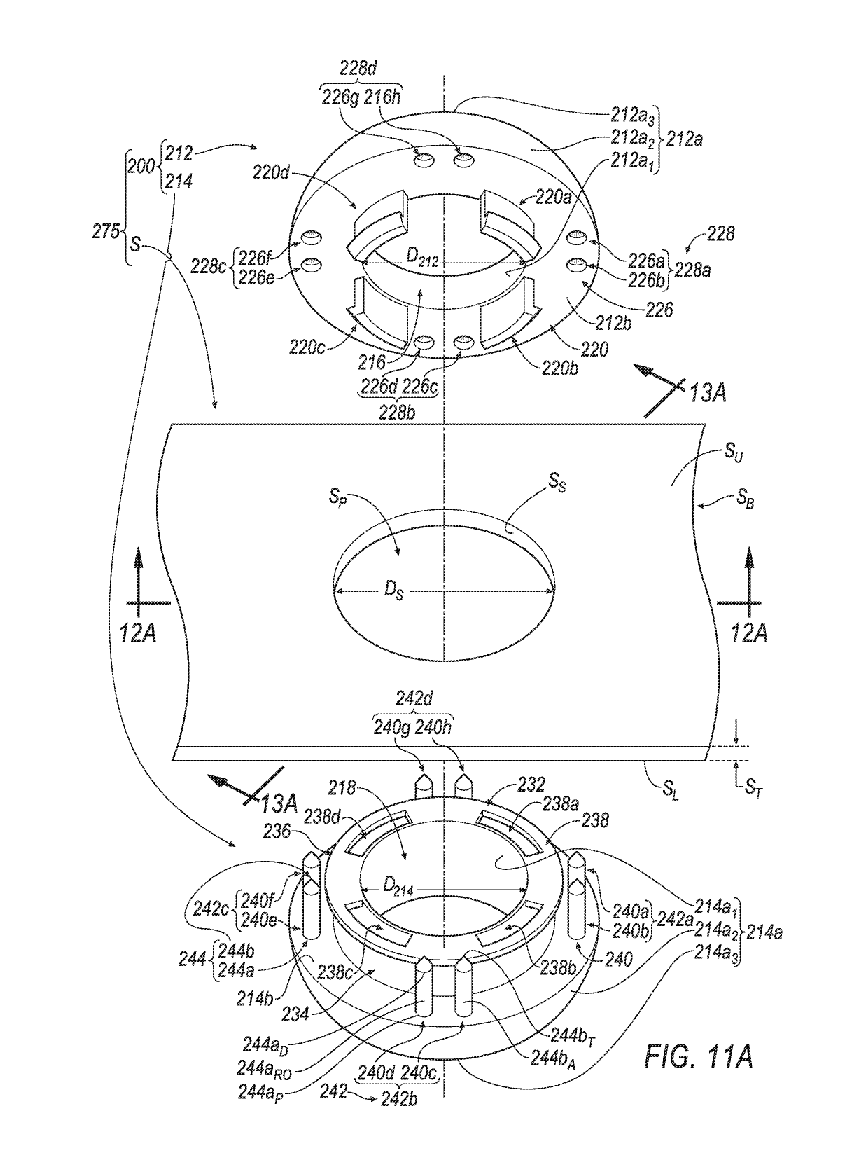

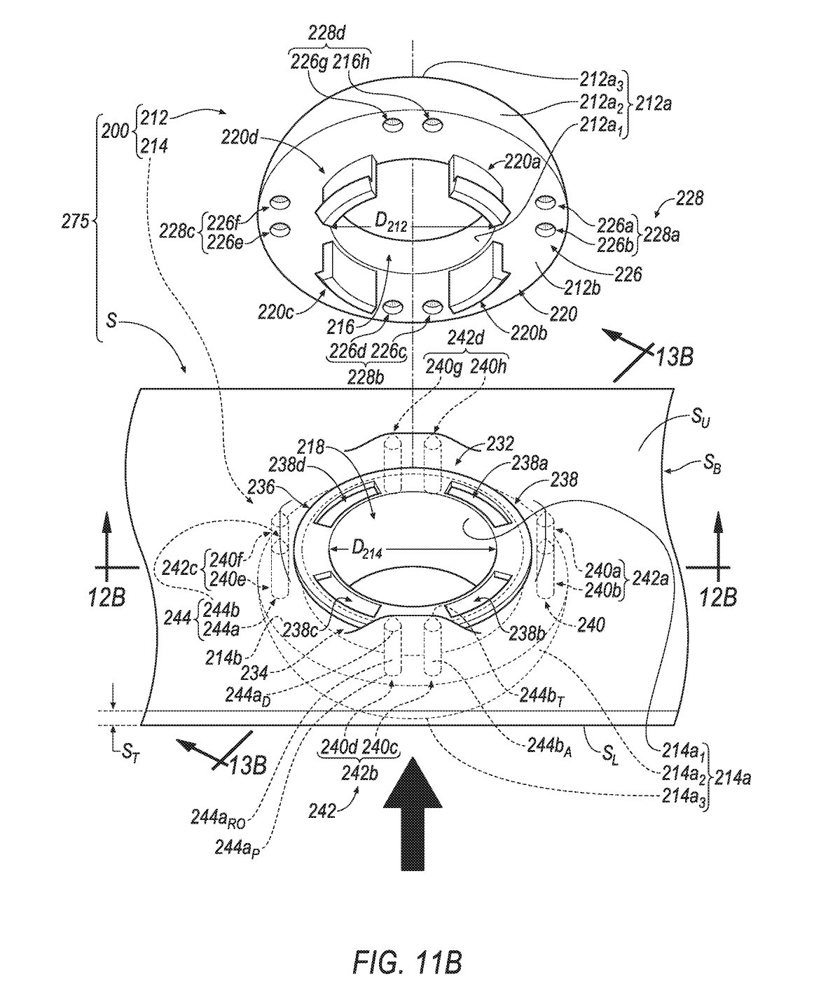

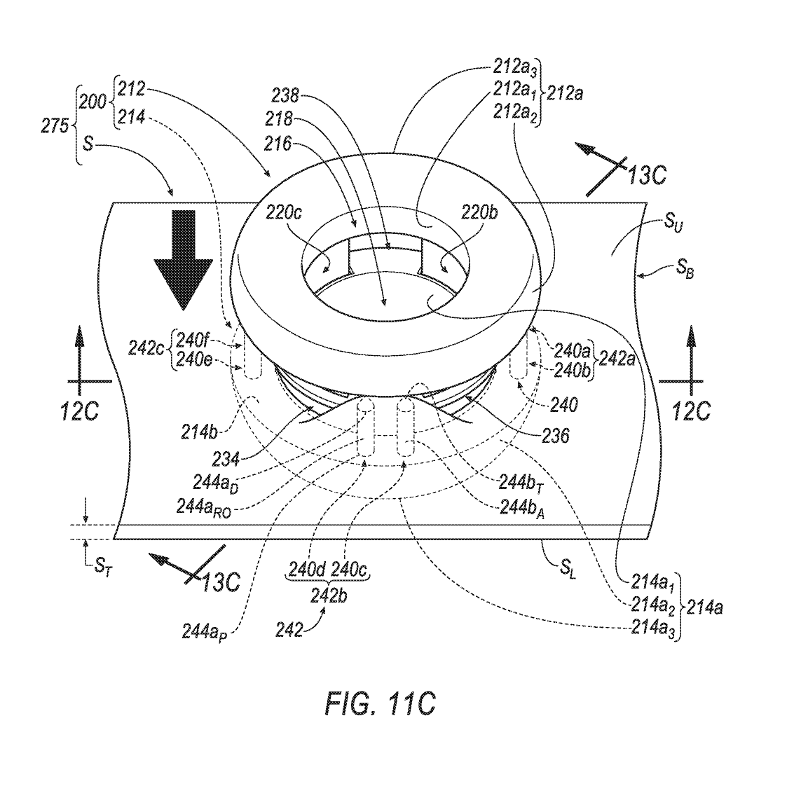

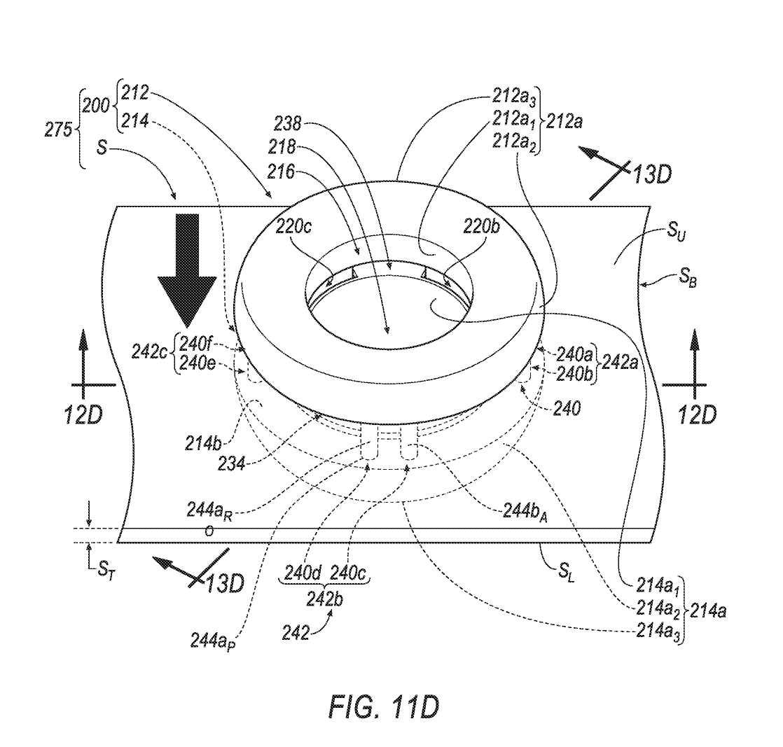

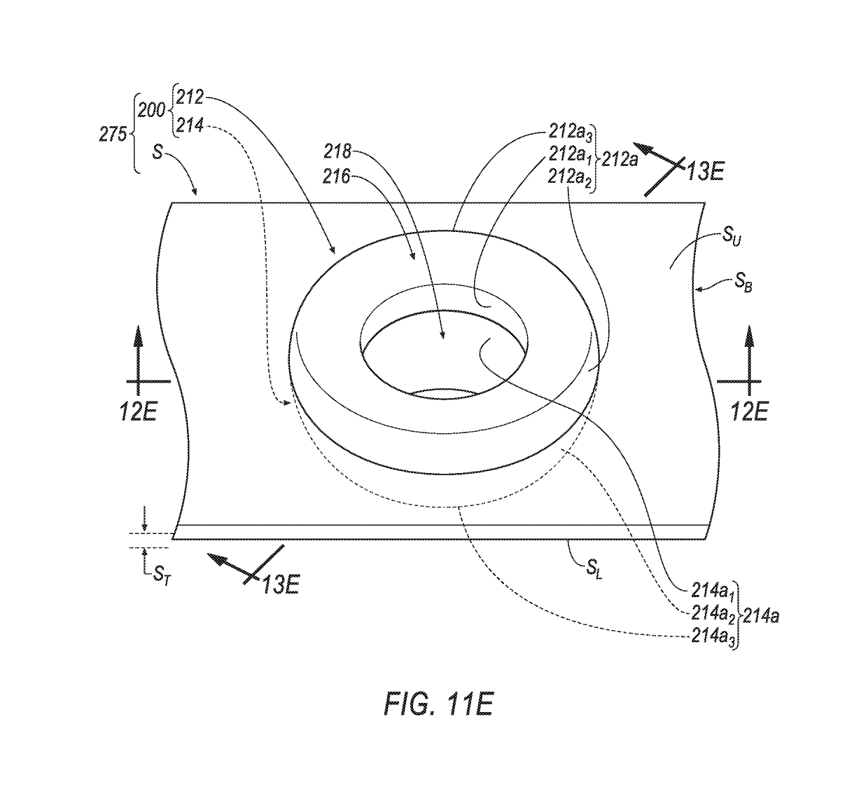

FIGS. 11A-15 illustrate an exemplary trim assembly 200 joined to a substrate S to form a trimmed assembly 275. As seen in FIG. 11A, the trim assembly 200 includes a first trim member 212 and a second trim member 214. The first trim member 212 includes an aesthetically-pleasing surface 212a and a substrate-facing surface 212b. The second trim member 214 includes an aesthetically-pleasing surface 214a and a substrate-facing surface 214b.

With continued reference to FIG. 11A, the substrate S is defined by a body S_{B} having an upper surface S_{U}, a lower surface S_{L} and a side surface S_{S} joining the upper surface S_{U} to the lower surface S_{L}. The body S_{B} is defined by a thickness S_{T} extending between the upper surface S_{U} to the lower surface S_{L}. The side surface S_{S} forms a passage S_{P} extending through the thickness S_{T} of the body S_{B}. The passage S_{P} extending through the thickness S_{T} of the body S_{B} may be defined by a diameter D_{S}.

The aesthetically-pleasing surface 212a of the first trim member 212 may include any desirable shape or surface profile. In some instances, the aesthetically-pleasing surface 212a includes an inner side surface 212a₁, an outer side surface 212a₂ and an intermediate surface 212a₃ joining the inner side surface 212a₁ to the outer side surface 212a₂. The inner side surface 212a₁ may define a passage 216 extending through the first trim member 212. The passage 216 extending through the first trim member 212 may be defined by a diameter D₂₁₂.

The aesthetically-pleasing surface 214a of the second trim member 214 may include any desirable shape or surface profile. In some instances, the aesthetically-pleasing surface 214a includes an inner side surface 214a₁, an outer side surface 214a₂ and an intermediate surface 214a₃ joining the inner side surface 214a₁ to the outer side surface 214a₂. The inner side surface 214a₁ may define a passage 218 extending through the second trim member 214. The passage 218 extending through the second trim member 214 may be defined by a diameter D₂₁₄.

A first plurality of circumferentially-arranged projections 220 extends axially away from the substrate-facing surface 212b of the first trim member 212. In some instances, the first plurality of circumferentially-arranged projections 220 includes a first projection 220a, a second projection 220b, a third projection 220c and a fourth projection 220d that are respectively offset by approximately 90°. Each of the first projection 220a, the second projection 220b, the third projection 220c and the fourth projection 220d includes a substantially arcuate shape having an axially-extending portion 222 (see, e.g., FIG. 13A₁) and a radially-extending portion 224 (see, e.g., FIG. 13A₁).

Referring to FIG. 13A₁, the axially-extending portion 222 includes a proximal end 222_{P}, a distal end surface 222_{D}, a radially-inwardly-facing surface 222_{RI} and a radially-outwardly-facing surface 222_{RO}. The proximal end 222_{P} of the axially-extending portion 222 extends axially away from the substrate-facing surface 212b of the first trim member 212. The radially-extending portion 224 includes a radially-outwardly-facing surface 224_{RO} and a shoulder surface 224_{S}. The radially-outwardly-facing surface 224_{RO} of the radially-extending portion 224 connects the shoulder surface 224_{S} to the distal end surface 222_{D} of the axially-extending portion 222.

The radially-outwardly-facing surface 224_{RO} of the radially-extending portion 224 extends away from the distal end surface 222_{D} of the axially-extending portion 222 at an angle θ (see, e.g., FIG. 13A₁). The shoulder surface 224_{S} is arranged in an opposing relationship with respect to the substrate-facing surface 212b of the first trim member 212 and is spaced from the substrate-facing surface 212b of the first trim member 212 at a length dimension L₂₂₄ (see, e.g., FIG. 13A₁) Each of the first projection 220a, the second projection 220b, the third projection 220c and the fourth projection 220d is defined by a length dimension L₂₂₀ (see, e.g., FIG. 13A₁) extending between the substrate-facing surface 212b of the first trim member 212 and the distal end surface 222_{D} of the axially-extending portion 222.

Referring again to FIG. 11A, a plurality of circumferentially-arranged passages 226 extends axially into the substrate-facing surface 212b of the first trim member 212. In some instances, the plurality of circumferentially-arranged passages 226 includes a first passage 226a, a second passage 226b, a third passage 226c, a fourth passage 226d, a fifth passage 226e, a sixth passage 226f, a seventh passage 226g and an eighth passage 226h that are grouped into a plurality of pairs of passages 228 that are respectively offset by approximately 90°. The first passage 226a and the second passage 226b are arranged as a first pair of passages 228a of the plurality of pairs of passages 228. The third passage 226c and the fourth passage 226d are arranged as a second pair of passages 228b of the plurality of pairs of passages 228. The fifth passage 226e and the sixth passage 226f are arranged as a third pair of passages 228c of the plurality of pairs of passages 228. The seventh passage 226g and the eighth passage 226h are arranged as a fourth pair of passages 228d of the plurality of pairs of passages 228.

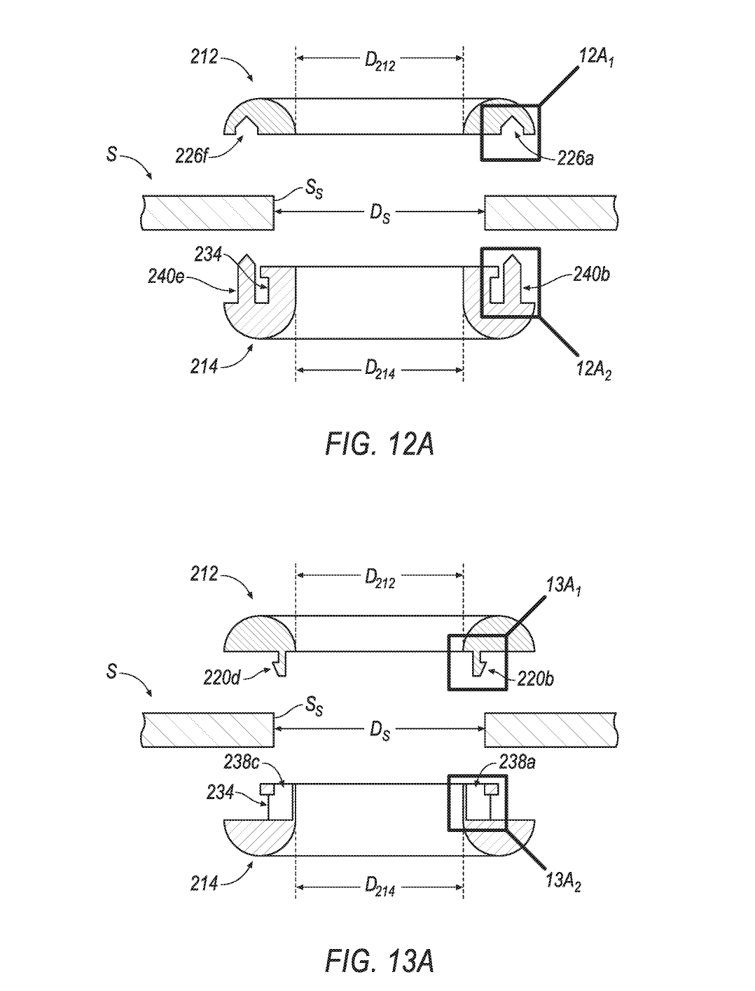

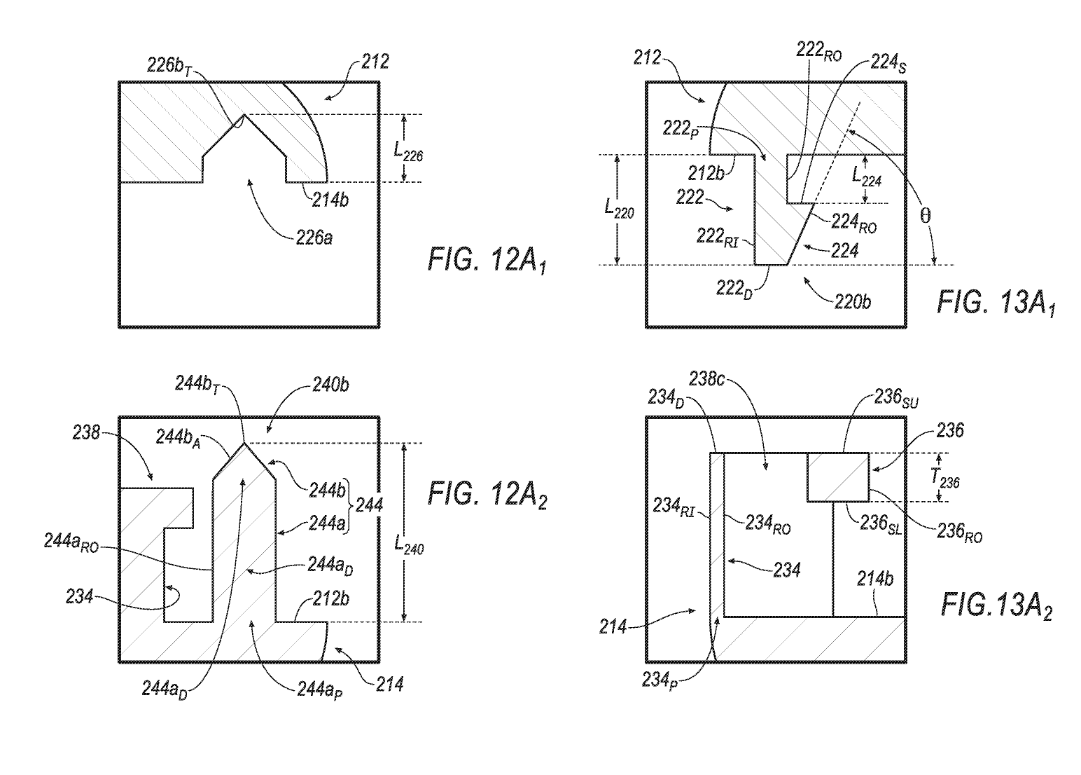

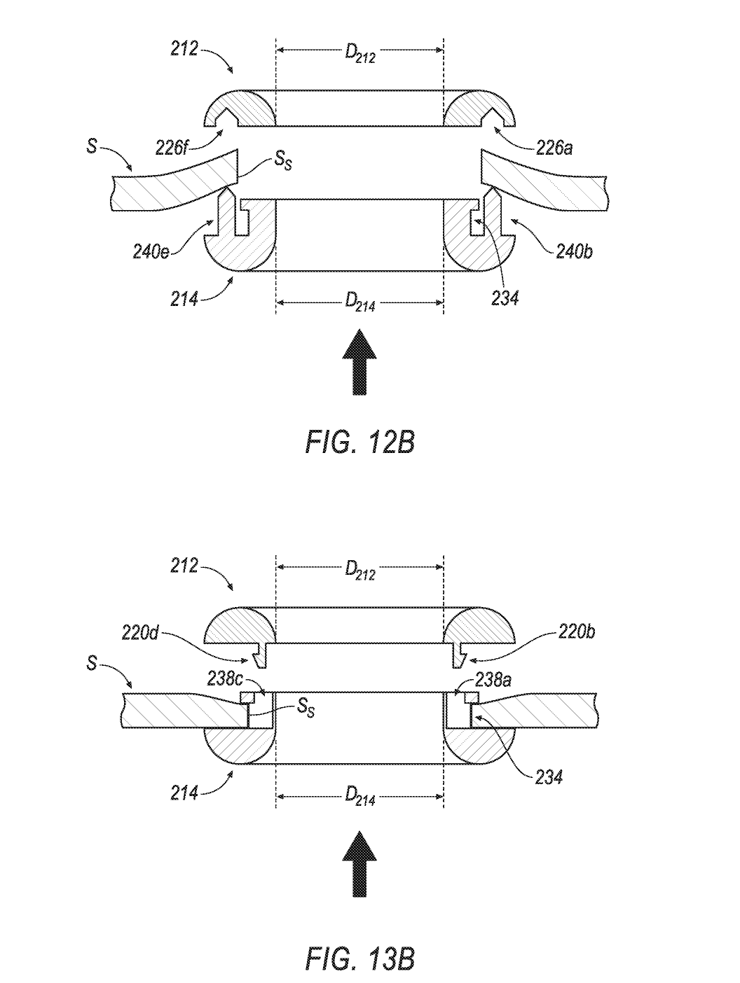

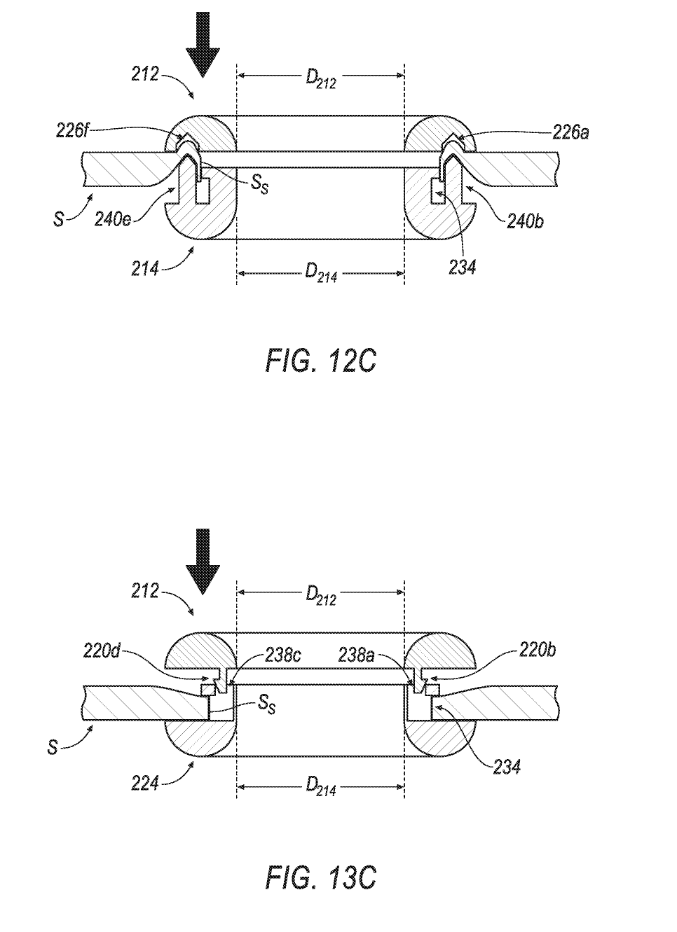

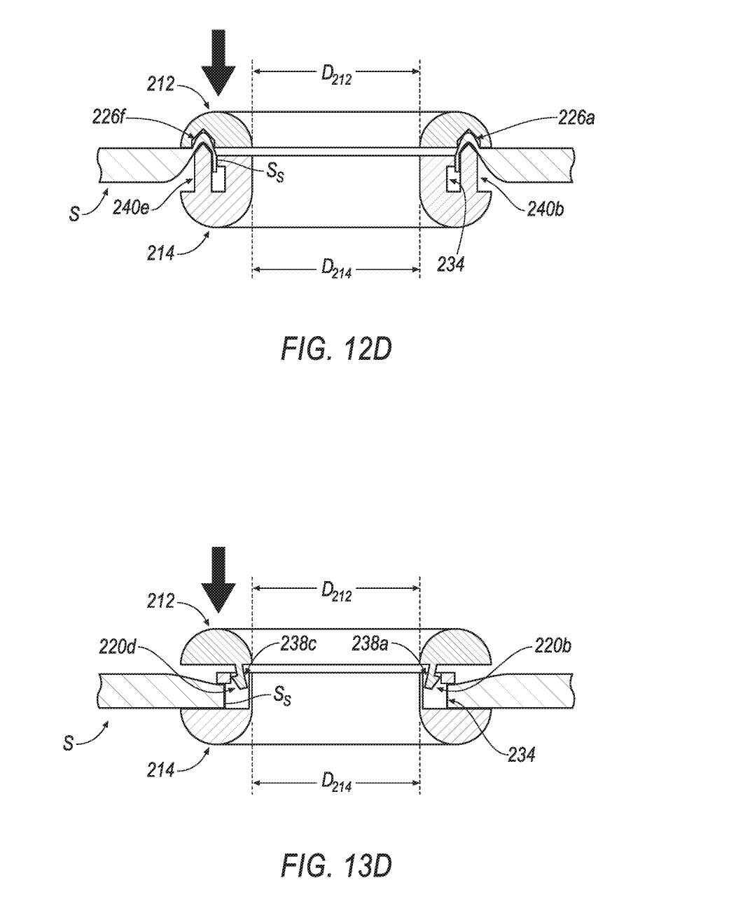

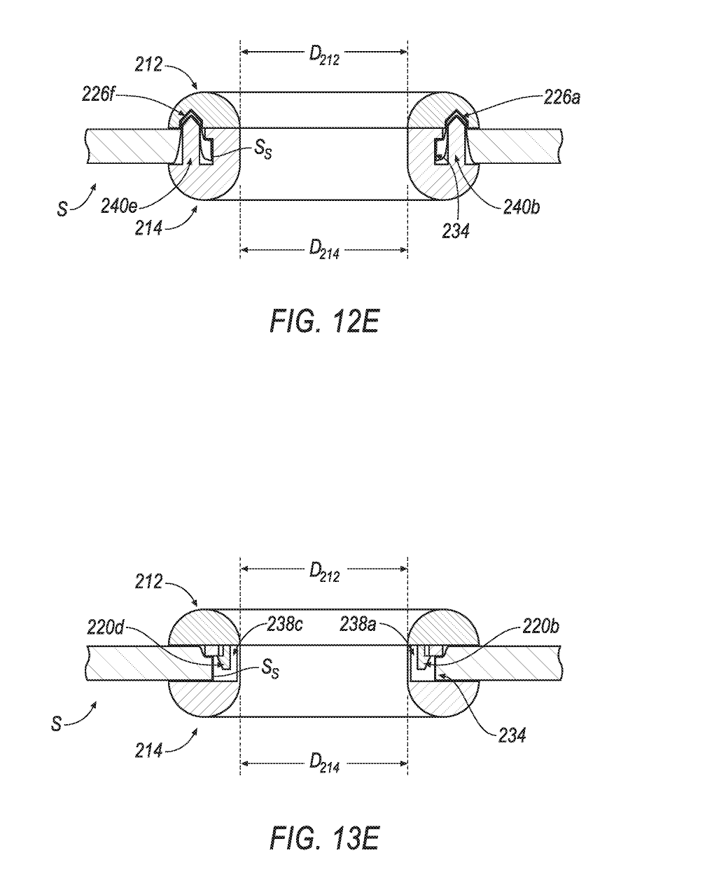

Referring to FIG. 12A₁, each of the first passage 226a, the second passage 226b, the third passage 226c, the fourth passage 226d, the fifth passage 226e, the sixth passage 226f, the seventh passage 226g and the eighth passage 226h defines a spatial void that geometrically corresponds to a dimension defined by a distal conical portion (see, e.g., 244b) and at least a portion of a length of a cylindrical portion (see, e.g., 244a) of an axially-extending body (see, e.g., 244) of each of a first projection (see, e.g., 240a), a second projection (see, e.g., 240b), a third projection (see, e.g., 240c), a fourth projection (see, e.g., 240d), a fifth projection (see, e.g., 240e), a sixth projection (see, e.g., 240f), a seventh projection (see, e.g., 240g) and an eighth projection (see, e.g., 240h) of a plurality of pairs of projections (see, e.g., 242). Each of the first passage 226a, the second passage 226b, the third passage 226c, the fourth passage 226d, the fifth passage 226e, the sixth passage 226f, the seventh passage 226g and the eighth passage 226h defines a length dimension L₂₂₆ (see, e.g., FIG. 12A₁) extending between the substrate-facing surface 212b of the first trim member 212 and a distal tip-receiving surface 226b_{T} that geometrically corresponds to a tip (see, e.g., 244b_{T}) of the distal conical portion 244b of each of the first projection 240a, the second projection 240b, the third projection 240c, the fourth projection 240d, the fifth projection 240e, the sixth projection 240f, the seventh projection 240g and the eighth projection 240h of the plurality of pairs of projections 242.

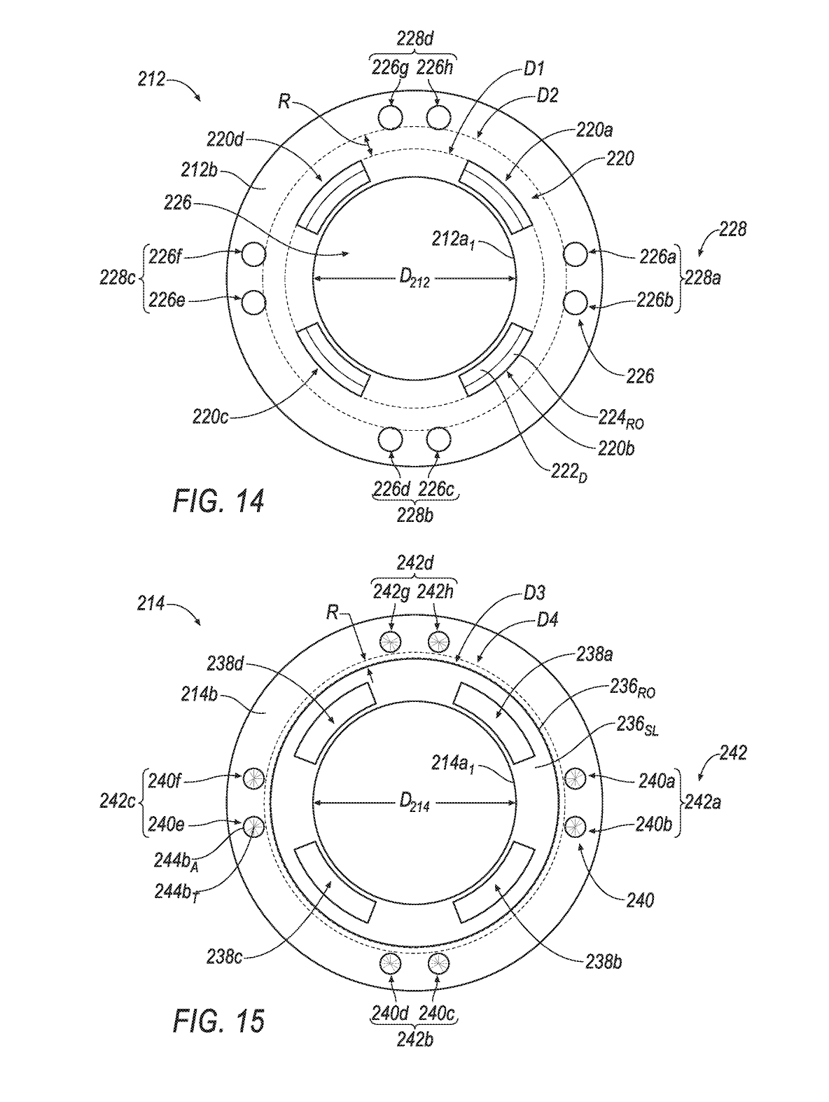

Referring to FIG. 14, a first circular perimeter is shown generally at a first dashed circular line D1, and a second circular perimeter is shown generally at a second dashed circular line D2, which is concentrically arranged with respect to the first dashed circular line D1. A radial double-arrow line R is shown radially extending between the first dashed circular line D1 and the second dashed circular line D2. The first dashed circular line D1 is shown extending across a radially-outwardly-most portion of the first plurality of circumferentially-arranged projections 220. The second dashed circular line D2 is shown tangentially extending across a radially-inwardly-most portion of the second plurality of circumferentially-arranged passages 226. The radial double-arrow line R demonstrates that the second plurality of circumferentially-arranged passages 226 is arranged radially outwardly with respect to the first plurality of circumferentially-arranged projections 220.

Referring to FIG. 12A, a circumferential projection 232 extends axially away from the substrate-facing surface 214b of the second trim member 214. In some instances, the circumferential projection 232 includes an axially-extending portion 234 and a radially-extending portion 236.

As seen in FIG. 13A₂, the axially-extending portion 234 includes a proximal end 234_{P}, a distal end surface 234_{D}, a radially-inwardly-facing surface 234_{RI} and a radially-outwardly-facing surface 234_{RO}. The proximal end 234_{P} of the axially-extending portion 234 extends axially away from the substrate-facing surface 214b of the second trim member 214.

Referring to FIG. 13A₂, the radially-extending portion 236 includes a radially-outwardly-facing surface 236_{RO} and a lower shoulder surface 236_{SL} and an upper shoulder surface 236_{SU}. The radially-outwardly-facing surface 236_{RO} of the radially-extending portion 236 connects the lower shoulder surface 236_{SL} to the upper shoulder surface 236_{SU}. The radially-extending portion 236 is defined by a thickness T₂₃₆ extending between the lower shoulder surface 236_{SL} and the upper shoulder surface 236_{SU}.

Referring again to FIG. 11A, the radially-extending portion 236 defines a first plurality of circumferentially-arranged passages 238. The first plurality of circumferentially-arranged passages 238 extends axially through the thickness T₂₃₆ (see, e.g., FIG. 13A₂) of the radially-extending portion 236. In some instances, the first plurality of circumferentially-arranged passages 238 includes a first passage 238a, a second passage 238b, a third passage 238c and a fourth passage 238d that are respectively offset by approximately 90°. Each of the first passage 238a, the second passage 238b, the third passage 238c and the fourth passage 238d includes a substantially arcuate shape.

A second plurality of circumferentially-arranged projections 240 extends axially away from the substrate-facing surface 214b of the second trim member 214. In some instances, the second plurality of circumferentially-arranged projections 240 includes a first projection 240a, a second projection 240b, a third projection 240c, a fourth projection 240d, a fifth projection 240e, a sixth projection 240f, a seventh projection 240g and an eighth projection 240h that are grouped into a plurality of pairs of projections 242 that are respectively offset by approximately 90°. The first projection 240a and the second projection 240b are arranged as a first pair of projections 242a of the plurality of pairs of projections 242. The third projection 240c and the fourth projection 240d are arranged as a second pair of projections 242b of the plurality of pairs of projections 242. The fifth projection 240e and the sixth projection 240f are arranged as a third pair of projections 242c of the plurality of pairs of projections 242. The seventh projection 240g and the eighth projection 240h are arranged as a fourth pair of projections 242d of the plurality of pairs of projections 242.

Referring to FIG. 12A₂, each of the first projection 240a, the second projection 240b, the third projection 240c, the fourth projection 240d, the fifth projection 240e, the sixth projection 240f, the seventh projection 240g and the eighth projection 240h includes an axially-extending body 244 defined by a proximal cylindrical portion 244a and a distal conical portion 244b. The proximal cylindrical portion 244a includes a proximal end 244a_{P}, a distal end 244a_{D} and a radial outer surface 244a_{RO}. The distal conical portion 244b includes an axial surface 244b_{A} that extends from the radial outer surface 244a_{RO} of the cylindrical portion 244a and terminates at a tip 244b_{T}. Each of the first projection 240a, the second projection 240b, the third projection 240c, the fourth projection 240d, the fifth projection 240e, the sixth projection 240f, the seventh projection 240g and the eighth projection 240h is defined by a length dimension L₂₄₀ (see, e.g., FIG. 12A₂) extending between the substrate-facing surface 214b of the second trim member 214 and the tip 244b_{T} of the distal conical portion 244b.

Referring to FIG. 15, a third circular perimeter is shown generally at a third dashed circular line D3, and a fourth circular perimeter is shown generally at a fourth dashed circular line D4, which is concentrically arranged with respect to the third dashed circular line D3. A radial double-arrow line R is shown radially extending between the third dashed circular line D3 and the fourth dashed circular line D4. The third dashed circular line D3 is shown extending across the radially-outwardly-facing surface 236_{RO} of the radially-extending portion 236 of the circumferential projection 232. The fourth dashed circular line D4 is shown tangentially extending across a radially-inwardly-most portion of the second plurality of circumferentially-arranged projections 240. The radial double-arrow line R demonstrates that the second plurality of circumferentially-arranged projections 240 is arranged radially outwardly with respect to the radially-outwardly-facing surface 236_{RO} of the radially-extending portion 236 of the circumferential projection 232.

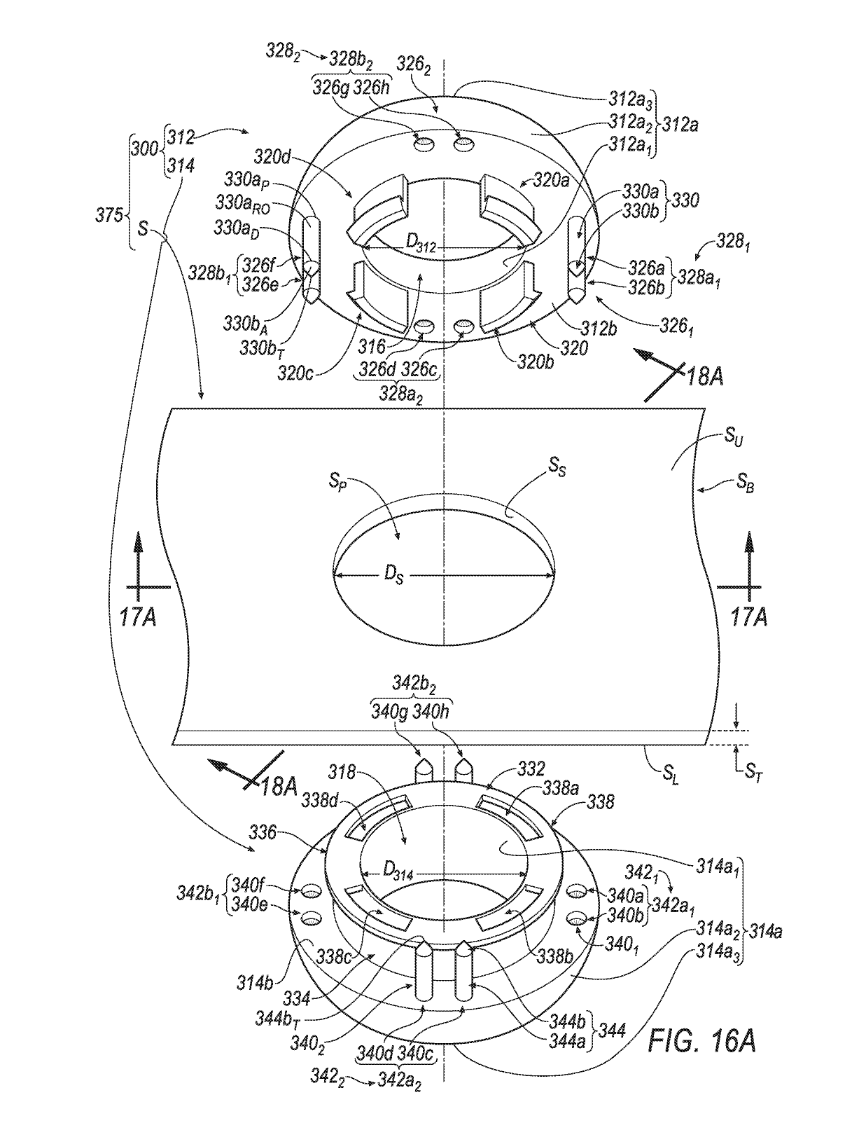

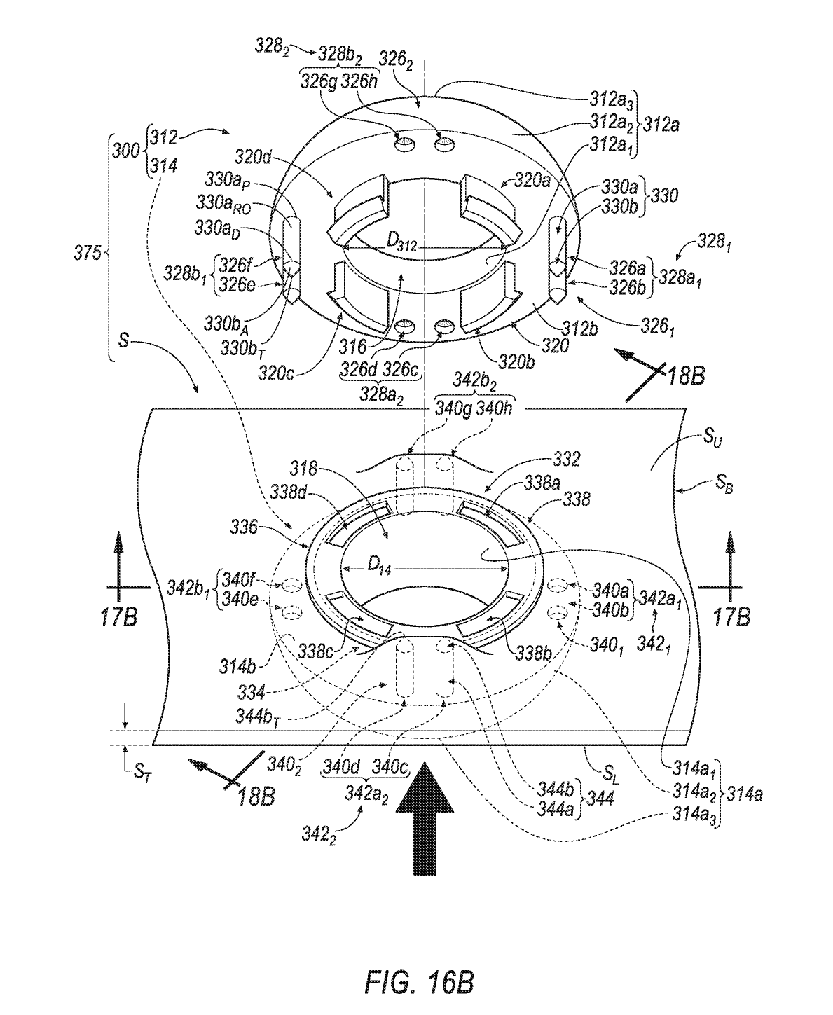

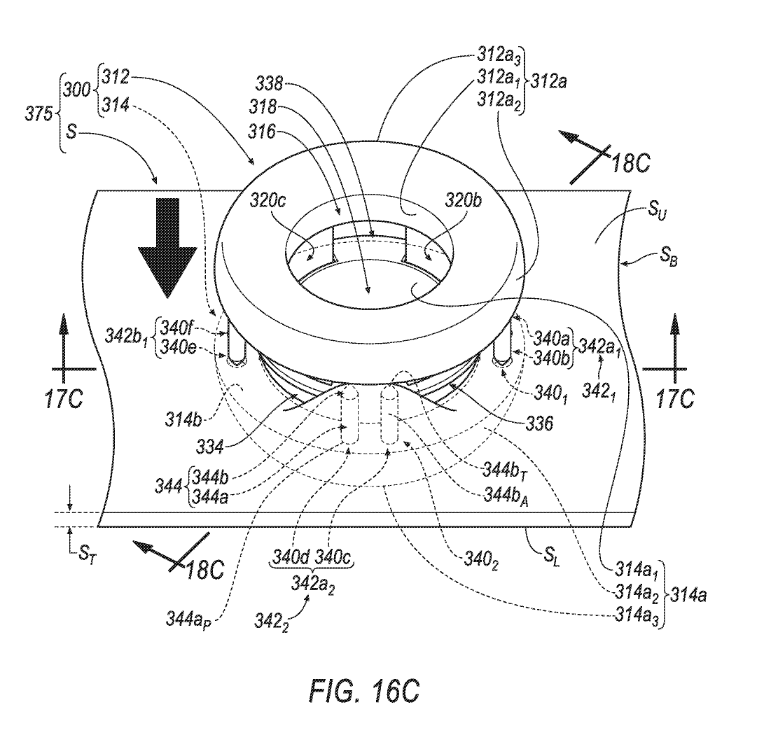

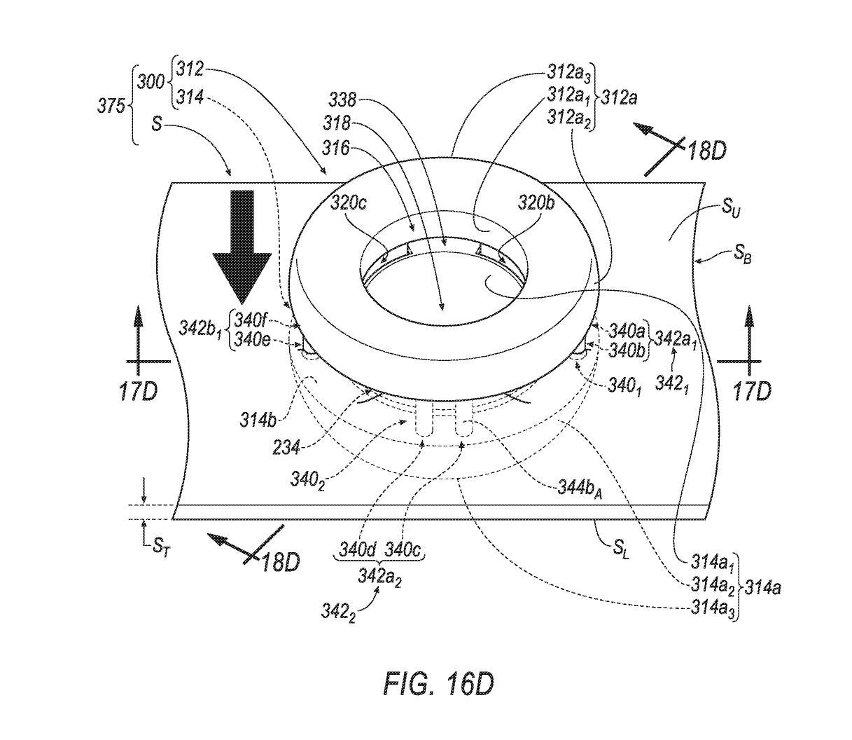

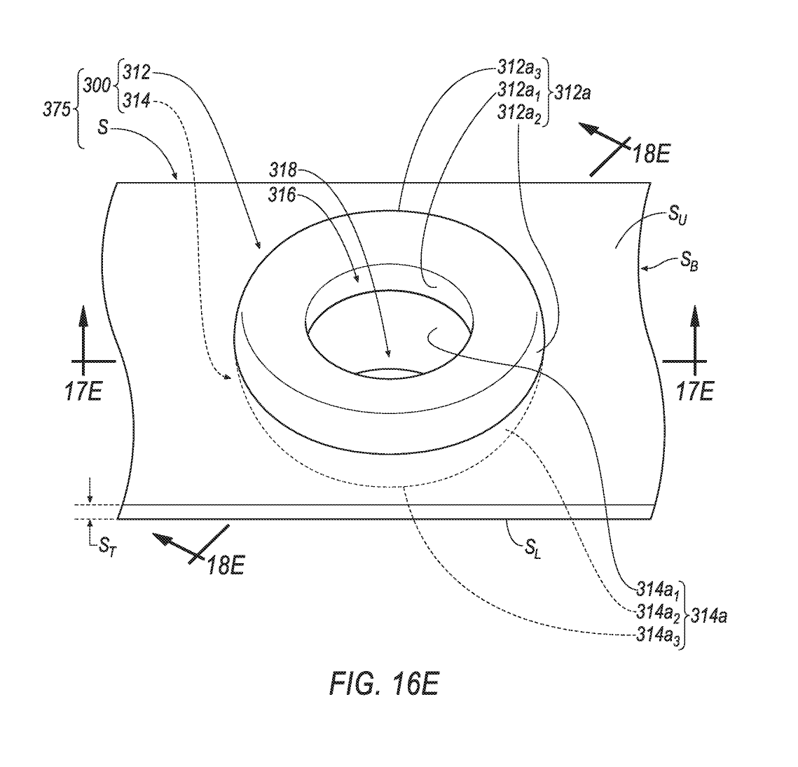

FIGS. 16A-20 illustrate an exemplary trim assembly 300 joined to a substrate S to form a trimmed assembly 375. As seen in FIG. 16A, the trim assembly 300 includes a first trim member 312 and a second trim member 314. The first trim member 312 includes an aesthetically-pleasing surface 312a and a substrate-facing surface 312b. The second trim member 314 includes an aesthetically-pleasing surface 314a and a substrate-facing surface 314b.

With continued reference to FIG. 16A, the substrate S is defined by a body S_{B} having an upper surface S_{U}, a lower surface S_{L} and a side surface S_{S} joining the upper surface S_{U} to the lower surface S_{L}. The body S_{B} is defined by a thickness S_{T} extending between the upper surface S_{U} to the lower surface S_{L}. The side surface S_{S} forms a passage S_{P} extending through the thickness S_{T} of the body S_{B}. The passage S_{P} extending through the thickness S_{T} of the body S_{B} may be defined by a diameter D_{S}.

The aesthetically-pleasing surface 312a of the first trim member 312 may include any desirable shape or surface profile. In some instances, the aesthetically-pleasing surface 312a includes an inner side surface 312a₁, an outer side surface 312a₂ and an intermediate surface 312a₃ joining the inner side surface 312a₁ to the outer side surface 312a₂. The inner side surface 312a₁ may define a passage 316 extending through the first trim member 312. The passage 316 extending through the first trim member 312 may be defined by a diameter D₃₁₂.

The aesthetically-pleasing surface 314a of the second trim member 314 may include any desirable shape or surface profile. In some instances, the aesthetically-pleasing surface 314a includes an inner side surface 314a₁, an outer side surface 314a₂ and an intermediate surface 314a₃ joining the inner side surface 314a₁ to the outer side surface 314a₂. The inner side surface 314a₁ may define a passage 318 extending through the second trim member 314. The passage 318 extending through the second trim member 314 may be defined by a diameter D₃₁₄.

A first plurality of circumferentially-arranged projections 320 extends axially away from the substrate-facing surface 312b of the first trim member 312. In some instances, the first plurality of circumferentially-arranged projections 320 includes a first projection 320a, a second projection 320b, a third projection 320c and a fourth projection 320d that are respectively offset by approximately 90°. Each of the first projection 320a, the second projection 320b, the third projection 320c and the fourth projection 320d includes a substantially arcuate shape having an axially-extending portion 322 (see, e.g., FIG. 18A₁) and a radially-extending portion 324 (see, e.g., FIG. 18A₁).

Referring to FIG. 18A₁, the axially-extending portion 322 includes a proximal end 322_{P}, a distal end surface 322_{D}, a radially-inwardly-facing surface 322_{RI} and a radially-outwardly-facing surface 322_{RO}. The proximal end 322_{P} of the axially-extending portion 322 extends axially away from the substrate-facing surface 312b of the first trim member 312. The radially-extending portion 324 includes a radially-outwardly-facing surface 324_{RO} and a shoulder surface 324_{S}. The radially-outwardly-facing surface 324_{RO} of the radially-extending portion 324 connects the shoulder surface 324_{S} to the distal end surface 322_{D} of the axially-extending portion 322. The radially-outwardly-facing surface 324_{RO} of the radially-extending portion 324 extends away from the distal end surface 322_{D} of the axially-extending portion 322 at an angle θ (see, e.g., FIG. 18A₁). The shoulder surface 324_{S} is arranged in an opposing relationship with respect to the substrate-facing surface 312b of the first trim member 312 and is spaced from the substrate-facing surface 312b of the first trim member 312 at a length dimension L₃₂₄ (see, e.g., FIG. 18A₁) Each of the first projection 320a, the second projection 320b, the third projection 320c and the fourth projection 320d is defined by a length dimension L₃₂₀ (see, e.g., FIG. 18A₁) extending between the substrate-facing surface 312b of the first trim member 312 and the distal end surface 322_{D} of the axially-extending portion 322.

With continued reference to FIG. 16A, a plurality of circumferentially-arranged projections 326₁ extends axially away from the substrate-facing surface 312b of the first trim member 312. The plurality of circumferentially-arranged projections 326₁ is circumferentially-aligned with a plurality of circumferentially-arranged passages 326₂. In some instances, the plurality of circumferentially-arranged projections 326₁ includes a first projection 326a, a second projection 326b, a third projection 326e and a fourth projection 326f that are grouped into a plurality of pairs of projections 328₁ that are respectively offset by approximately 180°. The first projection 326a and the second projection 326b are arranged as a first pair of projections 328aᵢ of the plurality of pairs of projections 328₁. The third projection 326e and the fourth projection 326f are arranged as a second pair of projections 328b₁ of the plurality of pairs of projections 328₁.

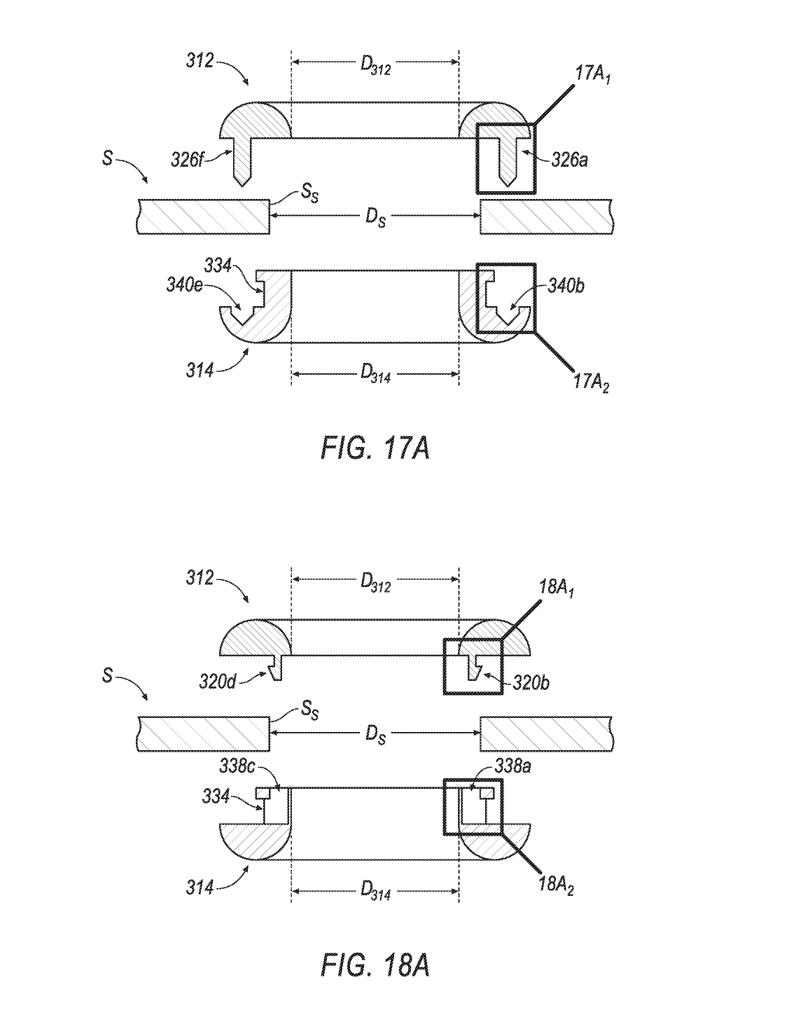

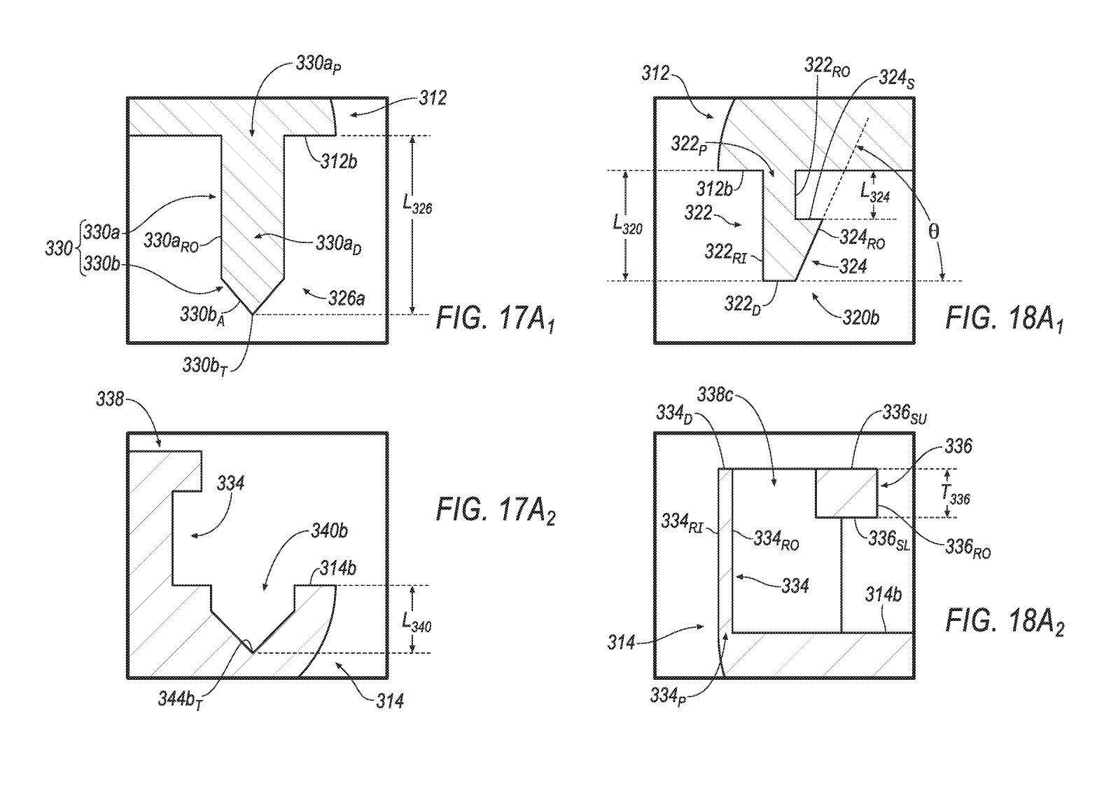

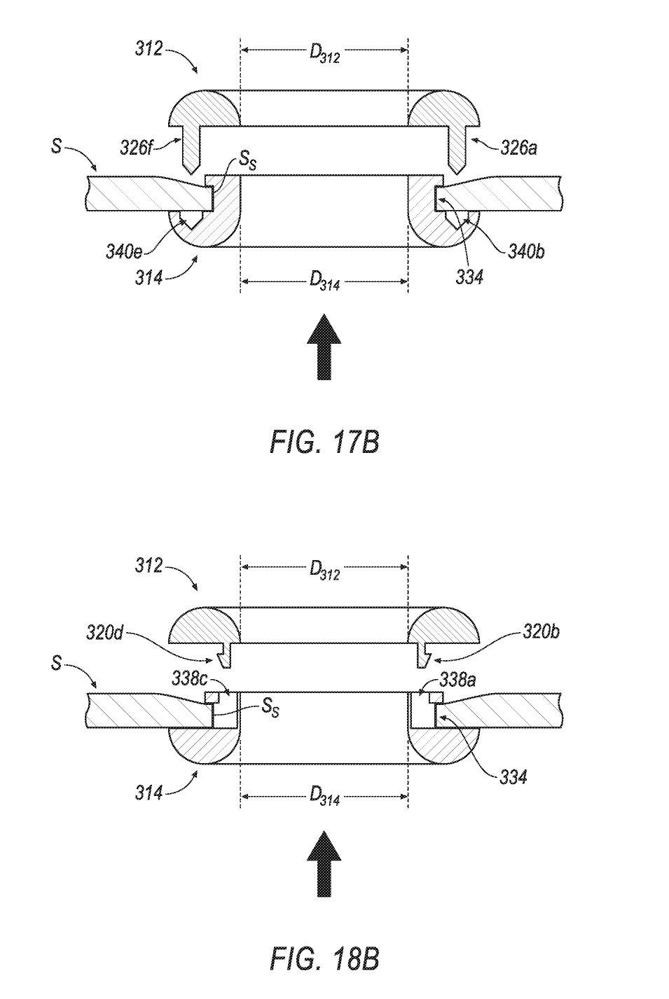

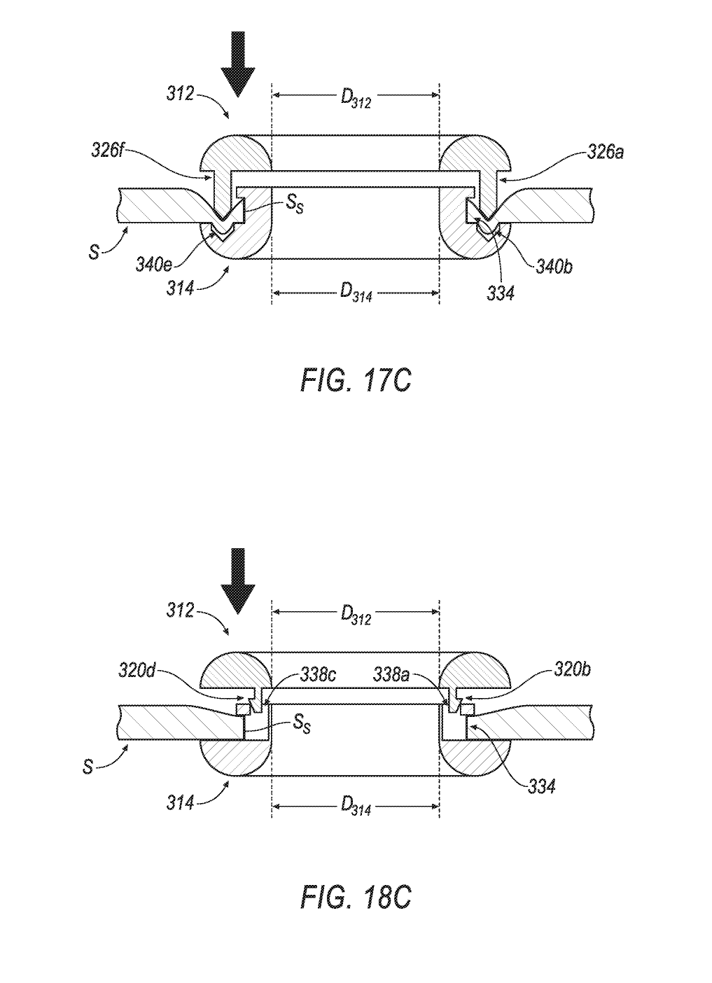

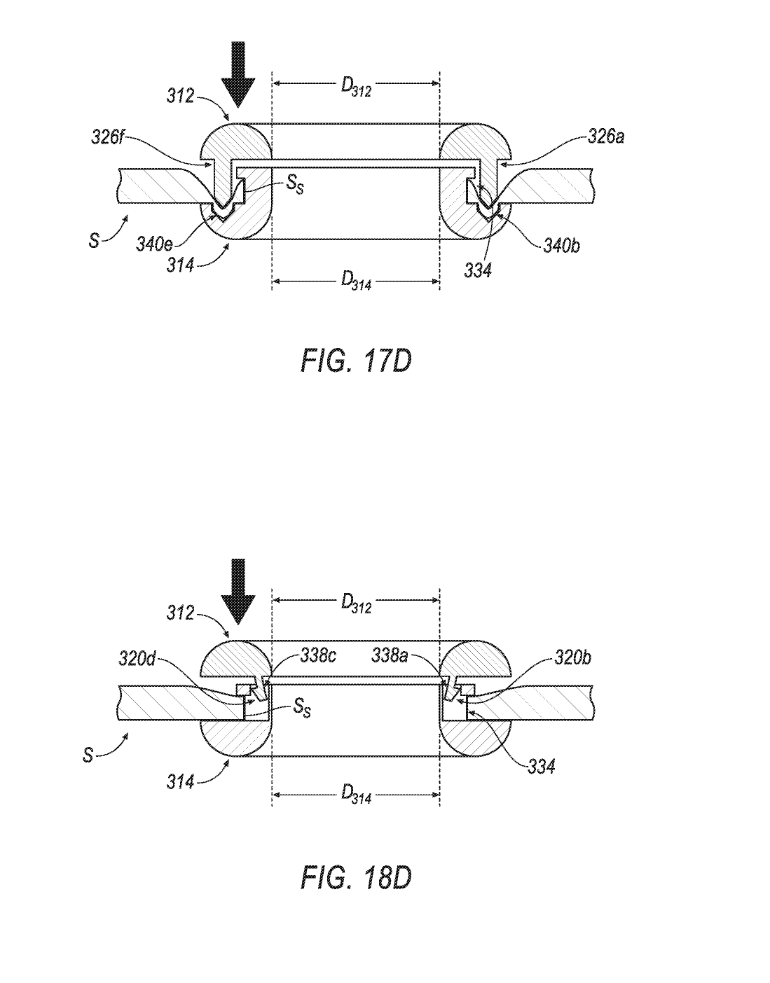

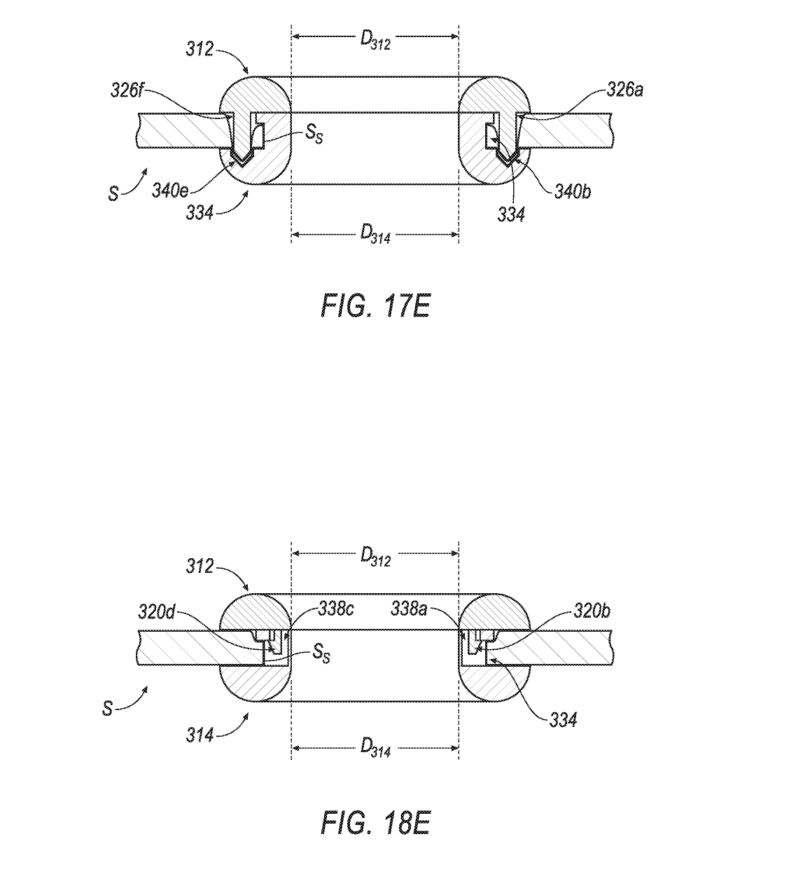

Referring to FIG. 17A₁, each of the first projection 326a, the second projection 326b, the third projection 326e and the fourth projection 326f includes an axially-extending body 330 defined by a proximal cylindrical portion 330a and a distal conical portion 330b. The proximal cylindrical portion 330a includes a proximal end 330a_{P}, a distal end 330a_{D} and a radial outer surface 330a_{RO}. The distal conical portion 330b includes an axial surface 330b_{A} that extends from the radial outer surface 330a_{RO} of the cylindrical portion 330a and terminates at a tip 330b_{T}. Each of the first projection 326a, the second projection 326b, the third projection 326e and the fourth projection 326f is defined by a length dimension L₃₂₆ (see, e.g., FIG. 17A₁) extending between the substrate-facing surface 312b of the first trim member 312 and the tip 330b_{T} of the distal conical portion 330b.

Referring to FIG. 16A, a plurality of circumferentially-arranged passages 326₂ extends axially into the substrate-facing surface 312b of the first trim member 312. In some instances, the plurality of circumferentially-arranged passages 326₂ includes a first passage 326c, a second passage 326d, a third passage 326g and a fourth passage 326h that are grouped into a plurality of pairs of passages 328₂ that are respectively offset by approximately 180°. The first passage 326c and the second passage 326d are arranged as a first pair of passages 328a₂ of the plurality of pairs of passages 328₂. The third passage 326g and the fourth passage 326h are arranged as a second pair of passages 328b₂ of the plurality of pairs of passages 328₂. Each of the first passage 326c, the second passage 326d, the third passage 326g and the fourth passage 326h defines a spatial void that geometrically corresponds to a dimension defined by a distal conical portion (see, e.g., 344b) and at least a portion of a length of a cylindrical portion (see, e.g., 344b) of an axially-extending body (see, e.g., 344) of each of a first projection (see, e.g., 340c), a second projection (see, e.g., 340d), a third projection (see, e.g., 340g) and a fourth projection (see, e.g., 340h) of a plurality of pairs of projections (see, e.g., 342₂). Each of the first passage 326c, the second passage 326d, the third passage 326g and the fourth passage 326h defines a length dimension (not shown) extending between the substrate-facing surface 312b of the first trim member 312 and a distal tip-receiving surface (not shown) that geometrically corresponds to a tip (see, e.g., 344b_{T}) of the distal conical portion 344b of each of the first projection 340c, the second projection 340d, the third projection 340g and the fourth projection 340h of the plurality of pairs of projections 342₂.

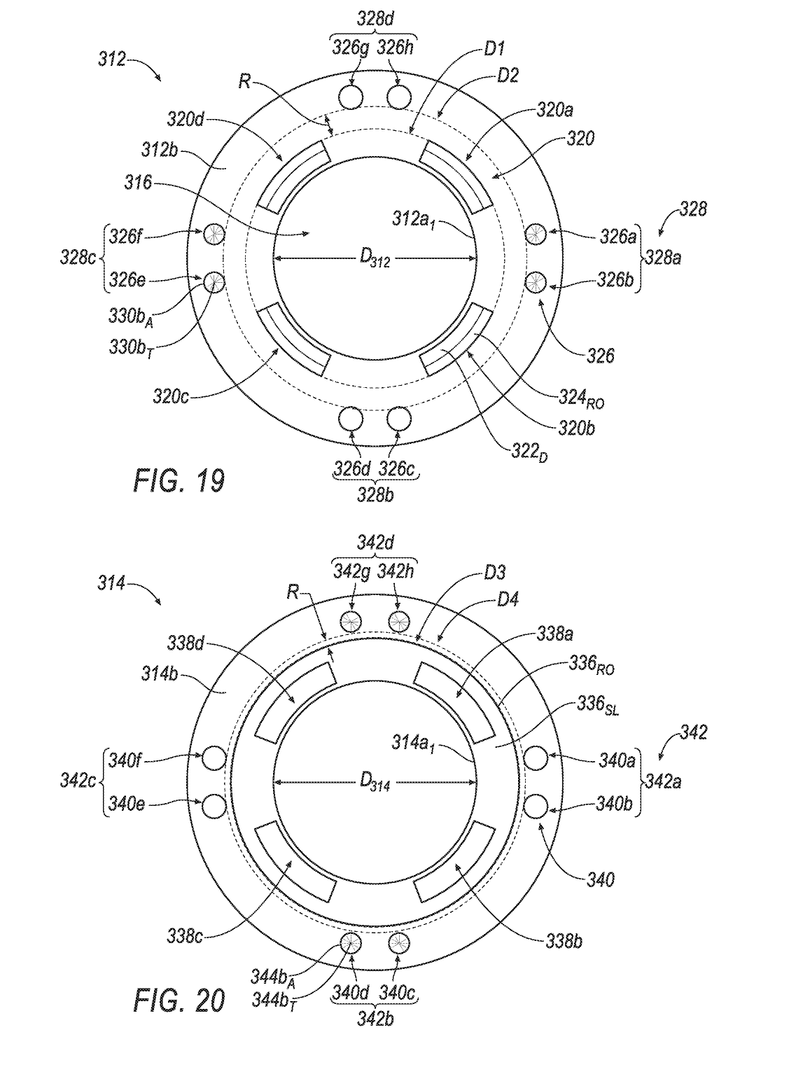

Referring to FIG. 19, a first circular perimeter is shown generally at a first dashed circular line D1, and a second circular perimeter is shown generally at a second dashed circular line D2, which is concentrically arranged with respect to the first dashed circular line D1. A radial double-arrow line R is shown radially extending between the first dashed circular line D1 and the second dashed circular line D2. The first dashed circular line D1 is shown extending across a radially-outwardly-most portion of the first plurality of circumferentially-arranged projections 320. The second dashed circular line D2 is shown tangentially extending across a radially-inwardly-most portion of each of the plurality of circumferentially-arranged passages 326₁ and the plurality of circumferentially-arranged projections 326₂. The radial double-arrow line R demonstrates that both of the plurality of circumferentially-arranged passages 326₁ and the plurality of circumferentially-arranged projections 326₂ are arranged radially outwardly with respect to first plurality of circumferentially-arranged projections 320.

Referring again to FIG. 16A, a circumferential projection 332 extends axially away from the substrate-facing surface 314b of the second trim member 314. In some instances, the circumferential projection 332 includes an axially-extending portion 334 and a radially-extending portion 336.

As seen in FIG. 18A₂, the axially-extending portion 334 includes a proximal end 334_{P}, a distal end surface 334_{D}, a radially-inwardly-facing surface 334_{RI} and a radially-outwardly-facing surface 334_{RO}. The proximal end 334_{P} of the axially-extending portion 334 extends axially away from the substrate-facing surface 314b of the second trim member 314. The radially-extending portion 336 includes a radially-outwardly-facing surface 336_{RO} and a lower shoulder surface 336_{SL} and an upper shoulder surface 336_{SU}. The radially-outwardly-facing surface 336_{RO} of the radially-extending portion 336 connects the lower shoulder surface 336_{SL} to the upper shoulder surface 336_{SU}. The radially-extending portion 336 is defined by a thickness T₃₃₆ extending between the lower shoulder surface 336_{SL} and the upper shoulder surface 336_{SU}.

Referring again to FIG. 16A, the radially-extending portion 336 defines a plurality of circumferentially-arranged passages 338. The plurality of circumferentially-arranged passages 338 extends axially through the thickness T₃₃₆ (see, e.g., FIG. 18A₂) of the radially-extending portion 336. In some instances, the first plurality of circumferentially-arranged passages 338 includes a first passage 338a, a second passage 338b, a third passage 338c and a fourth passage 338d that are respectively offset by approximately 90°. Each of the first passage 338a, the second passage 338b, the third passage 338c and the fourth passage 338d includes a substantially arcuate shape.

A plurality of circumferentially-arranged passages 340₁ extends axially into the substrate-facing surface 314b of the second trim member 314. In some instances, the plurality of circumferentially-arranged passages 340₁ includes a first passage 340a, a second passage 340b, a third passage 340e and a fourth passage 340f that are grouped into a plurality of pairs of passages 342₁ that are respectively offset by approximately 180° . The first passage 340a and the second passage 340b are arranged as a first pair of passages 342a₁ of the plurality of pairs of passages 342₁. The third passage 340e and the fourth passage 340f are arranged as a second pair of passages 342b₁ of the plurality of pairs of passages 342₁.

Referring to FIG. 17A₂, each of the first passage 340a, the second passage 340b, the third passage 340c and the fourth passage 340d defines a spatial void that geometrically corresponds to a dimension defined by a distal conical portion (see, e.g., 330b) and at least a portion of a length of a cylindrical portion (see, e.g., 330b) of an axially-extending body (see, e.g., 330) of each of the first projection (see, e.g., 326a), the second projection (see, e.g., 326b), the third projection (see, e.g., 326e) and the fourth projection (see, e.g., 326f) of the plurality of pairs of projections (see, e.g., 326₁). Each of the first passage 340a, the second passage 340b, the third passage 340e and the fourth passage 340f defines a length dimension L₃₄₀ (see, e.g., FIG. 17A₂) extending between the substrate-facing surface 314b of the second trim member 314 and a distal tip-receiving surface 344b_{T} that geometrically corresponds to a tip (see, e.g., 330b_{T}) of the distal conical portion 330b of each of the first projection 326a, the second projection 326b, the third projection 326e and the fourth projection 326f of the plurality of pairs of projections 326₁.

With continued reference to FIG. 16A, a plurality of circumferentially-arranged projections 340₂ extends axially away from the substrate-facing surface 314b of the second trim member 314. The plurality of circumferentially-arranged projections 340₂ is circumferentially-aligned with the plurality of circumferentially-arranged passages 340₁. In some instances, the plurality of circumferentially-arranged projections 340₂ includes a first projection 340c, a second projection 340d, a third projection 340g and a fourth projection 340h that are grouped into a plurality of pairs of projections 342₂ that are respectively offset by approximately 180° . The first projection 340c and the second projection 340d are arranged as a first pair of projections 342a₂ of the plurality of pairs of projections 342₂. The third projection 340g and the fourth projection 340h are arranged as a second pair of projections 342b₂ of the plurality of pairs of projections 342₂.

Each of the first projection 340c, the second projection 340d, the third projection 340g and the fourth projection 340h includes an axially-extending body 344 defined by a proximal cylindrical portion 344a and a distal conical portion 344b. The proximal cylindrical portion 344a includes a proximal end 344a_{P}, a distal end 344a_{D} and a radial outer surface 344a_{RO}. The distal conical portion 344b includes an axial surface 344b_{A} that extends from the radial outer surface 344a_{RO} of the cylindrical portion 344a and terminates at a tip 344b_{T}. Each of the first projection 340c, the second projection 340d, the third projection 340g and the fourth projection 340h is defined by a length dimension extending between the substrate-facing surface 314b of the second trim member 314 and the tip 344b_{T} of the distal conical portion 344b.

Referring to FIG. 20, a third circular perimeter is shown generally at a third dashed circular line D3, and a fourth circular perimeter is shown generally at a fourth dashed circular line D4, which is concentrically arranged with respect to the third dashed circular line D3. A radial double-arrow line R is shown radially extending between the third dashed circular line D3 and the fourth dashed circular line D4. The third dashed circular line D3 is shown extending across the radially-outwardly-facing surface 336_{RO} of the radially-extending portion 336 of the circumferential projection 332. The fourth dashed circular line D4 is shown tangentially extending across both of a radially-inwardly-most portion of the plurality of circumferentially-arranged passages 340₁ and the plurality of circumferentially-arranged projections 340₂. The radial double-arrow line R demonstrates that both of the plurality of circumferentially-arranged passages 340₁ and the plurality of circumferentially-arranged projections 340₂ is arranged radially outwardly with respect to the radially-outwardly-facing surface 336_{RO} of the radially-extending portion 336 of the circumferential projection 332.

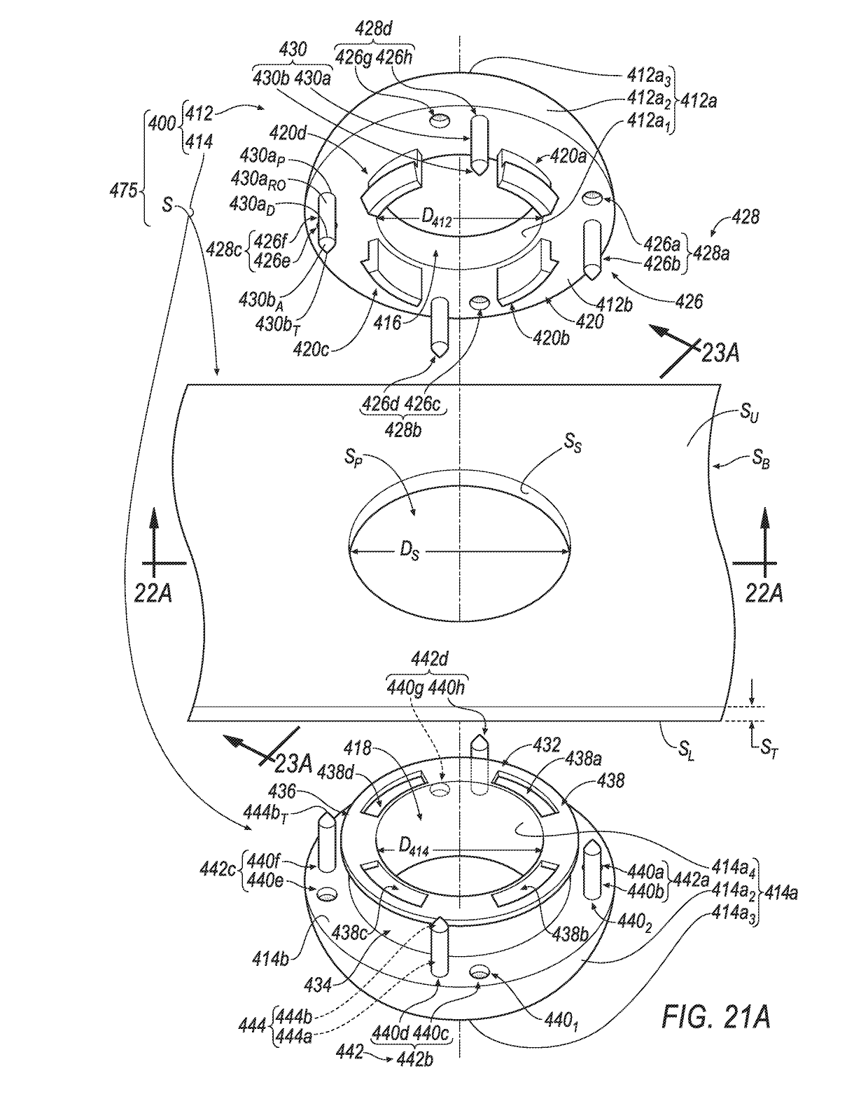

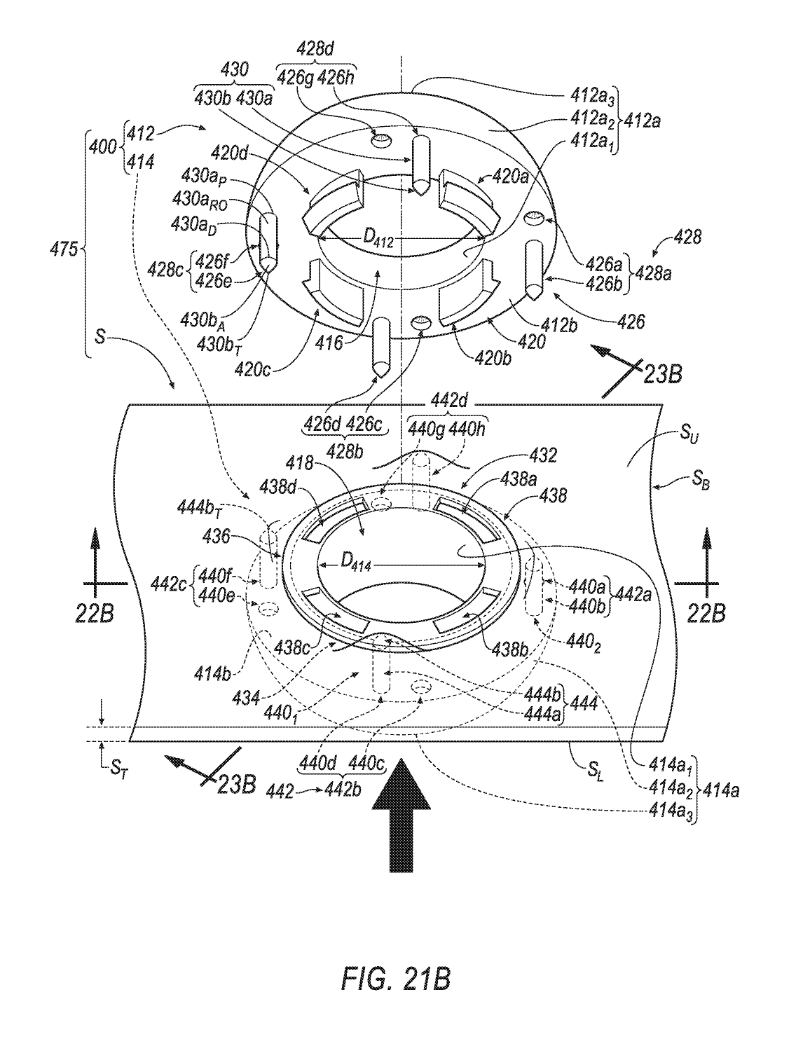

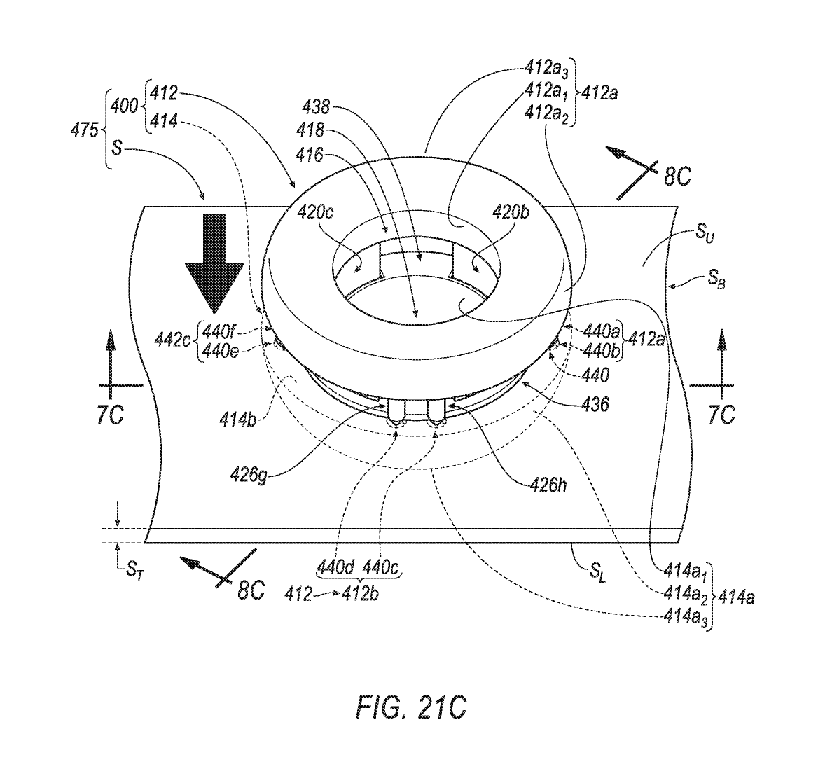

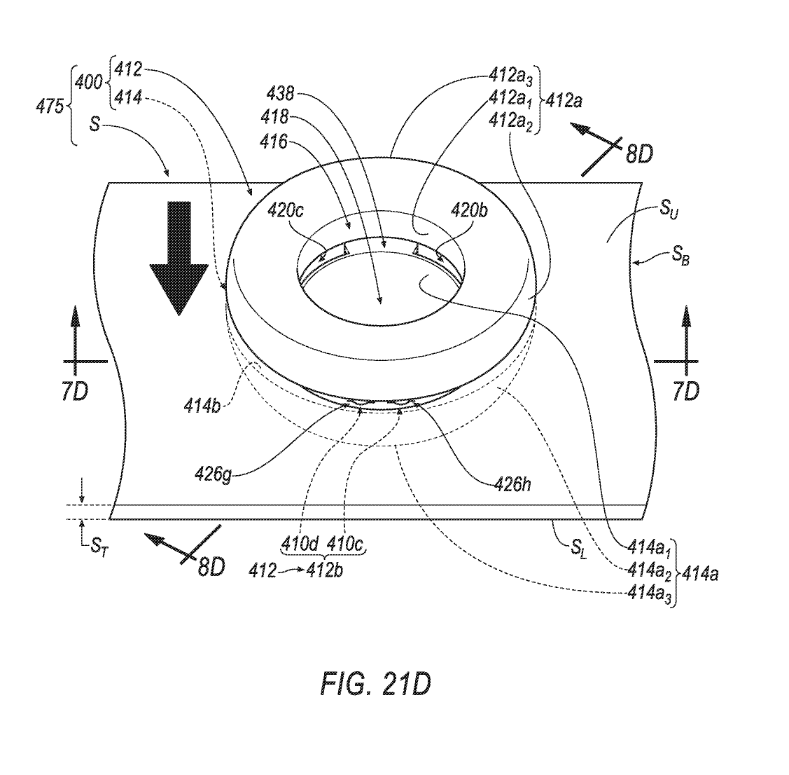

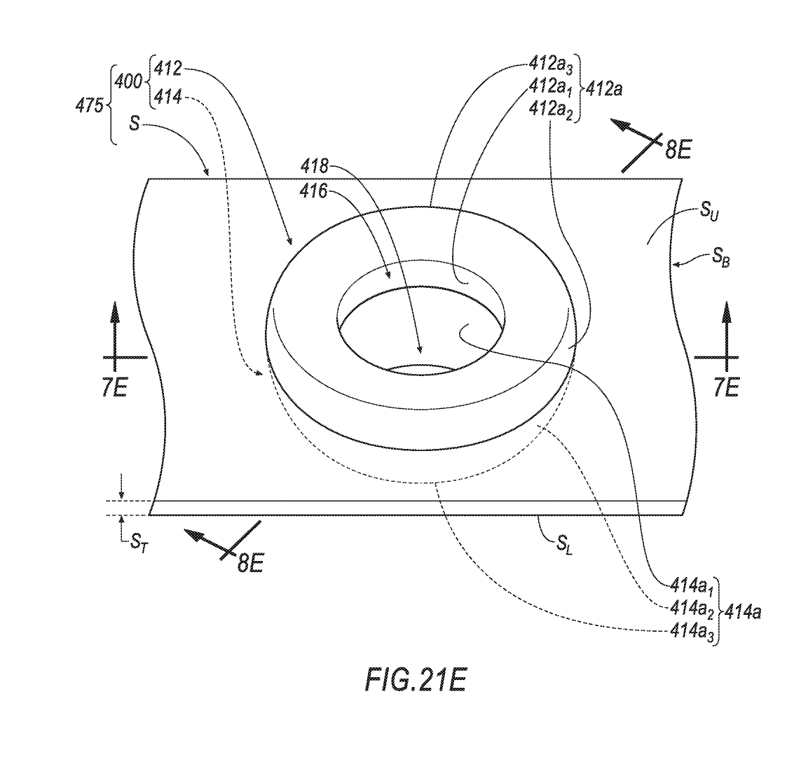

FIGS. 21A-25 illustrate an exemplary trim assembly 400 joined to a substrate S for forming a trimmed assembly 475. As seen in FIG. 21A, the trim assembly 400 includes a first trim member 412 and a second trim member 414. The first trim member 412 includes an aesthetically-pleasing surface 412a and a substrate-facing surface 412b. The second trim member 414 includes an aesthetically-pleasing surface 414a and a substrate-facing surface 414b.

With continued reference to FIG. 21A, the substrate S is defined by a body S_{B} having an upper surface S_{U}, a lower surface S_{L} and a side surface S_{S} joining the upper surface S_{U} to the lower surface S_{L}. The body S_{B} is defined by a thickness S_{T} extending between the upper surface S_{U} to the lower surface S_{L}. The side surface S_{S} forms a passage S_{P} extending through the thickness S_{T} of the body S_{B}. The passage S_{P} extending through the thickness S_{T} of the body S_{B} may be defined by a diameter D_{S}.

The aesthetically-pleasing surface 412a of the first trim member 412 may include any desirable shape or surface profile. In some instances, the aesthetically-pleasing surface 412a includes an inner side surface 412a₁, an outer side surface 412a₂ and an intermediate surface 412a₃ joining the inner side surface 412a₁ to the outer side surface 412a₂. The inner side surface 412a₁ may define a passage 416 extending through the first trim member 412. The passage 416 extending through the first trim member 412 may be defined by a diameter D₄₁₂.

The aesthetically-pleasing surface 414a of the second trim member 414 may include any desirable shape or surface profile. In some instances, the aesthetically-pleasing surface 414a includes an inner side surface 414a₁, an outer side surface 414a₂ and an intermediate surface 414a₃ joining the inner side surface 414a₁ to the outer side surface 414a₂. The inner side surface 414a₁ may define a passage 418 extending through the second trim member 414. The passage 418 extending through the second trim member 414 may be defined by a diameter D₄₁₄.

A first plurality of circumferentially-arranged projections 420 extends axially away from the substrate-facing surface 412b of the first trim member 412. In some instances, the first plurality of circumferentially-arranged projections 420 includes a first projection 420a, a second projection 420b, a third projection 420c and a fourth projection 420d that are respectively offset by approximately 90°. Each of the first projection 420a, the second projection 420b, the third projection 420c and the fourth projection 420d includes a substantially arcuate shape having an axially-extending portion 422 (see, e.g., FIG. 23A₁) and a radially-extending portion 424 (see, e.g., FIG. 23A₁).

Referring to FIG. 23A₁, the axially-extending portion 422 includes a proximal end 422_{P}, a distal end surface 422_{D}, a radially-inwardly-facing surface 422_{RI} and a radially-outwardly-facing surface 422_{RO}. The proximal end 422_{P} of the axially-extending portion 422 extends axially away from the substrate-facing surface 412b of the first trim member 412. The radially-extending portion 424 includes a radially-outwardly-facing surface 424_{RO} and a shoulder surface 424_{S}. The radially-outwardly-facing surface 424_{RO} of the radially-extending portion 424 connects the shoulder surface 424_{S} to the distal end surface 422_{D} of the axially-extending portion 422. The radially-outwardly-facing surface 424_{RO} of the radially-extending portion 424 extends away from the distal end surface 422_{D} of the axially-extending portion 422 at an angle 0 (see, e.g., FIG. 23A₁). The shoulder surface 424_{S} is arranged in an opposing relationship with respect to the substrate-facing surface 412b of the first trim member 412 and is spaced from the substrate-facing surface 412b of the first trim member 412 at a length dimension L₄₂₄ (see, e.g., FIG. 23A₁) Each of the first projection 420a, the second projection 420b, the third projection 420c and the fourth projection 420d is defined by a length dimension L₄₂₀ (see, e.g., FIG. 23A₁) extending between the substrate-facing surface 412b of the first trim member 412 and the distal end surface 422_{D} of the axially-extending portion 422.

Referring to FIG. 21A, a plurality of circumferentially-arranged passages 426₁ extends axially into the substrate-facing surface 412b of the first trim member 412. In some instances, the plurality of circumferentially-arranged passages 426₁ includes a first passage 426a, a second passage 426c, a third passage 426e and a fourth passage 426g. Furthermore, as seen in FIG. 21A, a plurality of circumferentially-arranged projections 426₂ extends axially away from the substrate-facing surface 412b of the first trim member 412. The plurality of circumferentially-arranged projections 426₂ is circumferentially-aligned with the plurality of circumferentially-arranged passages 426₁. In some instances, the plurality of circumferentially-arranged projections 426₂ includes a first projection 426b, a second projection 426d, a third projection 426f and a fourth projection 426h.

Unlike the previously-described embodiments, the plurality of circumferentially-arranged passages 426₁ and the plurality of circumferentially-arranged projections 426₂ are not exclusively-grouped in pairs; rather, one passage 426a, 426c, 426e, 426g and one projection 426b, 426d, 426f, 426h of each of the plurality of circumferentially-arranged passages 426₁ and the plurality of circumferentially-arranged projections 426₂ are paired to define a plurality of passage-and-projection pairs 428.

In some examples, the first passage 426a and the first projection 426b are arranged as a first passage-and-projection pair 428a of the plurality of passage-and-projection pairs 428. The second passage 426c and the second projection 426d are arranged as a second passage-and-projection pair 428b of the plurality of passage-and-projection pairs 428. The third passage 426e and the third projection 426f are arranged as a third passage-and-projection pair 428c of the plurality of passage-and-projection pairs 428. The fourth passage 426g and the fourth projection 426h are arranged as a fourth passage-and-projection pair 428d of the plurality of passage-and-projection pairs 428. Each passage-and-projection pair 428a, 428b, 428c, 428d is respectively offset by approximately 90°.

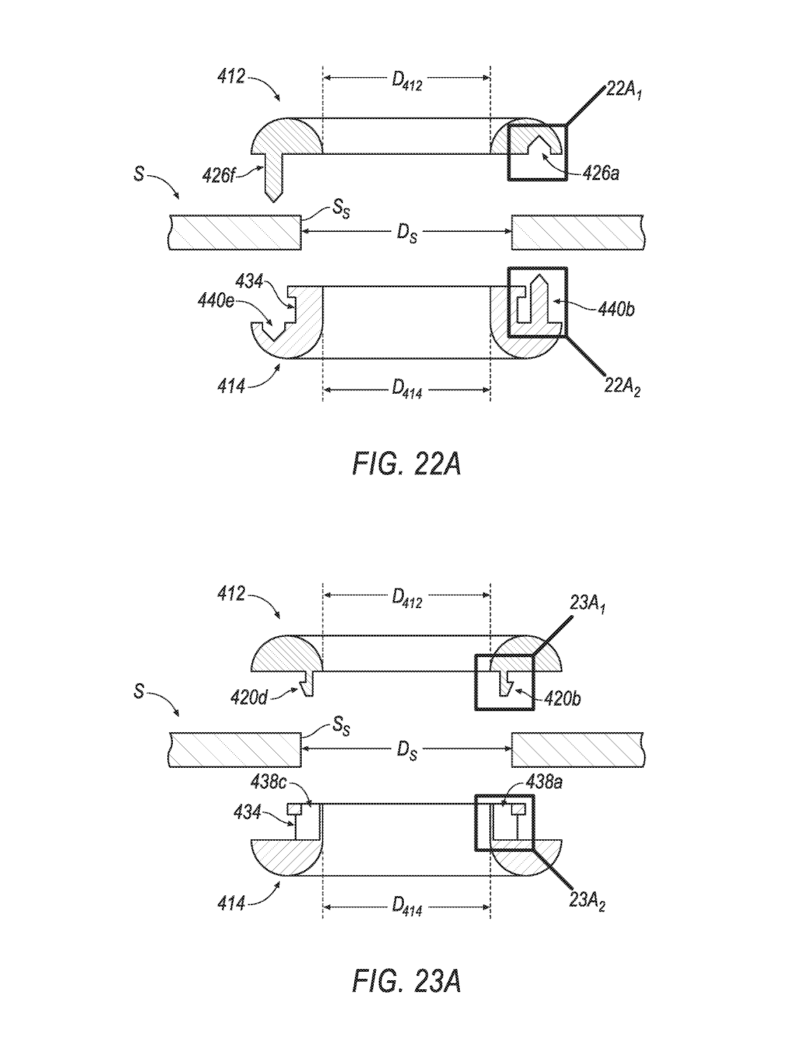

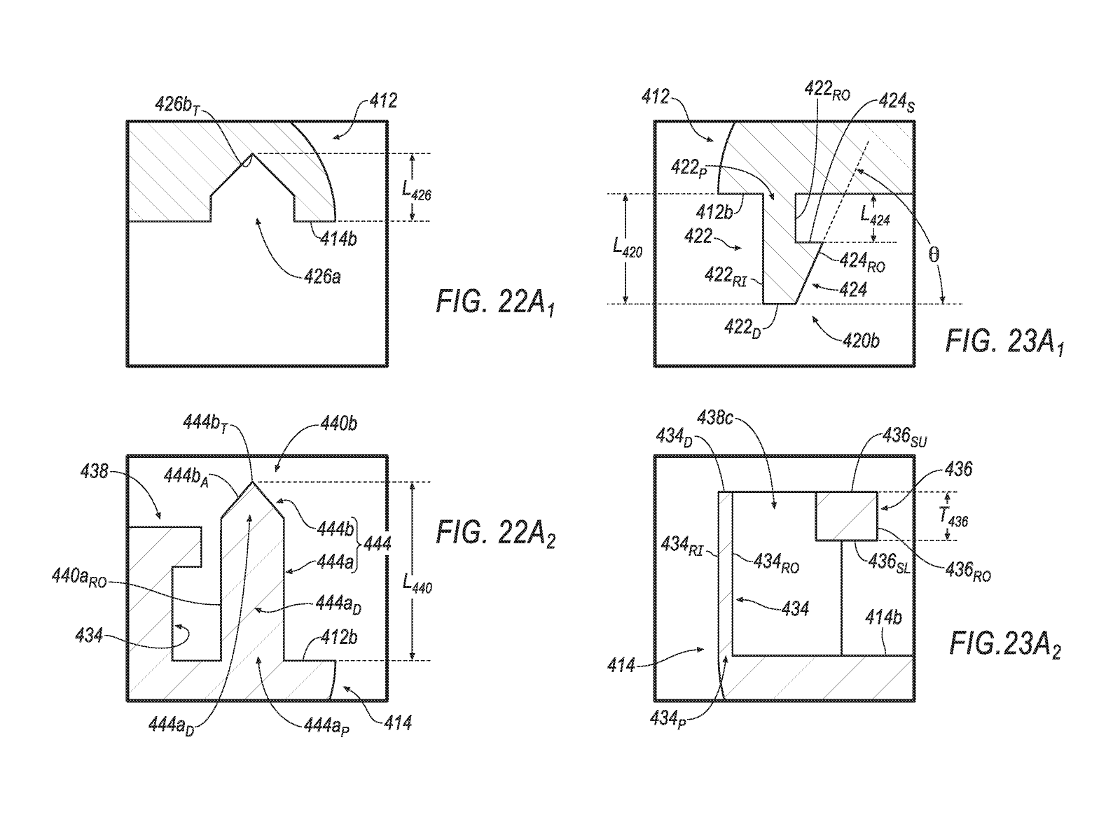

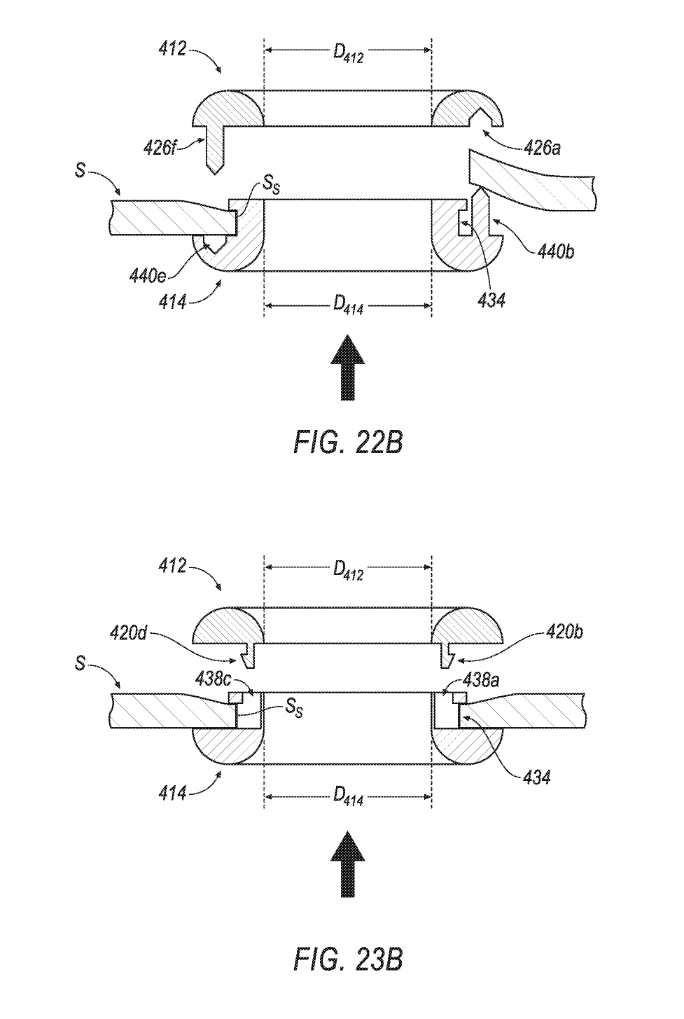

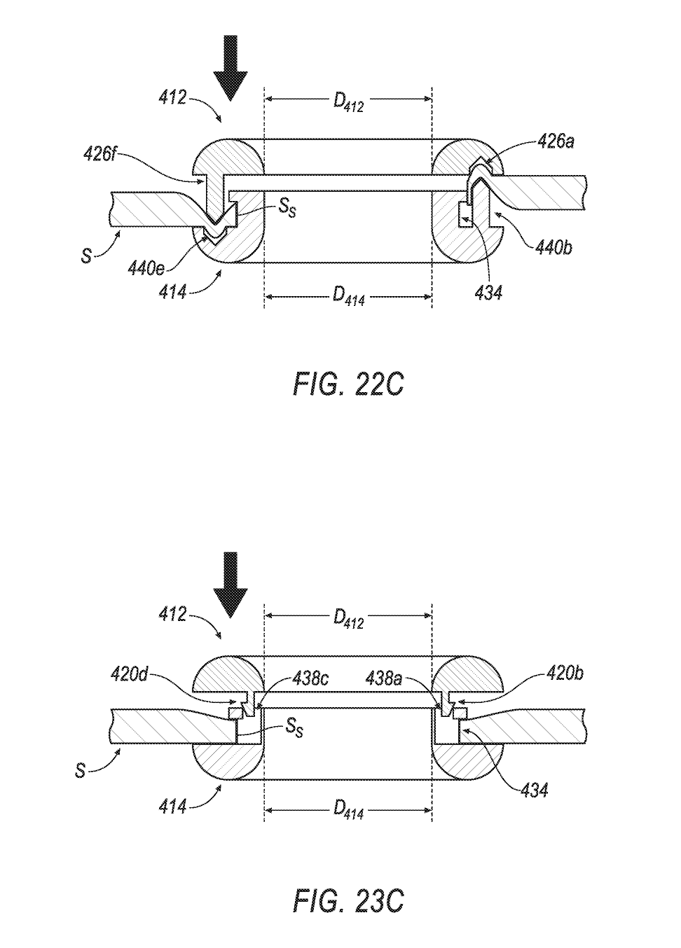

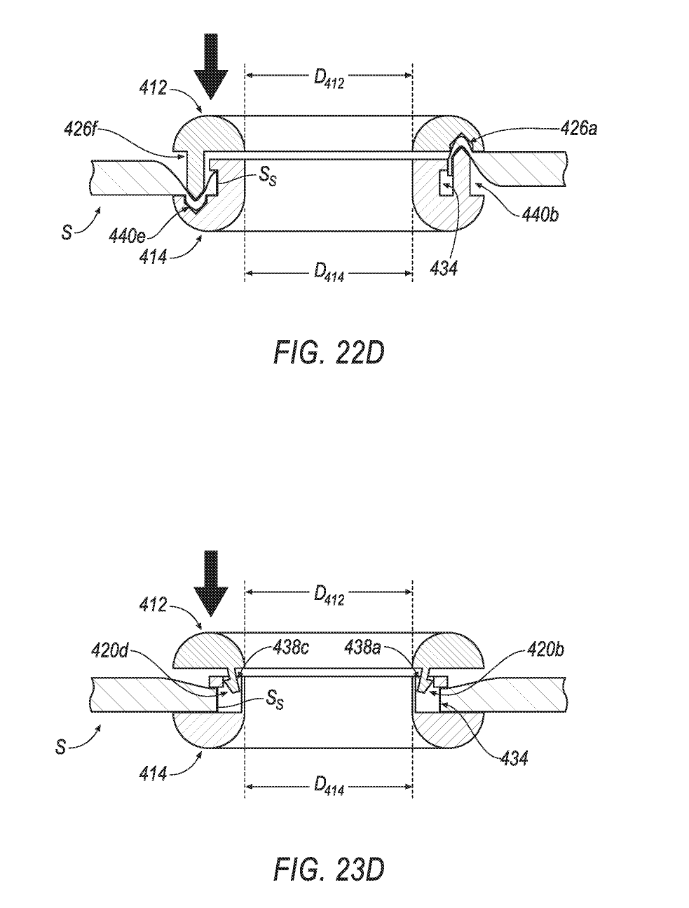

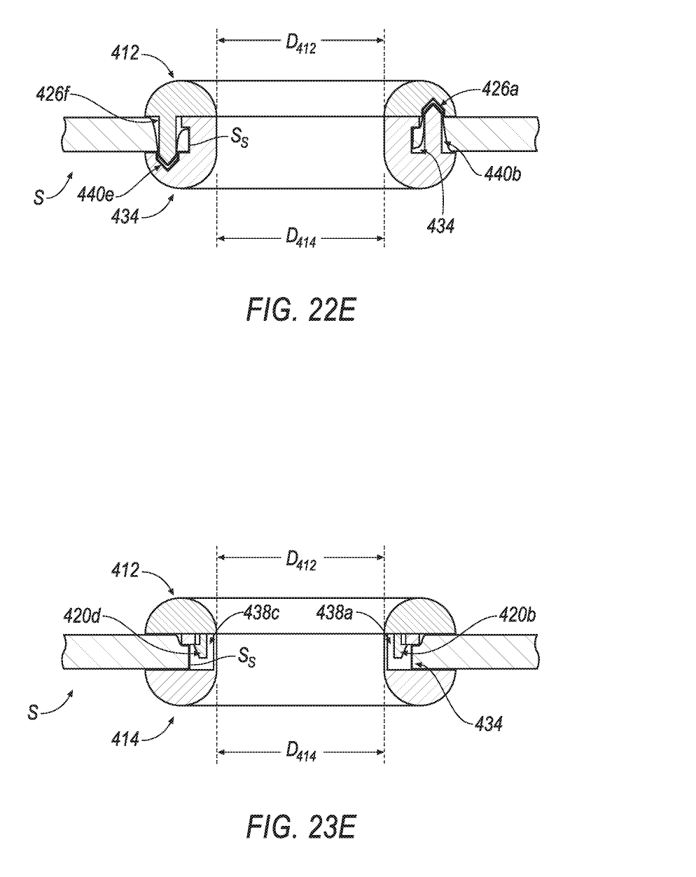

Each of the first passage 426a, the second passage 426c, the third passage 426e and the fourth passage 426g defines a spatial void that geometrically corresponds to a dimension defined by a distal conical portion (see, e.g., 444b) and at least a portion of a length of a cylindrical portion (see, e.g., 444b) of an axially-extending body (see, e.g., 444) of each of a first projection (see, e.g., 440b), a second projection (see, e.g., 440d), a third projection (see, e.g., 440f) and a fourth projection (see, e.g., 440h) of a plurality of projections (see, e.g., 442₂). Referring to FIG. 22A₁, each of the first passage 426a, the second passage 426c, the third passage 426e and the fourth passage 426g defines a length dimension L₄₂₆ extending between the substrate-facing surface 412b of the first trim member 412 and a distal tip-receiving surface 426b_{T} that geometrically corresponds to a tip (see, e.g., 444b_{T}) of the distal conical portion 444b of each of the first projection 440b, the second projection 440d, the third projection 440f and the fourth projection 440h of the plurality of pairs of projections 442₂.

Each of the first projection 426b, the second projection 426d, the third projection 426f and the fourth projection 426h includes an axially-extending body 430 defined by a proximal cylindrical portion 430a and a distal conical portion 430b. The proximal cylindrical portion 430a includes a proximal end 430a_{P}, a distal end 430a_{D}, and a radial outer surface 430a_{RO}. The distal conical portion 430b includes an axial surface 430b_{A} that extends from the radial outer surface 430a_{RO} of the cylindrical portion 430a and terminates at a tip 430b_{T}. Each of the first projection 426b, the second projection 426d, the third projection 426f, and the fourth projection 426h is defined by a length dimension (not shown) extending between the substrate-facing surface 412b of the first trim member 412 and the tip 430b_{T} of the distal conical portion 430b.

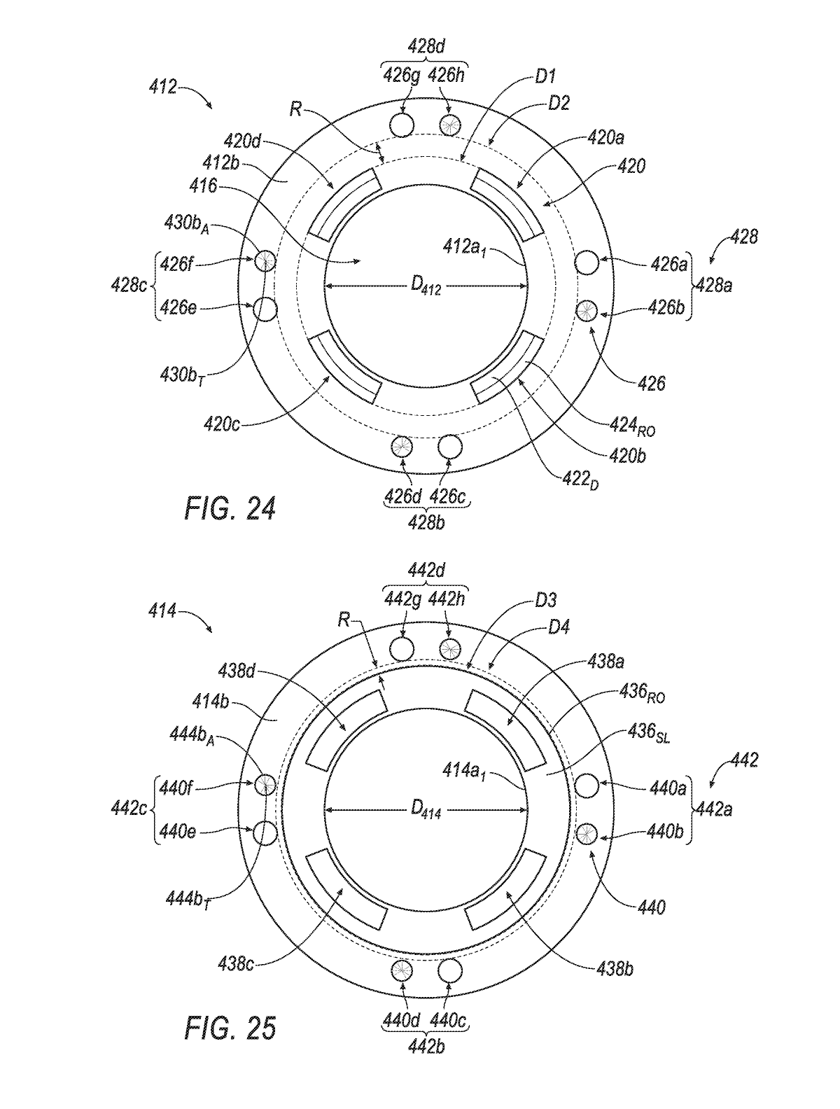

Referring to FIG. 24, a first circular perimeter is shown generally at a first dashed circular line D1, and a second circular perimeter is shown generally at a second dashed circular line D2, which is concentrically arranged with respect to the first dashed circular line D1. A radial double-arrow line R is shown radially extending between the first dashed circular line D1 and the second dashed circular line D2. The first dashed circular line D1 is shown extending across a radially-outwardly-most portion of the first plurality of circumferentially-arranged projections 420. The second dashed circular line D2 is shown tangentially extending across a radially-inwardly-most portion of each passage 426a, 426c, 426e, 426g and projection 426b, 426d, 426f, 426h of the plurality of circumferentially-arranged passages 426₁ and the plurality of circumferentially-arranged projections 426₂. The radial double-arrow line R demonstrates that each passage 426a, 426c, 426e, 426g and projection 426b, 426d, 426f, 426h of the plurality of circumferentially-arranged passages 426₁ and the plurality of circumferentially-arranged projections 426₂is arranged radially outwardly with respect to the first plurality of circumferentially-arranged projections 420.

Referring again to FIG. 21A, a circumferential projection 432 extends axially away from the substrate-facing surface 414b of the second trim member 414. In some instances, the circumferential projection 432 includes an axially-extending portion 434 and a radially-extending portion 436.

As seen in FIG. 23A₂, the axially-extending portion 434 includes a proximal end 434_{P}, a distal end surface 434_{D}, a radially-inwardly-facing surface 434_{RI} and a radially-outwardly-facing surface 434_{RO}. The proximal end 434_{P} of the axially-extending portion 434 extends axially away from the substrate-facing surface 414b of the second trim member 414. The radially-extending portion 436 includes a radially-outwardly-facing surface 436_{RO} and a lower shoulder surface 436_{SL} and an upper shoulder surface 436_{SU}. The radially-outwardly-facing surface 436_{RO} of the radially-extending portion 436 connects the lower shoulder surface 436_{SL} to the upper shoulder surface 436_{SU}. The radially-extending portion 436 is defined by a thickness T₄₃₆ extending between the lower shoulder surface 436_{SL} and the upper shoulder surface 436_{SU}.

Referring again to FIG. 21A, the radially-extending portion 436 defines a plurality of circumferentially-arranged passages 438. The plurality of circumferentially-arranged passages 438 extends axially through the thickness T₄₃₆ (see, e.g., FIG. 23A₂) of the radially-extending portion 436. In some instances, the first plurality of circumferentially-arranged passages 438 includes a first passage 438a, a second passage 438b, a third passage 438c and a fourth passage 438d that are respectively offset by approximately 90°. Each of the first passage 438a, the second passage 438b, the third passage 438c and the fourth passage 438d includes a substantially arcuate shape.

Referring to FIG. 21A, a plurality of circumferentially-arranged passages 440₁ extends axially into the substrate-facing surface 414b of the second trim member 414. In some instances, the plurality of circumferentially-arranged passages 440₁ includes a first passage 440a, a second passage 440c, a third passage 440e and a fourth passage 440g. Furthermore, as seen in FIG. 21A, a plurality of circumferentially-arranged projections 440₂ extends axially away from the substrate-facing surface 414b of the second trim member 414. The plurality of circumferentially-arranged projections 440₂ is circumferentially-aligned with the plurality of circumferentially-arranged passages 440₁. In some instances, the plurality of circumferentially-arranged projections 440₂ includes a first projection 440b, a second projection 440d, a third projection 440f, and a fourth projection 440h.

Unlike the previously-described embodiments, the plurality of circumferentially-arranged passages 440₁ and the plurality of circumferentially-arranged projections 440₂ are not exclusively-grouped in pairs; rather, one passage 440a, 440c, 440e, 440g and one projection 440b, 440d, 440f, 440h of each of the plurality of circumferentially-arranged passages 440₁ and the plurality of circumferentially-arranged projections 440₂ are paired to define a plurality of passage-and-projection pairs 442.

In some examples, the first passage 440a and the first projection 440b are arranged as a first passage-and-projection pair 442a of the plurality of passage-and-projection pairs 442. The second passage 440c and the second projection 440d are arranged as a second passage-and-projection pair 442b of the plurality of passage-and-projection pairs 442. The third passage 440e and the third projection 440f are arranged as a third passage-and-projection pair 442c of the plurality of passage-and-projection pairs 442. The fourth passage 440g and the fourth projection 440h are arranged as a fourth passage-and-projection pair 442d of the plurality of passage-and-projection pairs 442. Each passage-and-projection pair 442a, 442b, 442c, 442d are respectively offset by approximately 90°.

Each of the first passage 440a, the second passage 440c, the third passage 440e and the fourth passage 440g defines a spatial void that geometrically corresponds to a dimension defined by a distal conical portion (see, e.g., 430b) and at least a portion of a length of a cylindrical portion (see, e.g., 430b) of an axially-extending body (see, e.g., 430) of each of a first projection (see, e.g., 426b), a second projection (see, e.g., 426d), a third projection (see, e.g., 426f) and a fourth projection (see, e.g., 426h) of a plurality of projections (see, e.g., 426₂). Each of the first passage 440a, the second passage 440c, the third passage 440e and the fourth passage 440g defines a length dimension extending between the substrate-facing surface 414b of the second trim member 414 and a distal tip-receiving surface (not shown) that geometrically corresponds to a tip (see, e.g., 430b_{T}) of the distal conical portion 430b of each of the first projection 426b, the second projection 426d, the third projection 426f, and the fourth projection 426h of the plurality of pairs of projections 426₂.

Referring to FIG. 22A₂, each of the first projection 426b, the second projection 426d, the third projection 426f, and the fourth projection 426h includes an axially-extending body 444 defined by a proximal cylindrical portion 444a and a distal conical portion 444b. The proximal cylindrical portion 444a includes a proximal end 444a_{P}, a distal end 444a_{D} and a radial outer surface 444a_{RO}. The distal conical portion 444b includes an axial surface 444b_{A} that extends from the radial outer surface 444a_{RO} of the cylindrical portion 444a and terminates at a tip 444b_{T}. Each of the first projection 440b, the second projection 440d, the third projection 440f, and the fourth projection 440h is defined by a length dimension L₄₄₀ extending between the substrate-facing surface 414b of the second trim member 414 and the tip 444b_{T} of the distal conical portion 444b.

Referring to FIG. 25, a third circular perimeter is shown generally at a third dashed circular line D3, and a fourth circular perimeter is shown generally at a fourth dashed circular line D4, which is concentrically arranged with respect to the third dashed circular line D3. A radial double-arrow line R is shown radially extending between the third dashed circular line D3 and the fourth dashed circular line D4. The third dashed circular line D3 is shown extending across the radially-outwardly-facing surface 436_{RO} of the radially-extending portion 436 of the circumferential projection 432. The fourth dashed circular line D4 is shown tangentially extending across both of a radially-inwardly-most portion of the plurality of circumferentially-arranged passages 440₁ and the plurality of circumferentially-arranged projections 440₂. The radial double-arrow line R demonstrates that both of the plurality of circumferentially-arranged passages 440₁ and the plurality of circumferentially-arranged projections 440₂ are arranged radially outwardly with respect to the radially-outwardly-facing surface 436_{RO} of the radially-extending portion 436 of the circumferential projection 432.

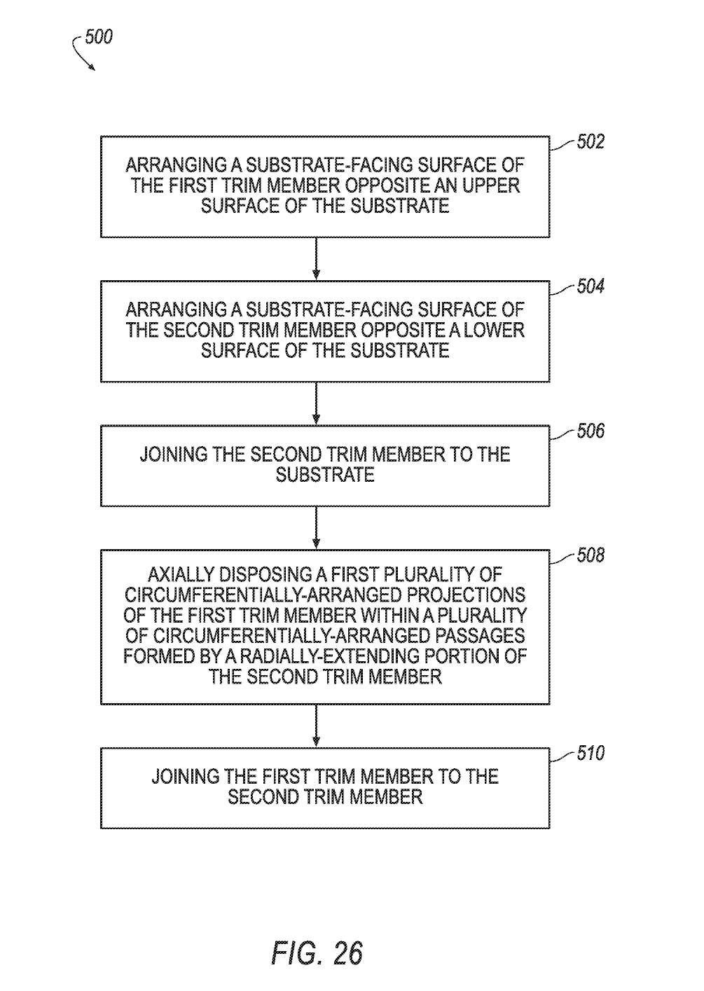

FIG. 26 provides an exemplary method 500 of forming a trimmed assembly 75, 175, 275, 375, 475 by utilizing the trim assembly 10, 100, 200, 300, 400 and the substrate S. The substrate S may include any desirable material (e.g. leather or an artificial leather) such that the trimmed assembly 75, 175, 275, 375, 475 may be said to form a leather good or an artificial leather good. The leather good or artificial leather good may include, but is not limited to: a belt, a strap (e.g., for a purse or satchel), a wallet, a handbag or the like.

As seen in FIGS. 2A-3A, 7A-8A, 12A-13A, 17A-18A, and 22A-23A, the method 500 includes arranging 502 the substrate-facing surface 12b, 112b, 212b, 312b, 412b of the first trim member 12, 112, 212, 312, 412 opposite the upper surface S_{U} of the substrate S. Furthermore, as seen in FIGS. 2A-3A, 7A-8A, 12A-13A, 17A-18A, and 22A-23A, the method also includes arranging 504 the substrate-facing surface 14b, 114b, 214b, 314b, 414b of the second trim member 14, 114, 214, 314, 414 opposite the lower surface S_{L} of the substrate S.

Referring to FIGS. 2B-3B, 7B-8B, 12B-13B, 17B-18B, and 22B-23B, the method 500 also includes joining 506 the second trim member 14, 114, 214, 314, 414 to the substrate S by axially inserting (according to the direction of the arrow X) the circumferential projection 32, 132, 232, 332, 432 into the passage S_{P} extending through the thickness S_{T} of the body S_{B} of the substrate S. The radially-extending portion 36, 136, 236, 336, 436 of the circumferential projection 32, 132, 232, 332, 432 defines a diameter that is greater than the diameter D_{S} of the passage S_{P} extending through the thickness S_{T} of the body S_{B} of the substrate S. The substrate S may include a flexible or stretchable material (or, in some instances. The substrate S may be formed with one or more radially-projecting perforations or slits (not shown) at the passage S_{P}) in order to permit the radially-extending portion 36, 136, 236, 336, 436 to: (1) axially pass in the direction of the arrow X from an initial arrangement 504 opposite the lower surface S_{L} of the substrate S; (2) through the passage S_{P} in the direction of the arrow X; and (3) axially beyond the upper surface S_{U} of the substrate S.

Once the radially-extending portion 36, 136, 236, 336, 436 is axially arranged beyond the upper surface S_{U} of the substrate S, the lower shoulder surface 36_{SL}, 136_{K}, 236_{SL}, 336_{SL}, 436_{SL}, of the radially-extending portion 36, 136, 236, 336, 436 may be arranged adjacent to, or, in a spaced-apart, opposing relationship with respect to the upper surface S_{U} of the substrate S to thereby prevent or mitigate the circumferential projection 32, 132, 232, 332, 432 to pass axially through the passage S_{P} in a direction opposite the arrow X. Furthermore, once the radially-extending portion 36, 136, 236, 336, 436 is axially arranged beyond the upper surface S_{U} of the substrate S, the substrate-facing surface 14b, 114b, 214b, 314b, 414b of the second trim member 14, 114, 214, 314, 414 is arranged adjacent to, or, in an opposing relationship with respect to the lower surface S_{L} of the substrate S. A gap or spacing extending between the lower shoulder surface ³⁶_{SL}, 136_{SL}, 236_{SL}, 336_{SL}, 436_{SL} and the substrate-facing surface 14b, 114b, 214b, 314b, 414b of the second trim member 14, 114, 214, 314, 414 may be slightly greater than (or, in some examples, slightly less than) the thickness S_{T} extending between the upper surface S_{U} and the lower surface S_{L} of the body S_{B} of the substrate S; therefore, the second trim member 14, 114, 214, 314, 414 may be arranged in a loose orientation (or, in some examples, a friction-fit orientation) with respect to the of the body S_{B} of the substrate S.

The axially-extending portion 34, 134, 234, 334, 434 of the circumferential projection 32, 132, 232, 332, 432 defines a diameter that is slightly less than (or, in some examples, slightly greater than) the diameter D_{S} of the passage S_{P} extending through the thickness S_{T} of the body S_{B} of the substrate S. Therefore, the axially-extending portion 34, 134, 234, 334, 434 may be arranged in a loose orientation (or, in some examples, a friction-fit orientation) with respect to the side surface S_{S} that forms the passage S_{P}.

As described above, in some instances, projections 40a-40h, 240a-240h, 340c-340d & 340g-340h, 440b & 440d & 440f & 440h axially extend away from the substrate-facing surface 14b, 114b, 214b, 314b, 414b of the second trim member 14, 114, 214, 314, 414. Therefore, as seen in FIG. 2B, for example, when the second trim member 14, 114, 214, 314, 414 includes the projections 40a-40h, 240a-240h, 340c-340d & 340g-340h, 440b & 440d & 440f & 440h that axially extend away from the substrate-facing surface 14b, 114b, 214b, 314b, 414b, the projections 40a-40h, 240a-240h, 340c-340d & 340g-340h, 440b & 440d & 440f & 440h axially engage and project into the thickness S_{T} of the body S_{B} of the substrate S when the second trim member 14, 114, 214, 314, 414 is joined 506 to the substrate S.

Referring to FIGS. 2C-3C, 7C-8C, 12C-13C, 17C-18C, and 22C-23C, after the second trim member 14, 114, 214, 314, 414 is joined 506 to the substrate S, the method 500 also includes axially disposing 508 (according to the direction of the arrow X′, which is opposite the direction of the arrow X) the first plurality of circumferentially-arranged projections 20, 120, 220, 320, 420 of the first trim member 12, 112, 212, 312, 412 within the plurality of circumferentially-arranged passages 38, 138, 238, 338, 438 formed by the radially-extending portion 36, 136, 236, 336, 436 of the second trim member 14, 114, 214, 314, 414. As seen in FIGS. 3C, 8C, 13C, 18C, 23C, each projection 20a-20d, 120a-120d, 220a-220d, 320a-320d, 420a-420d of the first plurality of circumferentially-arranged projections 20, 120, 220, 320, 420 of the first trim member 12, 112, 212, 312, 412 projects radially outwardly beyond each passage 38a-38d, 138a-138d, 238a-238d, 338a-338d, 438a-438d of the plurality of circumferentially-arranged passages 38, 138, 238, 338, 438 formed by the radially-extending portion 36, 136, 236, 336, 436 of the second trim member 14, 114, 214, 314, 414; therefore, the material defining the radially-extending portion 36, 136, 236, 336, 436 of the second trim member 14, 114, 214, 314, 414 interferes with the axial movement X′ of the first plurality of circumferentially-arranged projections 20, 120, 220, 320, 420 through the plurality of circumferentially-arranged passages 38, 138, 238, 338, 438. Referring to FIGS. 3D, 8D, 13D, 18D, 23D, as a result, the radially-outwardly-facing surface 24_{RO}, 124_{RO}, 224_{RO}, 324_{RO}, 424_{RO} of the radially-extending portion 24, 124, 224, 324, 424 of each projection 20a-20d, 120a-120d, 220a-220d, 320a-320d, 420a-420d of the first plurality of circumferentially-arranged projections 20, 120, 220, 320, 420 engages the material of the second trim member 14, 114, 214, 314, 414 defining each passage 38a-38d, 138a-138d, 238a-238d, 338a-338d, 438a-438d of the plurality of circumferentially-arranged passages 38, 138, 238, 338, 438 such that the plurality of circumferentially-arranged projections 20, 120, 220, 320, 420 flexes radially inwardly as the first plurality of circumferentially-arranged projections 20, 120, 220, 320, 420 are further disposed 508 within the circumferentially-arranged passages 38, 138, 238, 338, 438.

Referring to FIGS. 3E, 8E, 13E, 18E, 23E, the method 500 includes joining 510 the first trim member 12, 112, 212, 312, 412 to the second trim member 14, 114, 214, 314, 414 when the first plurality of circumferentially-arranged projections 20, 120, 220, 320, 420 is further axially moved X′ through the plurality of circumferentially-arranged passages 38, 138, 238, 338, 438 such that the shoulder surface 24_{S}, 124_{S}, 224_{S}, 324_{S}, 424_{S} of each projection 20a-20d, 120a-120d, 220a-220d, 320a-320d, 420a-420d of the first plurality of circumferentially-arranged projections 20, 120, 220, 320, 420 of the first trim member 12, 112, 212, 312, 412 is axially arranged beyond the lower shoulder surface 36_{SL}, 136_{K}, 236_{K}, 336_{K}, 436_{K}, of the radially-extending portion 36, 136, 236, 336, 436 of the circumferential projection 32, 132, 232, 332, 432 of the second trim member 14, 114, 214, 314, 414. Once the shoulder surface 24_{S}, 124_{S}, 224_{S}, 324_{S}, 424_{S} is axially arranged beyond the lower shoulder surface 36_{SL}, 136_{SL}, 236_{SL}, 336_{SL}, 436_{SL}, of the radially-extending portion 36, 136, 236, 336, 436, the radially-outwardly-facing surface 24_{RO}, 124_{RO}, 224_{RO}, 324_{RO}, 424_{RO} of the radially-extending portion 24, 124, 224, 324, 424 of each projection 20a-20d, 120a-120d, 220a-220d, 320a-320d, 420a-420d of the first plurality of circumferentially-arranged projections 20, 120, 220, 320, 420 no longer engages the material of the second trim member 14, 114, 214, 314, 414 defining each passage 38a-38d, 138a-138d, 238a-238d, 338a-338d, 438a-438d of the plurality of circumferentially-arranged passages 38, 138, 238, 338, 438 such that the plurality of circumferentially-arranged projections 20, 120, 220, 320, 420 is permitted to flex radially outwardly.

With reference to FIGS. 3A₁-3A₂, 8A₁-8A₂, 13A₁-13A₂, 18A₁-18A₂, 23A₁-23A₂, the length dimension L₂₄, L₁₂₄, L₂₂₄, L₃₂₄, L₄₂₄, extending between the shoulder surface 24_{S}, 124_{S}, 224_{S}, 324_{S}, 424_{S} and the substrate-facing surface 12b, 112b, 212b, 312b, 412b of the first trim member 12, 112, 212, 312, 412 is slightly greater than but approximately equal to the thickness dimension T₃₆, T₁₃₆, T₂₃₆, T₃₃₆, T₄₃₆ extending between the lower shoulder surface 36_{SL}, 136_{K}, 236_{K}, 336_{SL}, 436_{SL} and the upper shoulder surface 36_{SU}, 136_{SU}, 236_{SU}, 336_{SU}, 436_{SU} of the radially-extending portion 36, 136, 236, 336, 436 of the circumferential projection 32, 132, 232, 332, 432 of the second trim member 14, 114, 214, 314, 414; therefore, upon permitting the each projection 20a-20d, 120a-120d, 220a-220d, 320a-320d, 420a-420d of the first plurality of circumferentially-arranged projections 20, 120, 220, 320, 420 to flex radially outwardly, the shoulder surface 24_{S}, 124_{S}, 224_{S}, 324_{S}, 424_{S} of each projection 20a-20d, 120a-120d, 220a-220d, 320a-320d, 420a-420d of the first plurality of circumferentially-arranged projections 20, 120, 220, 320, 420 of the first trim member 12, 112, 212, 312, 412 is axially arranged adjacent to the lower shoulder surface 36_{SL}, 136_{K}, 236_{K}, 336_{K}, 436_{SL}, of the radially-extending portion 36, 136, 236, 336, 436 of the circumferential projection 32, 132, 232, 332, 432 of the second trim member 14, 114, 214, 314, 414 to thereby prevent or mitigate the each projection 20a-20d, 120a-120d, 220a-220d, 320a-320d, 420a-420d of the first plurality of circumferentially-arranged projections 20, 120, 220, 320, 420 of the first trim member 12, 112, 212, 312, 412 to pass axially through the each passage 38a-38d, 138a-138d, 238a-238d, 338a-338d, 438a-438d of the plurality of circumferentially-arranged passages 38, 138, 238, 338, 438 such that the plurality of circumferentially-arranged projections 20, 120, 220, 320, 420 of the second trim member 14, 114, 214, 314, 414 in a direction opposite the arrow X. Therefore, once each projection 20a-20d, 120a-120d, 220a-220d, 320a-320d, 420a-420d of the first plurality of circumferentially-arranged projections 20, 120, 220, 320, 420 of the first trim member 12, 112, 212, 312, 412 is prevented or mitigated from passing axially through the each passage 38a-38d, 138a-138d, 238a-238d, 338a-338d, 438a-438d of the plurality of circumferentially-arranged passages 38, 138, 238, 338, 438 such that the plurality of circumferentially-arranged projections 20, 120, 220, 320, 420 of the second trim member 14, 114, 214, 314, 414 in a direction opposite the arrow X′, the first trim member 12, 112, 212, 312, 412 is said to be joined 510 to the second trim member 14, 114, 214, 314, 414 thereby forming the trimmed assembly 75, 175, 275, 375, 475.

As described above, in some instances, projections 26a-26h, 126a-126h, 326a-326b & 326e-326f, 426b & 426d & 426f & 426h axially extend away from the substrate-facing surface 12b, 112b, 212b, 312b, 412b of the first trim member 12, 112, 312, 412. Therefore, as seen in, for example, FIG. 2E, when the first trim member 12, 112, 312, 412 includes projections 26a-26h, 126a-126h, 326a-326b & 326e-326f, 426b & 426d & 426f & 426h that axially extend away from the substrate-facing surface 12b, 112b, 312b, 412b, the projections 26a-26h, 126a-126h, 326a-326b & 326e-326f, 426b & 426d & 426f & 426h axially engage and project into the thickness S_{T} of the body S_{B} of the substrate S when the first trim member 12, 112, 312, 412 is joined 510 to the second trim member 14, 114, 314, 414 in order to mitigate rotation of the first trim member 12, 112, 312, 412 relative the substrate S.

In some instances, when the first trim member 12 is joined 510 to the second trim member 14, the projections 26a-26h that axially extend away from the substrate-facing surface 12b of the first trim member 12 are arranged in an opposing relationship with respect to projections 40a-40h that axially extend away from the substrate-facing surface 14b for the purpose of pinching a portion of thickness S_{T} of the body S_{B} of the substrate S arranged there-between in order to mitigate rotation of the first trim member 12 and the second trim member 14 relative the substrate S.

In other examples, when the first trim member 112, 312, 412 is joined 510 to the second trim member 114, 314, 414, the projections 126a-126h, 326a-326b & 326e-326f, 426b & 426d & 426f & 426h that axially extend away from the substrate-facing surface 112b, 312b, 412b of the first trim member 112, 312, 412 are arranged in an opposing relationship with respect to passages 140a-140h, 340a-340b & 340e-340f, 440a & 440c & 440e & 440g extending into the substrate-facing surface 114b, 314b, 414b of the second trim member 114, 314, 414 for permitting the projections 126a-126h, 326a-326b & 326e-326f, 426b & 426d & 426f & 426h to axially plunge a portion of thickness S_{T} of the body S_{B} of the substrate S into the void formed by the passages 140a-140h, 340a-340b & 340e-340f, 440a & 440c & 440e & 440g in order to mitigate rotation of the first trim member 112, 312, 412 and the second trim member 114, 314, 414 relative the substrate S.

In yet another example, when the first trim member 212, 312, 412 is joined 510 to the second trim member 214, 314, 414, the projections 240a-240h, 340c-340d & 340g-340h, 440b & 440d & 440f & 440h that axially extend away from the substrate-facing surface 214b, 314b, 414b of the second trim member 214, 314, 414 are arranged in an opposing relationship with respect to passages 226a-226h, 326c-326d & 326g-326h, 426a & 426c & 426e & 426g extending into the substrate-facing surface 212b, 312b, 412b of the first trim member 212, 312, 412 for permitting the projections 240a-240h, 340c-340d & 340g-340h, 440b & 440d & 440f & 440h to axially plunge a portion of thickness S_{T} of the body S_{B} of the substrate S into the void formed by the passages 226a-226h, 326c-326d & 326g-326h, 426a & 426c & 426e & 426g in order to mitigate rotation of the first trim member 212, 312, 412 and the second trim member 214, 314, 414 relative the substrate S.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A trim assembly comprising:
a first trim member having a first aesthetically-pleasing surface and a first substrate-facing surface, the first trim member comprising a plurality of circumferentially-arranged projections extending axially away from the first substrate-facing surface; and
a second trim member having a second aesthetically-pleasing surface and a second substrate-facing surface, the second trim member comprising a circumferential projection extending axially away from the second substrate-facing surface,
wherein the circumferential projection includes:
an axially-extending portion; and
a radially-extending portion extending radially outwardly away from the axially-extending portion,
wherein the radially-extending portion defines a plurality of circumferentially-arranged passages configured for receiving the plurality of circumferentially-arranged projections for joining the first trim member to the second trim member when the plurality of circumferentially-arranged projections are at least partially disposed within the plurality of circumferentially-arranged passages.

2. The trim assembly of claim 1, wherein the plurality of circumferentially-arranged projections include a first projection, a second projection, a third projection, and a fourth projection.

3. The trim assembly of claim 2, wherein each of the first projection, the second projection, the third projection, and the fourth projection is respectively offset by approximately 90°.

4. The trim assembly of claim 2, wherein each of the first projection, the second projection, the third projection, and the fourth projection includes a substantially arcuate shape having an axially-extending portion and a radially-extending portion.

5. The trim assembly of claim 4, wherein the axially-extending portion includes a proximal end, a distal end surface, a radially-inwardly-facing surface, and a radially-outwardly-facing surface, the proximal end of the axially-extending portion extending axially away from the first substrate-facing surface of the first trim member.

6. The trim assembly of claim 5, wherein the radially-extending portion includes a radially-outwardly-facing surface and a shoulder surface, the radially-outwardly-facing surface of the radially-extending portion connecting the shoulder surface to the distal end surface of the axially-extending portion.

7. The trim assembly of claim 4, wherein the radially-outwardly-facing surface of the radially-extending portion extends away from the distal end surface of the axially-extending portion at an angle with respect to the distal end surface, and the shoulder surface is arranged in an opposing relationship with respect to the first substrate-facing surface of the first trim member.

8. The trim assembly of claim 1, wherein the axially-extending portion includes a proximal end a distal end surface, a radially-inwardly-facing surface, and a radially-outwardly-facing surface, and the proximal end of the axially-extending portion extends axially away from the second substrate-facing surface of the second trim member.

9. The trim assembly of claim 8, wherein:
the radially-extending portion includes a radially-outwardly-facing surface, a lower shoulder surface, and an upper shoulder surface,
the radially-outwardly-facing surface of the radially-extending portion connects the lower shoulder surface to the upper shoulder surface, and
the radially-extending portion is defined by a thickness extending between the lower shoulder surface and the upper shoulder surface.

10. The trim assembly of claim 9, wherein the plurality of circumferentially-arranged passages extends axially through the thickness of the radially-extending portion, and the plurality of circumferentially-arranged passages includes a first passage, a second passage, a third passage, and a fourth passage.

11. The trim assembly of claim 11, wherein each of the first passage, the second passage, the third passage, and the fourth passage is respectively offset by approximately 90°.

12. The trim assembly of claim 11, wherein each of the first passage, the second passage, the third passage, and the fourth passage includes a substantially arcuate shape.

13. The trim assembly of claim 1, wherein the first trim member further comprises a second plurality of circumferentially-arranged projections extending axially away from the first substrate-facing surface and arranged radially outwardly with respect to the first plurality of circumferentially-arranged projections of the first trim member.

14. The trim assembly of claim 1, wherein the second trim member further comprises a plurality of circumferentially-arranged projections extending axially away from the second substrate-facing surface and is arranged radially outwardly with respect to a radially-outwardly-facing surface of the radially-extending portion of the circumferential projection of the second trim member.

15. A trimmed assembly comprising:
a first trim member having a first aesthetically-pleasing surface and a first substrate-facing surface, the first trim member comprising a plurality of circumferentially-arranged projections extending axially away from the first substrate-facing surface;
a second trim member having a second aesthetically-pleasing surface and a second substrate-facing surface, the second trim member comprising a circumferential projection extends axially away from the second substrate-facing surface of the second trim member,
wherein the circumferential projection includes:
an axially-extending portion; and
a radially-extending portion extending radially outwardly away from the axially-extending portion,
wherein the radially-extending portion defines a plurality of circumferentially-arranged passages configured for receiving the plurality of circumferentially-arranged projections for joining the first trim member to the second trim member when the plurality of circumferentially-arranged projections are at least partially disposed within the plurality of circumferentially-arranged passages; and
a substrate defined by a body having an upper surface, a lower surface, and a side surface joining the upper surface to the lower surface, the body being defined by a thickness extending between the upper surface to the lower surface, the side surface forming a passage extending through the thickness of the body, the passage extending through the thickness of the body and being defined by a passage diameter, wherein the axially-extending portion of the circumferential projection of the second trim member is disposed within the passage extending through the thickness of the body of the substrate and the radially-extending portion of the circumferential projection is arranged opposite or adjacent the upper surface of the body of the substrate.

16. The trimmed assembly of claim 15, wherein the second trim member further comprises a plurality of circumferentially-arranged projections extending axially away from the second substrate-facing surface, the circumferentially-arranged projections of the first trim member arranged in an opposing relationship with respect to the plurality of circumferentially-arranged projections of the second trim member for pinching a portion of the thickness of the body of the substrate arranged there-between.

17. The trimmed assembly of claim 15, wherein the plurality of circumferentially-arranged projections of the first trim member are arranged in an opposing relationship with respect to the circumferentially-arranged passages extending into the second substrate-facing surface of the second trim member for permitting the plurality of circumferentially-arranged projections of the first trim member to axially plunge a portion of thickness of the body of the substrate into each of the circumferentially-arranged passages.

18. The trimmed assembly of claim 15, wherein the first trim member defines projection passages extending into the first substrate-facing surface and the second trim member further comprises a plurality of circumferentially-arranged projections extending axially away from the second substrate-facing surface and arranged in an opposing relationship with respect to the projection passages extending into the first substrate-facing surface of the first trim member for permitting the plurality of circumferentially-arranged projections of the second trim member to axially plunge a portion of thickness of the body of the substrate into the projection passages.

19. A method of forming a trimmed assembly including a first trim member, a second trim member, and a substrate, the method comprising:
arranging a first substrate-facing surface of the first trim member opposite an upper surface of the substrate;
arranging a second substrate-facing surface of the second trim member opposite a lower surface of the substrate;
joining the second trim member to the substrate;
axially disposing a first plurality of circumferentially-arranged projections of the first trim member within a plurality of circumferentially-arranged passages defined by a radially-extending portion of the second trim member; and
joining the first trim member to the second trim member.

20. The method of claim 19, wherein joining the second trim member to the substrate comprises axially inserting a circumferential projection of the second trim member into the passage extending through the thickness of the body of the substrate such that the radially-extending portion is axially moved to an orientation opposite the lower surface of the substrate, through the passage extending through the thickness of the body of the substrate and axially beyond the upper surface of the substrate.

21. The method of claim 19, wherein axially disposing the first plurality of circumferentially-arranged projections of the first trim member within the plurality of circumferentially-arranged passages comprises arranging a radially-outwardly-facing surface of the radially-extending portion of each projection of the first plurality of circumferentially-arranged projections adjacent a surface portion defining each passage of the plurality of circumferentially-arranged passages such that the plurality of circumferentially-arranged projections flex radially inwardly.

22. The method of claim 19, wherein joining the first trim member to the second trim member comprises axially moving the first plurality of circumferentially-arranged projections further through the passage extending through the thickness of the body of the substrate for subsequently axially arranging the shoulder surface of each projection of the first plurality of circumferentially-arranged projections of the first trim member beyond the lower shoulder surface of the radially-extending portion of the circumferential projection of the second trim member such that the plurality of circumferentially-arranged projections flex radially outwardly.

23. The method of claim 19, wherein when the first trim member is joined to the second trim member, the projections that axially extend away from the first substrate-facing surface of the first trim member are arranged in an opposing relationship with respect to projections that axially extend away from the second substrate-facing surface for the purpose of pinching a portion of thickness of the body of the substrate arranged there-between.

24. The method of claim 19, wherein when the first trim member is joined to the second trim member, the projections that axially extend away from the first substrate-facing surface of the first trim member are arranged in an opposing relationship with respect to passages extending into the second substrate-facing surface of the second trim member for permitting the projections to axially plunge a portion of thickness of the body of the substrate into a void formed by the passages.

25. The method of claim 19, wherein when the first trim member is joined to the second trim member, the projections that axially extend away from the second substrate-facing surface of the second trim member are arranged in an opposing relationship with respect to passages extending into the first substrate-facing surface of the first trim member for permitting the projections to axially plunge a portion of thickness of the body of the substrate into a void formed by the passages.
